(19) United States
(12) Patent Application Publication
(10) Pub. No.: US 2015/0227414 A1
(43) Pub. Date: Aug. 13, 2015

(54) Systems And Methods Of Memory And Access Management

(71) Applicant: Pradeep Varma, (US)

(72) Inventor: Pradeep Varma, Gurgaon (IN)

(21) Appl. No.: 14/422,628

(22) PCT Filed: Aug. 24, 2013
(86) PCT No.: PCT/IB2013/056856

§ 371 Date: Feb. 19, 2015

(30) Foreign Application Priority Data
Aug. 31, 2012 (IN) 2713/DEL/2012

(51) Int. Cl. G06F 11/07; G06F 12/02

(52) U.S. Cl. CPC G06F 11/0793; G06F 11/073; G06F 12/0253; G06F 2212/251

(57) ABSTRACT

A memory and access management system for reducing memory access errors or management errors or runtime errors while dynamically allocating, moving or de-allocating memory to one or more objects of an application program is disclosed. The object may have a data part containing one or more values and a pointer part containing one or more pointers. The system may include a heap memory pool containing memory space to be assigned to the object and a processor for reading the pointer part. An interface coupled with the processor may be provided for dynamically allocating, moving or de-allocating the data part of the object to defragment, manage or optimize the heap memory pool and updating the address location of the data part contained in one or more pointers upon moving the data part, thereby reducing memory access errors, management errors or runtime errors while allocating, moving or de-allocating memory to the object.

### TECHNICAL FIELD

The disclosure generally relates to methods, a system and algorithms for memory management and safe memory and particularly relates to a garbage collection technique for memory management in computer programming languages such as C, C++.

### BACKGROUND

Programming languages such as C/C++ are used for low resource and efficient computing. Such programming languages form the mainstay of embedded computing systems, because of their low resource footprint. Said programming languages are widely used in computing systems due to the expressive power of the memory model that allows multiple overlapped views of the data in the systems memory. However, the expressive power and flexibility of C/C++ has a flip side also. There is a lack of safety in said programming languages, hence are error prone such as dereferencing an array out of bounds, dangling pointer dereference causing hard to trace program malfunctions and crashes, etc.

At times, the memory access errors may also be used maliciously, for example in buffer overflow attacks and use-after-free attacks to bring down the Internet access. To address the lack of safety in unsafe languages multiple solutions ranging from completely new language design such as Java for Internet programming, retrofitting C language with memory/type safety such as ‘Ccured’, ‘Safe-C’ etc., were developed. While Java is regarded safe over C, JAVA loses the efficiency and low resource footprint of C along with the expressive power of C's detailed, manually managed memory model and the simpler cost model that C provides for complexity analysis of programs. Similarly, the retrofitted CCured dialect of C is safe, at the cost of abandoning the manually managed memory model of C and incurring related costs. CCured and Safe-C dialects utilize fat, non-scalar, non-atomic pointers in their implementations that may not be conducive to concurrent implementation and may have high instrumentation costs. Further, Safe-C's fat pointers are not protected from meta-data reading and overwrite that may compromise the safety of the system. Similarly Ccured, permits reading and overwriting of the pointer components of it's fat wild pointers, allowing integers computations to permeate the stored pointer data and vice versa. This may compromise safety as well as the safe use of a relocating garbage collector in the design and the Ccured utilizes a non-moving conservative garbage collector.

Garbage collection relates to automatic management of the dynamic memory. The Garbage Collection process allows dynamically allocating and deallocating memory by using the C++ operators new and delete as well as by using the libc functions malloc( ) and free( ). Managing dynamic memory is a complex and largely error prone task and is one of the most common causes of runtime errors. Such errors may cause intermittent program failures that are difficult to trace and fix.

Garbage collection technique includes a garbage collector for automatically analyzing the program's data and deciding whether memory is in use and when to return it to the system. When the garbage collector identifies memory that is no longer in use, it frees that part of memory. Garbage collectors may be of many types such as moving and non-moving Garbage Collector.

Garbage Collection in C/C++ is tedious because pointers are not pre-identified in the memory image of a program. When garbage collector begins, and the memory image, comprising the stack, global data section and registers are examined, there is no indication as to what scalars among the data are pointer values.

Different approaches and systems have been known that employ garbage collection technique for memory management. Approaches such as Conservative garbage collector assume that any location that might contain a pointer (or something else, like an integer) contains a pointer and thus tries to mark memory based on this assumption. The garbage collector does not move objects of course because it does not know how to update a field that might either be a pointer or an integer. Regardless, except for movement, all the pointers that conservative garbage collector finds with this assumption are believed to be the entirety of pointers relevant for the program and the garbage collector makes decisions accordingly (e.g. reclaiming objects). In other words, conservative garbage collection assumes that manufactured pointers (constructed after garbage collection by say an integer-to-pointer cast) and hidden pointers (constructed for example by juxtaposing separate bit-fields) do not exist in a C program. Among the pointers it collects, a conservative garbage collector has no way of knowing whether a pointer is a live pointer or a dangling pointer to a re-allocated object. A pointer may be out of bounds of allocated objects and the language/implementations permit dereferencing of such pointers. Conservative garbage collector has no choice but to support out-of-bounds accesses using the pointers it collects, which may cause the garbage collector to mark and traverse all machine memory as reachable memory. Similarly, a dangling pointer to a free object has to support the marking of the free object since the object can be accessed using the pointer. Similarly, an un-initialized pointer variable containing a random value adds the random value as a pointer to the conservative garbage collector's collected pointers, engendering the randomly pointed memory to be marked as reachable. The nice case for a conservative garbage collector comprising dealing with inbound pointers of allocated objects offers its own difficulties as extra work has to be done to determine the object the pointer is inbound to, if the pointer does not point to the base of the object.

Precise garbage collectors have been constructed for C that with restrictions are capable of separating pointers from integers in program data and hence are capable of moving objects also during garbage collection. The collectors however suffer from all the pointer problems listed above for conservative garbage collectors vis-à-vis manufactured pointers, hidden pointers, dangling pointers, out-of-bounds pointers, un-initialized pointers, and in-bound interior pointers. Restrictions placed on C programs in order to make them amenable to precise collection by the precise garbage collectors are not all verified so a violating C program may run with unpredictable and unsafe behavior using a collector.

A precise Garbage Collector for C language is capable of moving objects during garbage collection wherein program restrictions comprise that integers are not confused with pointers, and the liveness of a pointer is apparent at the source level. As an example of the first restriction, this approach handles unions using a tag byte, such that the tag tries to accurately tell when a pointer is stored in the union and when not. However, in case of mixed use where a pointer is viewed as an integer (or vice versa), so that the tag loses meaning may not be supported. Pointer casts are ignored, so alternate views of an object through pointer casts are assumed to not exist. As an example of the second restriction, namely pointer liveness being apparent at source level, free( ) is not expected to be used on objects allocated by the garbage collector and the user is expected to verify this. Interior pointers (pointers to the middle of an object) are a concern and not always supported. Although they are a common C idiom (pointer to member etc.), it is preferred if the source code is modified to avoid them for improving performance. A pointer just past the end of an array is regarded as an interior pointer. Behavior on an out-of-bounds pointer arising from an inbounds pointer and pointer arithmetic is undefined. An out-of-bounds pointer may become inbounds again with further pointer arithmetic, so ignoring it is unsafe both for the direct dereferences it may allow and the inbound behavior it may later manifest. Since no knowledge of the direct dereferences of an out-of-bounds pointer can be assumed, the dereferences cannot distinguish between pointers and integers, which compromises the very premises that precise collection is carried out with.

Another type of garbage collector is Mostly Copying Collector (MCC). MCC is an alternative to conservative mark-sweep that requires that most objects be typed (annotated to distinguish pointers from other values) in order, to be effective. MCC expects annotations from the user and connects a typed object with its type annotation via a header word. In MCC, typed objects carry a header word describing their type, size, and state. A putative pointer, or quasi-pointer to a page is considered detected once the object it is inbound to be located by searching among all the objects on the page it falls on. This on average costs half the number of objects on the page. However, it is not clear how MCC handles or rules out out-of-bounds pointers, which is a fundamental problem that can make such/conservative collectors search the entire accessible machine memory. No support for manual memory management on garbage-collected objects (free( ) calls by user) is described. MCC suffers from the same pointer problems as conservative/precise collectors above for manufactured pointers, hidden pointers, un-initialized pointers, etc.

For the safe running of a program, another approach provides a run-time system comprising a mirror of program memory that identifies for each location whether it is an appropriate target of some unsafe pointer. A memory dereference of an inappropriate location through a pointer is thus identified. Pointers are partitioned into safe and unsafe pointers using a static analysis. Tracked locations are also identified by a static analysis. The tool provides protection against a wide range of attacks through unchecked pointer dereferences, including buffer overruns and attempts to access or free unallocated memory. The tool reports no false positives but does not attempt to catch all attacks (e.g. dangling pointers to reallocated memory).

Another conventional approach such as HSDefender, comprises of three methods for protection: (1) a hardware-implemented boundary check that disallows writes of variables past the frame pointer, thereby protecting return address, frame pointer and arguments. This however requires a user to re-write a program to shift stack local variables with such writes to globals or heap in order to comply with this hardware bounds check requirement (2) a secure call SCALL (and SRET) that additionally encrypts and pushes the return address at the time of a call so that upon return, the encrypted address can be decrypted to compare with the actual return address to ensure safety of the return address. While this method is noted to have much less strict requirements than the hardware boundary method above, this method only protects the return address and is not as safe against stack smashing as the hardware boundary method (3) A secure jump (SJMP) to ensure that an encrypted function pointer is decrypted each time a call through it is made to ensure secure calls. The user is required to manually encrypt a function pointer upon creation and to use only SJMP calls on it for calls. The encrypt/decrypt functions are XOR based, using a special key available to a programmer in a special register so he can manipulate both encrypted and un-encrypted values in a program. XOR based encryption/decryption makes jumping to an attack address harder, but does not eliminate the possibility of such a jump. Finally, protection does not extend to resources beyond function pointers or stack/call variables.

Another conventional approach is a compile time instrumentation technique (CETS) for detection of temporal access violations. CETS associates a key (a capability) and a lock address with each pointer in a disjoint metadata space and checks pointer dereferences. The design of CETS is similar to Softbound's design and suffers with similar limitations. In CETS pointers created from integer-to-pointer casts all yield memory violations upon dereferences. Consider the following program fragment:

int ** ptr;
int * ptr1 = ...; // *ptr1 = 1;
int * ptr2 = ...; // *ptr2 = 2;
*ptr = ptr1;
free(ptr1);
long * alternative = (long *) ptr;
*alternative = (long) ptr2;
return **ptr;

In CETS, the above program will signal a violation. The standard C program will return 2. When *ptr is assigned ptr1, CETS associates ptr1's metadata with ptr. Using alternative, then ptr2 is slipped into *ptr as a long. The metadata associated with ptr continues to be the one for ptr1, which by now has been deallocated. CETS blocks the return statement then, by considering **ptr to be a dangling pointer dereference for ptr1. In short, when CETS and similarly Softbound claim to be applicable to arbitrary casts, their disjoint metadata mechanism loses track of the computation in-between casts and applies stale metadata assumptions to the results of the computation de-legitimizing the cast-based computation in effect. So the claim of applicability to arbitrary casts needs to be revisited.

Barring meta-data reading and overwrite, Safe-C tries to detect memory access errors relatively precisely (viz. temporal access errors, also spatial access errors). However, this approach has limited efficiency (temporal error checks had a hash-table implementation with worst-case linear costs; for large fat pointer structures, register allocation was compromised with accompanying performance degradation; execution time overheads were benchmarked above 300%). The large fat pointers also compromise backward compatibility with standard C code. Significant work has transpired since on these error classes because of the very hard to trace and fix attributes of these errors.

Further, a run-time type-checking scheme is also used that tracks extensive type information in a “mirror” of application memory to detect type-mismatched errors. The scheme concedes expensiveness performance-wise (due to mirror costs, not constant-time ops, e.g. type information is proportional to object size including aggregate objects) and does not comprehensively detect dangling pointer errors (fails past reallocations of compatible objects analogous to Purify).

CCured provides a type inference system for C pointers for statically and dynamically checked memory safety. CCured targets type-safe C programs instead of just memory safety. So in its treatment of unions, the writing of a union by one type and reading of another are disallowed. CCured partitions its pointers into three categories, safe, seq, and wild, all of which have some run-time checks associated with them. The safe pointer is represented in one word, the seq pointer requires three words and the wild pointer requires two words. Wild pointers are the most general variety. Their objects carry size and tag information for them identifying the storage locations of base components of the wild pointers. Thus, tracking of tag information and maintenance is carried out unshared, on a per-object-basis. Tags are laid out one per word of the object space, tracking individual words of the object including the individual components of the two-word wild pointers. Tags representation is thus flat, more fine-grained than pointers, and not compacted according to any repeat patterns. Having a word-by-word granularity, the tags permit inspection of a pointer's components such as integer reading and writing of the pointer component of a wild pointer. Thus, changes to a pointer permeate to the integer part of the data and vice versa and the two are not segregated for the safe use of a moving garbage collector. No compliance is checked when T1 * wild is cast to T2 * wild. Thus, wild pointers allow values of arbitrary type to be written and allow arbitrary interpretation of the value read (except that the tags prevent misinterpreting a pointer base field). The lack of an invulnerable pointer type in CCured, that cannot be spoofed by integer computations that permeate the pointer type means that the ability to provide a shield via the pointer to vulnerable resources like user ids is compromised. In CCured, casts of safe and seq pointers are statically verified to be type safe, ensuring that the same atomic types, padding and alignments exist in the two types.

In the CCured dialect, cast of an integer to a pointer can only generate a null safe pointer (cast of 0), or a non-dereferenceable seq/wild pointer (base/bound set to null) so C's integer to pointer casts is limited (a cast from a pointer to integer to pointer is not identity). CCured's denial of free( ) and reliance purely on a conservative garbage collector for memory reclamation is reflected in its benchmarks also where a program be is found to have a slowdown of a factor of 10, which reduces to an overhead of 50% if CCured's garbage collector is disabled and free( ) calls are trusted.

All capability-based systems have a problem that they can run out of capability space. This is because the capability fields have a fixed size and hence the number of capabilities they represent is fixed while a long-running program can engender an unbounded number of object lifetimes.

Briefly stated, Garbage collection in languages like C/C++ is considered a hard problem since the locations of pointers in a program's memory is not known. This has spawned a whole area of specialised garbage collectors for C/C++ called conservative collectors that in some sense are more general than other collectors because they allow any program location to be a pointer-keeping candidate and not just known ones. Such collectors do not ordinarily attempt object relocation because then pointers to the object have to be updated, which cannot be discriminated from integers and other data in memory. Thus a subset of garbage collector functionality (i.e. non-moving collection), weakened with only guessed pointers (i.e. location x might be holding a pointer, a putative pointer, as opposed to the knowledge that location x holds a pointer) is the state of the art in C/C++ collection. This state of the art, is actually flawed, because it makes the following leap of faith in its working: a value in a location is a putative pointer if and only if it points within a known object of the program. An object is known if it is an object created by the memory management system of the program. The object that a pointer is inbound to is assumed to be the only object reached using that pointer by the program.

A pointer in C can actually be used to dereference any part of the machine memory by allowed manipulations such as pointer arithmetic, using which the pointer can stride through the whole memory and cast of integers to pointers, which can reach anywhere in the machine. The leap of faith made above simplifies garbage collection, as now the collector can filter each location's contents by the address ranges they point to. Without such simplification, the collector would have to trawl through the whole machine memory (as it could all be accessed) and still not find any useful result, since all objects would have to be considered live as each pointer can reach them using pointer arithmetic.

The state of affairs for precise collection is equally dismal. None of the proposed precise collectors for C/C++ can handle the pointer acrobatics that the languages permit and make the same simplifying leap of faith that conservative collectors do. The leap, strictly speaking, is relaxed to if from iff: a value in a (known pointer) location is valid only if it points within a known object of the program. This object is the only object reached using that pointer by the program.

These simplistic, leap-of-faith-based garbage collectors have no clue what to do when faced with situations like an out-of-bounds pointer (i.e. a pointer that does not fall within any known object), dangling pointer (i.e. a pointer to a free object or a re-allocated object), and hidden or manufactured pointers, which can be put together from integer components by arithmetic operations and then cast to a pointer. The collectors work on the hope that the programmer will deliver the faith in the leap-of-faith and that uncomfortable situations like the ones above will not arise. In short, the programmer is burdened tremendously in using these fragile and uncomfortable tools, which in the end, still deliver less than what the programmer still wants (sharper filtering, object relocation, etc.).

It is clear therefore that the state of the art has tremendous scope for improvement, whereby the programmer burden is eliminated and garbage collectors turned into reliable tools as opposed to being wishful wands. The breakthrough needed to realise this improvement is offered by the present disclosure as an insight that a completely safe, memory access system can guarantee the memory reachable from a pointer during its lifetime unambiguously, that can then validate the leap-of-faith assumptions made by a garbage collector (and help overcome other abovementioned weaknesses). A safe system has the machinery necessary to characterise a pointer as inbound or out-of-bounds, and dangling or live. This characterisation is guaranteed only if the system is completely safe. Complete safety is a necessary, but not sufficient condition to realise proper garbage collection. Further work has to be done thereafter to build the proper garbage collection that solve all the abovementioned weaknesses of the state of the art (such as integers and pointers not stepping on each other to allow pointer updates in object relocation). But where is such a completely safe memory access system? This in itself is a research challenge that the prior art does not provide and none of the “safe” systems in prior art are suitable for building proper garbage collectors.

The present disclosure solves both the garbage collector and safety problem for C/C++ together as one unified problem where the underlying novel concept is that of an invulnerable encoded pointer using which both the safety properties are realised and correct, reliable, conservative and/or precise garbage collection for C/C++ are provided with object relocation capability. The problem cannot be solved separately—without GC, the safety system is limited and incapable of handling long-running programs that create and/or delete objects (as in other lifetime or capability enumerating safe systems). Without safety, the GC would remain wishful, as mentioned earlier. The hallmark of C/C++ is efficiency and direct access to the machine model, e.g. for systems or embedded programming. For the present disclosure to be useful, the offered solution has to be highly efficiency conscious. This efficiency consciousness is worked into the offered solution at all levels, e.g. in ensuring that the garbage collectors provided adds only constant-space overhead and that the solution handles concurrency well.

The present disclosure thus is a unified method offering safety, the first correct and reliable and comprehensive garbage collection, and efficiency in languages up to the C/C++ arena of languages. A contrast with some neighbouring prior art now follows.

The tremendous expressive power and flexibility of C/C++ that makes them most widely used and popular has a flip side also. There is a lack of safety in these languages, with errors like dereferencing an array out of bounds, dangling pointer dereference causing hard to trace program malfunctions and crashes. Malicious programs can exploit these vulnerabilities to launch attacks against computers. Austin et al. (Safe-C, published in ACMProgramming Languages Design and Implementation Conference, 1994) described these errors as memory access errors, with a dereference outside the bounds of a referent address-wise being called a spatial access error e.g. array out of bounds access error, and a dereference outside the bounds of a referent time-wise being called a temporal access error e.g. dereferencing a pointer after the object has been freed. Austin et al. provided the first solution to treat temporal access errors relatively comprehensively using a notion of pointer capabilities that can distinguish between distinct lifetimes of an allocated object. Austin et al.'s solution however assumes non-malicious programming and does not protect object and pointer metadata like capabilities from subversion.

Varma et al. (published in ACM Foundations of Software Engineering Conference, 2009) present temporally and spatially safe solution that improves Austin et al. substantially but again assumes non-adverserial programming. It also is thus not suited for protecting infrastructure like the Internet from hostile parties. Like Austin et al., the work also does not present an automatic memory management system. Varma et al. can be viewed as a tiny subset of the work presented here and the distinctions presented in that work vis-a-vis prior arts, like Austin et al. are applicable to the present disclosure also. Varma (US20130007073A1, Jan. 3, 2013) presents a conservative garbage collector that Varma et al. talk about but do not concretely present. This later work is highly ambitious however, in accommodating overlapped views of pointers and integers. An object containing pointers, when viewing for pointers gets the encoded pointers back, while a second view, using a pointer cast, of the same object as comprising all integers, gets the decoded integers for the pointers back. Thus for an area of storage, the pointer cast determines the interpretation of the data in the storage. While this approach is extremely close to C's standard semantics, this approach inherently rules out pointer updates by a moving GC, as an updated pointer's integer interpretation will change (and vice versa, for an integer update). In contrast to this, the present disclosure contributes the core, novel concept of an invulnerable pointer, that is kept invulnerable using compliance machinery tracking casts etc., statically and dynamically. Besides providing safety, this separates the storage of pointers and integers, allowing the first definition of precise, conservative and safe collectors for C/C++. Complete safety is not a target of Varma, for example function pointers are not made safe. To the best of our knowledge, the present system is the only system that guarantees complete memory access safety, only after which do the properties of correct and first accurate conservative and/or precise garbage collection for C/C++ become applicable. Our work claims and delivers on all these properties, unlike any work in the past.

Ringenburg et al. (“Preventing format-string attacks via automatic and efficient dynamic checking”, in Proceedings of the 12th ACM conference on Computer and communications security, pages 354-363, New York, N.Y., USA, 2005) describe the format string attack and a solution comprising static dataflow analyses and dynamic whitelists of safe address ranges. Improvements in false negatives and false positives are reported. The work provides an automated whole program analysis and transformation that enables the whitelist approach without any programmer burden.

Devietti et al. (Hardbound, published in ACM Conference on Architectural Support for Programming Languages and Operating Systems, 2008) proposes a hardware-bounded pointer, an architectural primitive that augments the C standard pointer representation with bounds information maintained separately and invisibly by hardware. The work can be viewed as replacing the fat pointers in Safe-C, CCured) etc. with its hardware-bounded pointer so that memory layout compatibility is maintained as the bounds are stored in a disjoint space. The hardware support also implicitly checks and propagates the bounds information as the bounded pointer is dereferenced, incremented, and copied to and from memory. Binary compatibility is obtained as the hardware-bounded pointer works like a Standard C pointer. Pointers can be read as integers and vice versa and effects of the two types of computations permeate each other and moving garbage collection is not a goal of the work. The translation of pointers to integer and vice versa however is compromised by the limitations in Devietti et al. for handling integer-to-pointer casts. For a cast from an integer literal, since object data is not maintained by the system, the system is unable to recover an object to associate such a pointer with. So no bounds information is available for a pointer cast from an integer and hence all bounds checks on the pointer are flagged as memory violations. Furthermore, since the goal of bounds tracking of a pointer extends to sub-object bounds, the recovery of such a pointer's bounds are more complicated than simply being able to locate the object associated with a pointer. By contrast, in the present disclosure, if an integer i is sought to be cast to a pointer, then invoking encode (i) using the system provided primitive creates an encoded pointer for the integer with object bounds taken from the object associated with the object. This is feasible in the present disclosure because object lists are tracked and lookup simplified using markers in the objects. Further, the present disclosure obtains its safety properties by using compliance checks and not by de-legitimizing intra-object overflows (as for example happens when carrying out memcpy( ) to copy from one sub object to another inside an object) so sub-object bounds are neither used, nor needed for integer-to-pointer conversions.

Oiwa's Fail-Safe C (“Implementation of the memory-safe full ansi-c compiler”, In Proceedings of the 2009 ACM SIGPLAN conference on Programming language design and implementation, PLDI, pages 259-269, New York, N.Y., USA, 2009) uses gc for memory reuse ignoring user-specified memory reclamation. In conjunction with fat pointers storing object base and offset, Oiwa also provides fat integers so that the metadata of a fat pointer cast to an integer can be tracked. This scheme is inherently biased towards the metadata that the integer is initialized with and not what the integer becomes. So for instance, consider two objects A and B separated by a distance X in memory. A pointer to an object A cast to an integer followed by incrementing it by X and cast back to pointer would end up being treated as an out-of-bounds pointer to A and not as an inbound pointer to B. In standard C, the use of the pointer to dereference B would be legitimate. So would be the case in the safe setting if the metadata for the pointer was provided for B and not A. In the present disclosure, this indeed the case hence the present disclosure is closer to the original semantics of C than Fail-Safe C. Similarly, pointers generated from pure integers (not originating from a cast from pointer) generate metadata that completely de-legitimizes their dereferences. This is not the case in the present disclosure. Objects in Fail-Safe C acquire an estimated type and accessor methods, using which (cast) pointer accesses to the object are transacted (via fat integers as an intermediary representation). Efficiency and access is a concern, for example, for arbitrary pointer accesses to an object subset along the lines of memcpyQ-style access (as permitted in the integer/byte regions of objects by the present disclosure). The fat representations (fat pointers, fat integers) in Fail-Safe Care not double word aligned for atomic access, which is necessary in efficient concurrent implementations. Finally, since provision of general automatic memory management (object relocation) is not a goal of Fail-Safe C, the separation of integer computations and pointer storage is not carried out unlike in the present disclosure. This non-separation of the two computations means that a pointer in Fail-Safe C is not invulnerable to changes due to integer computations that permeate the pointer type. Such changes can spoof a Fail-Safe C pointer, denying a shield capability to the pointer for vulnerable resources like user ids that the present disclosure's invulnerable pointers are able to provide.

To re-iterate, the present disclosure is the first unified method offering complete memory access safety, the first correct and reliable and comprehensive garbage collection, and efficiency in languages up to the C/C++ arena of languages. The work stands apart from all the past work on safety easily in terms of its ability to handle volatile data like volatile-qualified pointers, atomically while facing any modification, serial or concurrent. This is a critical requirement for efficiency and completeness, for the coverage of C/C++ type of languages. Following a major school of thought in programming languages like Lisp, and safe languages, the present disclosure makes a design choice to track the metadata of each program pointer explicitly. This leads to a general design, unfettered by legacy code concerns that the traditional C pointer structure be followed literally. Compatibility with legacy C code is addressed in the system design, elsewhere, explicitly. Here we provide a comparison with C/C++ memory safety systems in prior art that track each pointer's metadata explicitly, such as liveness (dangling or not), inbounds/outbounds etc. We show how all these prior arts are intrinsically deficient in their coverage of synchronization-free, atomic pointer dereferences, a key goal of standard C/C++ implementation. This is also a distinguishing feature of the present disclosure, which is critical for the efficient and scalable use of (a made-safe version of the) source languages (C/C++) in the emerging world of concurrency. An atomic, synchronization-free pointer-to-a-scalar dereference means that for an already read pointer value (saved as a local copy), the read/write dereference of the pointer-to-a-scalar be carried out on the pointer's location without the involvements of synchronization constructs like locks explicitly by the program, or by the program's compiled/run-time implementation. Herein we have that the pointer points to a scalar datum, whose lock/synchronization-free access via a pointer dereference is a must.

There are four dimensions of deficiency in prior art on safety that tracks pointer metadata. These deficiencies disable atomic, synchronization-free pointer dereferences, and comprise:
(a) Separately stored pointer metadata from the pointer itself, requiring that a dereference that reads or writes a pointer has to simultaneously read/write separate locations of program memory, an enterprise that cannot be done atomically without synchronization like locks.
(b) An inability to ensure that a dereference that reads or writes a pointer value indeed does so uncorrupted by a concurrent or serial number read or write to the same location, and vice versa. This in brief is the invulnerability condition, to prevent pointer metadata leakage or corruption from corrupting a dereference or the system.
(c) An inability to handle concurrent deallocation and reallocation of the object being accessed by the dereference, which in turn makes the dereference unreliable for further processing.
(d) Fat pointers or other fat data that may furthermore be unsuitably aligned for atomic reading or writing.

Reference is now made to Loginov et al, at reference number [14] given later, which suffers from deficiency (a) above, at a minimum.

Nagarkatte et al. in Softbound/CETS (references [15-16]) suffers from all deficiencies (a-c) above, besides fatness of their separately kept pointer metadata that then suffers from (d).

Nagarkatte et al. in Softbound alone [15] suffers from (a) and (b), besides fatness of the separately kept pointer metadata that then suffers from (d).

Oiwa [19] suffers from (a) and (b), besides having fat integers and fat pointers that are not double word aligned for atomic access, which further adds deficiency (d).

CCured [17] suffers from (a) and (b), besides having two or three word fat pointers that are not suitably aligned for atomic access, which then adds deficiency (d).

Varma et al. in each of [26], U.S. Pat. No. 8,156,385 B2, and U.S. Pat. No. 8,347,061 B2 suffers from both (b) and (c). Varma in US2013/0007073 A1 comes close to invulnerability in a manner that rewrites an object's data according to the type it is next accessed with. This requires a single-threaded typed view of the object, which may not be the case with a concurrent program. Hence Varma in US2013/0007073 A1 also suffers from both (b) and (c).

Safe C [3] suffers from (b) and (c), besides using non-scalar fat pointers of 4+ words each, that are not suitably aligned either for atomic access, which adds deficiency (d).

Cyclone [11] uses 3-word fat pointers called ?-pointers, which makes up deficiency (d). Cyclone points out that assignments to its fat pointers are not atomic requiring a lock to be acquired before accessing a fat pointer shared among threads. As a corollary, dereferencing a fat pointer to access a fat pointer is also non-atomic.

Valgrind [18] and Purify [9] suffer from (a) in offering incomplete safety to a program, without lock-free atomic pointer dereferences.

Xu et al. [27] suffer from (a) and (c). They track 4 words of metadata additional to an unchanged pointer representation, in the optimized case, which adds further a deficiency (d). This metadata is kept separate from the pointer, either in a structure for the purpose, or as scalarized, separate variables. None of this is amenable to atomic pointer dereferencing.

Chase in US2012/0023306 A1 uses pointers with version metadata to construct a precise garbage collector system with manual management. The system presupposes a simple, safe language setting with foreknowledge of pointers in program memory as the precise garbage collector works by resetting versions in pointers, which are known separately from integers in the program memory and can be overwritten thus. The system however does not have atomic pointer operations for dereferencing a pointer. In writing to a pointer dereference, an explicit transaction is invoked, which is synchronization support pre-supposed from the underlying computer system. A pointer dereference for a read is left non-atomic, since it is not wrapped in an explicit transaction, and without such protection, is unguarded against deficiency (c) above.

Devietti et al. in Hardbound [5] offer a hardware system tracking pointer metadata. This work is the hardware predecessor that inspired Softbound and the work suffers with limitations analogous to Softbound, except that being hardware, it can pull in extra, special-purpose support for itself like transactional memory synchronization support for pointer operations. Hence like Softbound, Hardbound also does not offer synchronization-free atomic pointer dereferencing, with special-purpose synchronization having to be built in the hardware for the purpose of carrying this out.

Examples of safety methods that do not track pointer metadata are:

Jones and Kelly [12], and Ruwase et al. [23] wherein the safety obtained does not safeguard against dangling pointers to either stack or heap objects. Akritidis et al. [2] builds on these schemes, and includes tracking pointer metadata to the extent of using 1-word tagged pointers as one alternative, and marking out-of-bounds pointers with a reserved bit as a second alternative. Both these tracked schemes suffer from deficiency (b), as a result. Furthermore, for Jones and Kelly, Ruwase et al., and Akritidis et al., even to the extent they do not track pointer metadata, the checking done for a pointer in terms of its object lookup may well require locks in a concurrent setting, given that the object table faces concurrent deletions and additions to itself. Finally, all these three schemes are incomplete in terms of checking intra-object overflows that for example are handled gracefully in the present disclosure by invulnerable pointers (viz. compliance checks).

Dhurjati et al. [6] builds further the Jones and Kelly, and Ruwase et al. schemes by partitioning the object table into smaller tables, and introducing some pointer tracking by replacing an out-of-bounds object pointer with a pointer value identifiable by its presence in the kernel address range. These tracked pointers suffer from deficiency (b) to the extent they are used. Otherwise, the scheme inherits the limitations of its predecessors Jones and Kelly, and Ruwase et al, including limitations vis-à-vis intra-object overflows.

Cling [1] mitigates, but does not eliminate the deleterious effects of dangling pointers by limiting re-allocations of objects to the same type. The scheme does not track pointer metadata.

Dhurjati et al. in [7] obtain dangling pointer protection by leveraging the virtual paging mechanism, without tracking pointer metadata. The scheme requires operating system intervention with system calls per object allocation and de-allocation, making these activities extremely expensive. The scheme also overloads the paging mechanism with TLB (translation lookaside buffer) misses as potentially a new virtual page is allocated per object allocation, causing a protected program to overload and harm the performance of other processes on the machine also (that are sharing the same virtual paging mechanism). Reasoning about out-of-bounds addresses is also made difficult (or integer-to-pointer casts), as objects are randomly remapped all over the virtual address space. More importantly, since an out-of-bounds address (or an integer cast to a pointer) can however land up on a valid object, the scheme cannot rule out an adversary remapping a dangling pointer to a live object and thereby subverting the system, in a manner analogous to deficiency (b) given earlier.

Safecode [8] provides a framework for sound static analyses for a memory-unsafe language, providing partial safety as a result. Its safety incompleteness includes inability to prevent dangling pointer and out-of-bounds pointer uses within a pool they are contained in. The method does not track pointer metadata.

Synchronization requirements of the run-time checks enforced by Safecode are not discussed.

Li et al. [13] uses symbolic analysis to detect some buffer overflow vulnerabilities statically, without tracking pointer metadata at run-time.

Yong et al. [28] use static analysis and run-time checks to provide partial safety to a program without tracking pointer-specific metadata per pointer and the pointer representation is unchanged.

Ringenberg et al. [22] present a static analysis and dynamic whitelist of safe address ranges to guard against format string attacks (only). The method does not track pointer metadata.

Berger et al. [4] approximate an ideal memory manager with infinite memory wherein objects are far apart in memory (making inter-object overflows difficult), and never reused (making dangling pointers irrelevant) with a randomized memory manager such that pointer representation remains unchanged in the program. This provides probabilistic memory safety to a program. Chilimbi et al [10] profile objects, such that long unused objects are identified as stale and potential leaks. Neither berger et al., nor Chilimbi et al. track pointer metadata.

Hardware safety systems that offer incomplete safety without tracking pointer metadata are HSDefender [24], Smashguard [20], and Shi et al. [25]. Qin et al. [21] shows how hardware error correcting codes can be leveraged to provide some protection against memory leaks and memory corruption using page protection kind of support, but at a finer cache-line of granularity. Qin et al. do not track pointer metadata.

Given the discussion of both pointer metadata-tracking and non-tracking prior art above, it is clear that the present disclosure is the first memory safety system offering complete safety inclusive of synchronization-free atomic pointer dereferencing, besides being the first such system offering general manual memory management, automatic memory management, or both.

In order to obviate at least one or more of the aforementioned problems, there is a well-felt need to provide a safe, manual and automatic managed dialect of C/C++ that is capable of supporting both moving and non-moving garbage collectors and combinations thereof.

### SUMMARY

A memory and access management system for reducing memory access errors or management errors or runtime errors while dynamically allocating, moving or de-allocating memory to one or more objects of an application program is disclosed. The object has a data part containing one or more values and a pointer part containing one or more pointers. The system comprises of a heap memory pool that contains a memory space to be assigned to the object of the application program and a processor configured for reading the pointer part of the object. An interface coupled with the processor is provided for dynamically allocating, moving or de-allocating the data part of the object to defragment, manage or optimize the heap memory pool and updating the address location of the data part contained in one or more pointers in the pointer part upon moving the data part, thereby reducing memory access errors or management errors or runtime errors while allocating, moving or de-allocating memory to the object.

According to an embodiment, the pointer part comprises of one or more live pointer, dangling pointer, inbound pointer, out-of-bounds pointer, uninitialized pointer, manufactured pointer or hidden pointer.

According to another embodiment, the interface comprises of a garbage collector for moving or de-allocating memory to the object.

According to yet another embodiment, the interface comprises of a manual management unit including support for allocating or de-allocating memory to the object

According to yet another embodiment, the garbage collector is a precise garbage collector for moving data part of the object in order to de-fragment the heap memory pool and improve cache or locality performance.

According to yet another embodiment, the garbage collector is a complete conservative garbage collector configured without the object moving functionality and to effectively track the pointer part of the object.

According to yet another embodiment, the garbage collector is a hybrid precise garbage collector with partial object moving functionality and configured to effectively track the pointer part of the object.

The memory and access management system further comprises of an invulnerability compliance unit for ensuring the pointers are invulnerable, an access checking unit for ensuring safe memory access and a management checking unit for ensuring safe memory management.

According to yet another embodiment, the garbage collector builds or uses a hash table comprising a plurality of buckets for containing lists of live or free objects.

According to yet another embodiment, the pointer of the object is maintained in an encoded state.

According to yet another embodiment, the manual management unit is a substitute to the memory management functions in stdlib.h, section 7.20.3 of the ANSI/ISO C99 manual such that spatially and temporally safe use and management of memory is obtained.

According to yet another embodiment, the memory and access management system is an automatically managed memory and access system supporting complete manually managed memory standards of C and C++ programming languages.

According to yet another embodiment, the heap memory pool comprises of a non-contiguous memory space to be increased or decreased at run-time, based on the needs of the application program.

According to yet another embodiment, the memory and access management system manages the heap memory pool via an arrangement of management structures, each for a specific allocation size used by the application program.

According to yet another embodiment, the management structures comprises of a dsizeof(0) structure where dsizeof(0) is doubleword sizeof(0) and a dsizeof(gh) structure where gh is a gap header and a dsizeof(m) structure where m is a management structure, such that one or more of the structures are created at system initialization time.

According to yet another embodiment, the dsizeof(0) structure is configured for housing an eNULL object whose data size excluding meta-data is 0, the dsizeof(gh) structure contains gap headers on the internal allocated and internal free lists of the dsizeof(gh) structure and the dsizeof(m) structure contains management structures on the internal allocated list of the dsizeof(m) structure.

According to yet another embodiment, the outside of paired creation times the total number of free or live gap headers equals the total number of arranged management structures in the heap memory pool at any time.

According to yet another embodiment, the management structures are arranged in a doubly linked sorted-by-size list such that each management structure tracks at least five allocated/free object lists and one gap header (gh) pertinent to allocations of the management structure's size.

According to yet another embodiment, the garbage collector is further configured to quarantine the live or free objects having a dangling pointer.

According to yet another embodiment, the gap header points to lists of gaps using fields gaps, fit_nxt, or fit_nxt_nxt wherein fit_nxt and fit_nxt_nxt point to consumable gaps and gaps points to non-consumable gaps.

According to yet another embodiment, an allocation request with an existing management structure uses a free object or a consumable gap on the fit_nxt or fit_nxt_nxt lists unless none exist.

According to yet another embodiment, the management structure creation leads to a re-partitioning of the lists of gaps such that consumable-gaps stored on fit_nxt or fit_nxt_nxt lists are maximized.

According to yet another embodiment, all objects and gaps in the heap memory pool are doubleword aligned.

According to yet another embodiment, each gap created from a free object of doubleword size s by a garbage collector can serve allocation requests of doubleword size s among possibly others.

According to yet another embodiment, the object data part comprises a meta-data part, the meta-data part includes one or more fields for storing next and previous links of objects for a doubly-linked object arrangement and, for storing an object layout key, version, size, markers or multi-purpose markers.

The memory and access management system further comprises of a hash table built by a garbage collector such that one or more lists of free or live objects stored in the hash table are built by re-using one of the links of the doubly-linked objects in the heap memory pool.

According to yet another embodiment, the one or more pointers are invulnerable pointers, invulnerable encoded pointers, scalar invulnerable encoded pointers or atomic scalar invulnerable encoded pointers.

According to yet another embodiment, the object layout key identifies a layout data structure or a constant to represent that the object does not yet have a layout or the object's layout is special, such as for an eNULL object.

An invulnerable pointer supporting pointer-to-pointer cast or pointer arithmetic is provided for identifying an object in a heap memory pool such that the pointer cannot be overwritten by a non-pointer value or read as a non-pointer value.

A deferred free operation over an object for manual memory management is disclosed. The deferred free operation comprises steps of saving the object in a cache of objects and freeing the cached objects later as a group using barrier synchronization.

According to yet another embodiment, the barrier synchronization is lock-free.

A memory layout for a static type is disclosed. The memory layout comprises a bitwise representation of pointer-sized or pointer-aligned entities including pointer and non-pointer data, with one bit value representing a pointer datum and the other bit value representing non-pointer data.

According to yet another embodiment, the memory layout is generated by compacting a recognized repeat pattern in the layout into an un-repeated representation.

According to yet another embodiment, the memory layout is represented in a data structure comprising bitstrings of appended combinations of un-repeated bitstring pattern and one or more unrolls of repeat bitstring pattern.

According to yet another embodiment, pointer invulnerability compliance checks based on a static type layout are disclosed.

According to yet another embodiment, the pointer invulnerability compliance checks are carried out dynamically for compliance operations comprising pointer casts, pointer arithmetic and stored pointer reads. The pointer invulnerability compliance checks are static or dynamic and comprise layout or bitstring or layout key comparisons. The pointer invulnerability compliance checks are optimized if an object's layout does not comprise an un-repeated bitstring or if the repeat bitstring is not manifested in the un-repeated bitstring. The pointer invulnerability compliance checks wherein the checks are lock-free. The pointer invulnerability checks are shared with memory access checks.

According to yet another embodiment, the shared checking occurs when a compliance check operation dominates a memory access operation or a memory access operation dominates a compliance check operation or a set of one or more compliance check operations effectively dominates a memory access operation or a set of one or more memory access operations effectively dominates a compliance check operation.

A method of shielding a vulnerable resource in the heap memory pool is disclosed. The method comprises steps of storing the vulnerable resource in an object in the heap memory pool and representing the vulnerable resource by an invulnerable pointer to the object.

According to yet another embodiment, the method further comprises of storing the resource in a free object in the heap memory pool and referencing the free object by a dangling pointer allowing only special-purpose accesses to the resource through the dangling pointer and disallowing other accesses such as dereferences of the dangling pointer through normal access checking.

A method for encoding an un-encoded pointer is disclosed. The method comprises steps of identifying an object for the un-encoded pointer by searching through a cache of previously decoded pointers' objects or using the object of a hinted encoded pointer or deferring the identification till a hash table of objects is dynamically constructed and using the address location or version of the object to build the encoded pointer.

An extended gap structure is disclosed. The extended gap structure comprises at least four fields stored at one end of an unused memory block of a heap memory pool comprising a first field pointing to the other end of the memory block, a second field pointing to a list of gaps, a third and fourth field maintaining a doubly-linked list of gaps according to location-wise sorted order among gaps representing the entire set of unused memory blocks in the heap memory pool.

According to yet another embodiment, the extended gaps in a sorted state defragment the heap memory pool by maximizing matched memory allocations that consume an extended gap apiece, and enable linear time coalescing or addition of gaps within a constant-space garbage collector.

A probabilistically-applicable deterministic, precise garbage collector comprises of a precise garbage collector with object moving functionality having a lightweight screening mechanism for determining applicability that decides whether collected putative pointers are also precise pointers.

According to yet another embodiment, the lightweight screening mechanism comprises comparing a count of putative pointers that cover all actual pointers with a separately collected count of actual pointers, equality indicating that each putative pointer is an actual pointer.

A method for reducing memory access errors or management errors or runtime errors while dynamically allocating, moving or de-allocating memory to one or more objects of an application program is disclosed. The object has a data part containing one or more values and a pointer part containing one or more pointers. The method comprises steps of dynamically allocating, moving or de-allocating the data part of the object to defragment, manage or optimize a heap memory pool. The heap memory pool contains a memory space to be assigned to the object of the application program. The method further comprises step of updating the address location of the data part contained in one or more pointers in the pointer part upon moving the data part, thereby reducing memory access errors or management errors or runtime errors while allocating, moving or de-allocating memory to the object.

A mark method for a conservative garbage collector, such that the method identifies memory reachable from a root set of an application program is disclosed. The root set comprises of a stack, globals and static data section, and registers for the application program. The mark method comprises steps of identifying putative encoded pointers in the root set and recognizing a putative encoded pointer as a discovered encoded pointer only if a live or free object in the heap memory pool exists for the putative encoded pointer. The mark method further comprises of marking a live object pointed by a live putative encoded pointer as reachable memory, adding marked live objects to the root set and repeating the above steps again till the root set stops changing.

According to yet another embodiment, an object in the heap memory pool is marked or traversed only once to identify the reachable memory.

The mark method further comprises tracking a putative encoded pointer effectively by screening the pointer for proper size and alignment, the proper alignment and memory range of the pointer's pointed object, the presence of proper markers in the pointed object, the putative validity of the next or previous objects linked from the pointed object, or the equality or non-equality of the pointer and pointed object versions the former of which is indicative of a live pointer to a live object and the latter of which is indicative of a dangling pointer.

A recursive formulation of a mark method of a garbage collector is disclosed. The recursive formulation comprises steps of marking an object with a deferred-marking tag for deferring the recursive marking of the object when the recursion depth has exceeded a user-specified bound and executing the mark method on the deferred-marking tagged objects.

According to yet another embodiment, the recursive formulation further comprises of storing deferred-marking objects in a cache.

A method for re-cycling object version in a memory and access management system is disclosed. The method comprises steps of enumerating locally optimized last version candidates and choosing the best last version candidate among locally optimized last version candidates by selecting the candidate with maximum total version space for objects.

According to yet another embodiment, the method further comprises of reusing one of the links of doubly linked objects and a multipurpose marker for computing the best last version candidate.

According to yet another embodiment, the method further comprises a gap creation method execution before the version-recycling method

A try block for backward compatibility is provided such that the try block runs in a scope where free variables comprising of pointers consist only of decoded pointers.

### BRIEF DESCRIPTION OF DRAWINGS

To further clarify the above and other advantages and features of the disclosure, a more particular description will be rendered by references to specific embodiments thereof, which are illustrated in the appended drawings. It is appreciated that the given drawings depict only some embodiments of the method, system, computer program and computer program product and are therefore not to be considered limiting of its scope. The embodiments will be described and explained with additional specificity and detail with the accompanying drawings in which:

FIG. 1 illustrates a schematic diagram showing a heap memory pool organization in accordance with an embodiment of the invention;

FIG. 2 illustrates a diagram showing egaps in accordance with an embodiment of the invention;

FIG. 3 illustrates a schematic diagram showing heap memory pool organization with hash table and cache storage in accordance with an embodiment of the invention.

FIG. 4 illustrates a diagram showing a circular version space illustration in accordance with an embodiment of the invention;

FIG. 5 illustrates a flowchart showing Mark_root process for the conservative garbage collector in accordance with an embodiment of the invention;

FIG. 6 illustrates a flowchart showing Mark_transitive process for the conservative garbage collector in accordance with an embodiment of the invention;

FIG. 7 illustrates a flowchart showing Hybrid_mark_transitive process for the hybrid garbage collector in accordance with an embodiment of the invention;

FIG. 8 illustrates a flowchart showing Mark_root process for the probabilistic precise garbage collector in accordance with an embodiment of the invention;

FIG. 9 illustrates a flowchart showing Mark_root process for the precise garbage collector in accordance with an embodiment of the invention;

FIG. 10 illustrates a diagram showing an Invulnerable Pointers and Dereferences in accordance with an embodiment of the invention;

FIG. 11 illustrates a diagram showing a heap memory pool in accordance with an embodiment of the invention;

FIG. 12 illustrates a diagram showing a memory and access management system in accordance with an embodiment of the invention; and

FIG. 13 illustrates a computer system in which the memory and access management system can be implemented in accordance with an embodiment of the invention.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof. Throughout the patent specification, a convention employed is that in the appended drawings, like numerals denote like components.

Reference throughout this specification to “an embodiment”, “another embodiment” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

Disclosed herein are embodiments of a system, methods and algorithms for memory management.

The disclosure presented herein, named Memory and Access Management System, is a low-resource, safe, automatically managed memory system that also supports the complete functionality of C's manually managed memory standards.

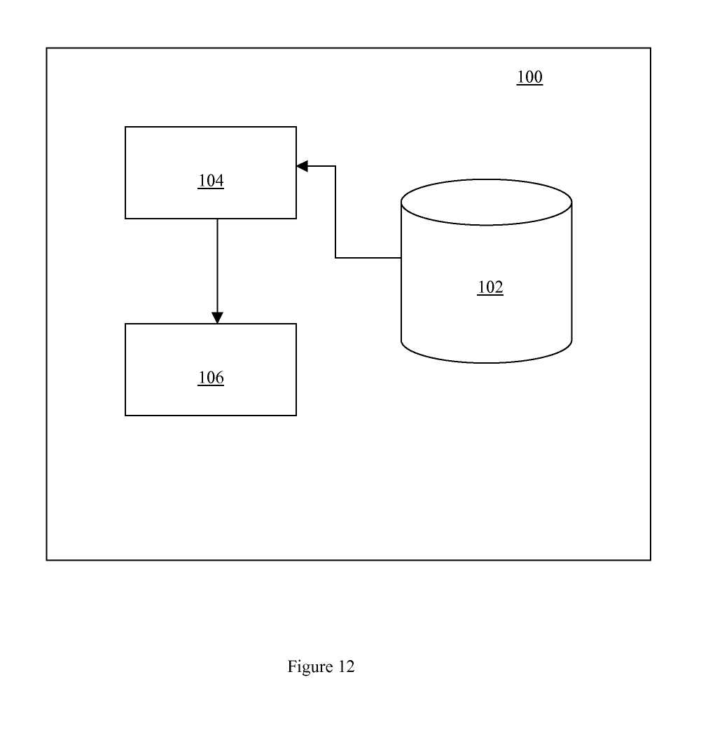

FIG. 12 illustrates a memory and access management system 100 for reducing memory access errors or management errors or runtime errors while dynamically allocating, moving or de-allocating memory to one or more objects of an application program in accordance with an embodiment of the invention. The object may have a data part containing one or more values and a pointer part containing one or more pointers. The system 100 may comprise of a heap memory pool 102 that contains a memory space to be assigned to the object of the application program and a processor 104 configured for reading the pointer part of the object. An interface 106 coupled with the processor 104 may be provided for dynamically allocating, moving or de-allocating the data part of the object to defragment, manage or optimize the heap memory pool 102 and updating the address location of the data part contained in one or more pointers in the pointer part upon moving the data part, thereby reducing memory access errors or management errors or runtime errors while allocating, moving or de-allocating memory to the object.

According to an embodiment of the invention, the pointer part may comprise of one or more live pointer, dangling pointer, inbound pointer, out-of-bounds pointer, manufactured pointer or hidden pointer.

According to another embodiment of the invention, the pointer of the object may be maintained in an encoded state.

According to yet another embodiment of the invention, the heap memory pool 102 may comprise of a non-contiguous memory space to be increased or decreased at run-time, based on the needs of the application program.

The memory and access management system 100 may be an automatically managed memory and access system supporting complete manually managed memory standards of programming languages such as C and C++.

The Memory and access management system 100 may be broadly applicable to all computing platforms including real-time, embedded, distributed, networked, mobile, parallel, and mainstream because of its following attributes:
A clearly enunciated safety scheme built in terms of invulnerable, scalar, atomic, encoded pointers.
A low resource footprint comprising constant space overhead garbage collectors, scalar and atomic encoded pointers, packed metadata objects, and incremental acquiring/releasing of system memory.
Enhanced functionality and productivity arising out of retaining C's expressive and detailed memory model, adding safety to it, and augmenting the result further with safe automatic management of memory eliminating problems like memory leaks and controlling memory fragmentation.
High efficiency arising out of localized metadata storage (in objects and pointers), matched allocation maximization, moving objects for memory compaction, optimal recycling of versions, etc.

An invulnerable pointer for identifying an object in the heap memory pool 102 and supporting pointer-to-pointer cast or pointer arithmetic such that the pointer cannot be overwritten by a non-pointer value or read as a non-pointer value is also disclosed.

The memory and access management system 100 offers the following compliance policy for invulnerable pointers: At the user level, a pointer is an invulnerable type that can be read as a pointer only and overwritten or altered as a pointer only.

The memory and access management system 100 may further comprise of an invulnerability compliance unit for ensuring the pointers are invulnerable, an access checking unit for ensuring safe memory access and a management-checking unit for ensuring safe memory management.

According to yet another embodiment of the invention, the interface 106 may comprise of a manual management unit including support for allocating or de-allocating memory to the object. According to yet another embodiment of the invention, the interface 106 may comprise of a garbage collector for moving or de-allocating memory to the object.

For an application such as C programming language, the memory and access management system 100 may provide a substitute interface to the memory management functions in stdlib.h, section 7.20.3 of the ANSI/ISO C99 manual such that spatially and temporally safe use of the allocated memory is obtained. The substitute interface may include automatic garbage collection technique of heap memory, such that no specification of free( ) by a user is required. The user may choose to exercise free( ) calls, which works safely in conjunction with the garbage collection technique. The garbage collection technique may include a garbage collector that works within constant memory overhead (of stack, heap and globals/static space) that means that the garbage collector may be relied upon to succeed, even while operating at near saturation levels of systems memory use. The garbage collector may be of many types such as a precise garbage collector having the option of moving allocated objects in order to de-fragment the heap and improve cache performance. The memory and access management system 100 may provide a simple and effective policy for running an efficient, precise, general garbage collector, which comprises using invulnerable pointers in the memory and access management system 100. Within invulnerable pointers, the memory and access management system 100 is free to use any representation for pointers.

Using an encoded representation for pointers, the memory and access management system 100 may implement precise garbage collectors more efficiently and effectively by providing a handle on interior and out-of-bounds pointers to objects using a localized metadata encoded with the pointers. This in conjunction with cast/decode support for encoded pointers (to integer and vice versa) provides correctness guarantees to garbage collector despite C's ability to synthesize pointers at will.

Further, the memory and access management system 100 may provide a range of garbage collectors as follows:
A complete, precise garbage collector, with object moving functionality. The precise garbage collector moves the data part of the object in order to de-fragment the heap memory pool and improve cache or locality performance
A complete conservative garbage collector, without object moving functionality that has superior performance due to the effective tracing of encoded pointers of the memory and access management system.
A hybrid, conservative and precise garbage collector that moves objects reached from heap stored pointers. This garbage collector is fast because the garbage collector avoids the cost of registering stack pointer locations. Also, the precise tracking of heap pointer locations is fast and the conservative performance on stack locations superior due to encoded pointers of memory and access management system.
A probabilistically-applicable deterministic, precise garbage collector comprising of a precise garbage collector with object moving functionality having a lightweight screening mechanism for determining applicability that decides whether collected putative pointers are also precise pointers. According to an embodiment, the lightweight screening mechanism comprises comparing a count of putative pointers that cover all actual pointers with a separately collected count of actual pointers, equality indicating that each putative pointer is an actual pointer.

According to yet another embodiment of the invention, the garbage collector may build or use a hash table that comprise of a plurality of buckets for containing lists of live or free objects.

According to an embodiment, all the garbage collectors above may have constant-space overhead during garbage collection time.

According to yet another embodiment of the invention, the object data part may comprise a meta-data part, the meta-data part may include one or more fields for storing next and previous links of objects for a doubly-linked object arrangement and for storing an object layout link, version, size, markers or multi-purpose markers.

The memory and access management system 100 may further comprise a hash table built by a garbage collector such that one or more lists of free or live objects stored in the hash table are built by re-using one of the links of the doubly-linked objects in the heap memory pool.

According to yet another embodiment of the invention, the one or more pointers may be invulnerable encoded pointers, scalar invulnerable encoded pointers or atomic scalar encoded pointers.

According to yet another embodiment of the invention, heap memory pool, heap memory and heap are used interchangeably throughout the detailed description.

In memory and access management system 100, an allocation bound for the maximum memory heap space to be used by a program is specified. This is specified by a HEAP_OFFSET_BITS flag, which implies that a maximal heap of 2^{HEAP}^{_{—}}^{OFFSET}^{_{—}}^{BITS} bytes is to be used. The largest bound specification, which a user may specify makes HEAP_OFFSET_BITS equal to the machine word size—1. This leaves one-bit or up to half the machine address space for containing the rest of the machine memory beyond the program's heap, including the program's stack for instance. Larger space allocation for the program heap is not recommended, even though the method may be modified to work with non-scalar, fat versions of its encoded pointers and reduced/scalarized variants thereof.

According to another embodiment, the incremental heap memory pool, pointers to which from the program are maintained in an encoded state such that the program's access to the heap memory pool may be verified for safety against the encoded metadata.

A memory layout for a static type is disclosed. The memory layout may comprise of bitwise representation of pointer-sized entities including pointer and non-pointer data, with one bit value representing a pointer datum and the other bit value representing non-pointer data. According to an embodiment, the memory layout may be generated by compacting a recognized repeat pattern in the layout into an un-repeated representation. According to another embodiment, the memory layout may be represented in a data structure comprising bitstrings of appended combinations of un-repeated bitstring pattern and one or more unrolls of repeat bitstring pattern.

According to an aspect of the invention, a pointer invulnerability compliance checks are based on a static type layout. The pointer invulnerability compliance checks may be lock-free and shared with memory access checks.

According to an embodiment, the pointer invulnerability compliance checks may be carried out dynamically for compliance operations comprising pointer casts, pointer arithmetic and stored pointer reads. The pointer invulnerability compliance checks may be static or dynamic and comprise layout or bitstring or layout key comparisons. The Pointer invulnerability compliance checks may be optimized if an object's layout does not comprise an un-repeated bitstring or if the repeat bitstring is not manifested in the un-repeated bitstring. According to an embodiment, the shared checking occurs when a compliance check operation dominates a memory access operation or a memory access operation dominates a compliance check operation or a set of one or more compliance check operations effectively dominates a memory access operation or a set of one or more memory access operations effectively dominates a compliance check operation.

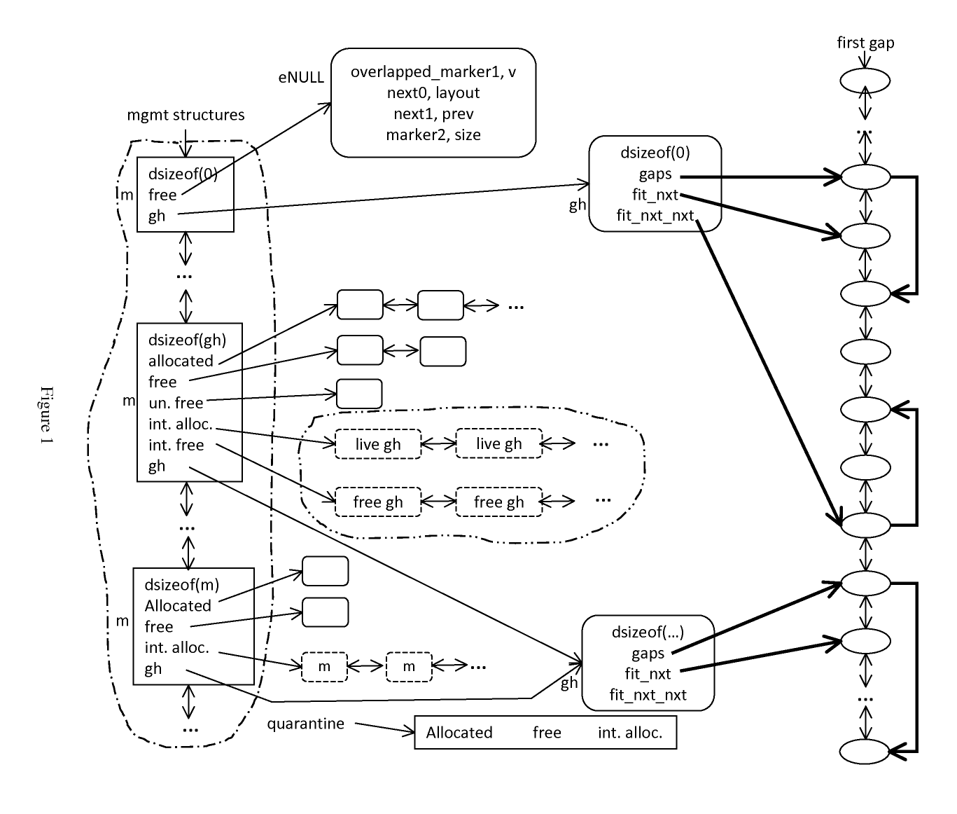

The memory and access management system 100 may manage the heap memory pool 102 via an arrangement of management structures, each for a specific allocation size used by the application program, as illustrated in FIG. 1. The management structures may comprise of a dsizeof(0) structure where dsizeof(0) is doubleword sizeof(0) and a dsizeof(gh) structure where gh is a gap header and a dsizeof(m) structure where m is a management structure, such that one or more of the structures are created at system initialization time. The dsizeof(0) structure may be configured for housing an eNULL object whose data size excluding meta-data is 0, the dsizeof(gh) structure contains gap headers on the internal allocated and internal free lists of the dsizeof(gh) structure and the dsizeof(m) structure contains management structures on the internal allocated list of the dsizeof(m) structure.

According to an embodiment, outside of paired creation times the total number of free or live gap headers equals the total number of arranged management structures in the heap memory pool at any time. According to another embodiment, the management structures may be arranged in a doubly linked list such that each management structure tracks at least five allocated/free object lists and one gap header (gh) pertinent to allocations of the management structure's size.

According to yet another embodiment, the gap header points to lists of gaps using fields gaps, fit_nxt, or fit_nxt_nxt wherein fit_nxt and fit_nxt_nxt point to consumable gaps and gaps points to non-consumable gaps. An allocation request with an existing management structure uses a free object or a consumable gap on the fit_nxt or fit_nxt_nxt lists unless none exist. According to yet another embodiment, the management structure creation may lead to a re-partitioning of the lists of gaps such that consumable-gaps stored on fit_nxt or fit_nxt_nxt lists are maximized. According to yet another embodiment, all objects and gaps in the heap memory pool may be doubleword aligned.

According to yet another embodiment, each gap created from a free object of doubleword size s by a garbage collector can serve allocation requests of doubleword size s among possibly others.

According to yet another embodiment, the object layout key identifies a layout data structure or a constant to represent that the object does not yet have a layout or the object's layout is special, such as for an eNULL object.

Referring to FIG. 1, three management structures are explicitly shown, one of doubleword sizeof(0) viz. dsizeof(0), another of dsizeof(gh), where gh is a gap header, and a third of dsizeof(m), where m is a management structure. The dsizeof(0) management structure is at the head of a doublylinked list of management structures arranged by increasing size. The dsizeof(0) structure is also called the eNULL management structure since the structure houses the eNULL object whose data size excluding metadata is 0. Dsize of an object is its data size (excluding metadata) rounded up to the nearest doubleword.

The eNULL object showing the metadata layout of any object is shown in the FIG. 1. Also shown at the extreme right is a doubly linked, location-wise sorted list of available space gaps (egaps) in the heap with the head of the list pointed by first gap. The gh field of management structures points to gap headers, each pointing to up to three lists of gaps shown in bold lines. The management structure of gap headers, of size dsizeof(gh), illustrates the fields of a management structure. Regular allocated objects of this size reside on the allocated list; similar is the case for free objects on the free list. The unusable free list contains free objects of this size, which are awaiting a version increase for further use. The internal allocated list and internal free list point to internally managed allocated and free objects respectively, which for this size are the gap header objects. Gap headers are kept away from user allocated objects in these lists instead of the regular allocated and free lists. Similarly, the management structure for dsizeof(m) contains management structures as internal objects on its internal allocated list. Gap headers and management structures are created as pairs together. Outside of such paired creation times, the total number of gap headers (free and live) equals the total number of arranged management structures at any time and this is shown by circling the two sets by broken lines in the figure. Quarantine is an isolated management structure that houses objects with a dangling pointer to them. According to another embodiment, the garbage collector may further configured to quarantine the live or free objects having a dangling pointer.

Increase in heap memory pool 102 may be requested from the operating system/process following a version of the standard C malloc( ) interface, whereby the freshly-obtained memory is stored in a gap linked from a pertinent management structure. Similarly, memory to be returned to the process may be freed using the version of the standard C free ( ) interface whereby it is guaranteed that some memory block of the named size will be freed, as soon as it becomes safely available. This may be immediate, if an equal or larger free gap is available in the heap memory pool, or it may happen after intervening garbage collection(s) that make such a gap safely available. As per user specification, the freeing may be done in consultation with a map of the heap memory pool, to keep the heap unfragmented.

The memory and access management system 100 may be fully automatic for the entire specified C/C++ language (and not just a restricted set of heap types used by a compiler backend), does not use user input via annotations, works using automatically generated object layouts that are computed and used for the collector purpose as well as for ensuring that access through pointer casts/unions complies with the heap object type assumptions. Structurally, the Memory and access management system 100 consists of an encoded pointer as its fundamental unit. For conservative garbage collection, a putative encoded pointer may always be exactly decided by locating its heap object via a hash table search. Pointer misidentification, viz. mistaking integers for pointers, may be much less of a concern in the memory and access management system 100 due to the rigorous screening of pointers using markers.

According to another embodiment, pointer misidentification, viz. mistaking integers for pointers, is much less of a concern in the memory and access management system 100 due to the intricate pointer structure with multiple sub fields that generate values that are unlikely to be the common integral values (0s, 1s, characters etc.). In memory and access management system's conservative garbage collector, a value may be considered a pointer if and only if it makes up an encoded pointer to a heap object. The use of invulnerable pointers ensures that all pointers are encoded pointers with properly associated heap objects. Memory accesses are carried out using invulnerable pointers only, which ensure that only safe memory accesses occur and memory outside (live) heap objects is not accessed. Thus, the memory and access management system 100 only needs to search transitively through the live program memory and not the entire accessible machine memory as traditional conservative collection is obligated to do for out-of-bounds pointers, dangling pointers, un-initialized pointers etc. discussed earlier. Handling interior pointers, out-of-bound pointers are straightforward in the memory and access management system's conservative garbage collector due to the metadata contained in encoded pointers and objects. The memory and access management system 100 may not organize or search through the heap space as pages. The memory and access management system 100 organizes heap space as size-wise partitioned allocated/free objects and sorted egaps. An egap structure may contain small or large spaces of the heap (many pages) from which allocations are carried out. The sorted egap and the three gap-related queues in gap headers may help defragment the heap by maximizing matched allocations and enable inexpensive coalescing of gaps (within a constant-space garbage collector).

In memory and access management system, if an integer i is sought to be cast to a pointer, then invoking encode(i) using the memory and access management system 100 provided primitive creates an encoded pointer for the integer with object bounds taken from the object to which i is inbound. This is feasible in Memory and access management system 100 because an object list is tracked and lookup simplified using markers in the objects. Further, Memory and access management system 100 obtains its safety properties by using compliance checks and not by de-legitimizing intra-object overflows (discussed below) so sub-object bounds are neither used, nor needed for integer-to-pointer conversions.

In memory and access management system, the compliance checks allow pointer arithmetic and casts to access any non-pointer or byte data in any format. Thus using a pointer to one byte member in a struct, the adjacent byte members of the struct may also be read/written by pointer arithmetic and dereferences, regardless of their type. Similarly, access permitted for pointer data may be allowed access to only pointer data and not bytes. The segregation of pointer and byte data access is enforced by the memory and access management system.

In Memory and Access Management System, to fit compliance constraints, the CETS program fragment presented earlier, suitably re-expressed is:

### Code 1: A Code for Compliance Constraints is as Follows:

int ** ptr;
int * ptr1 = ...; // *ptr1 = 1;
int * ptr2 = ...; // *ptr2 = 2;
*ptr = ptr1;
free(ptr1);
*ptr = ((int *) encode(decode(ptr2)));
return **ptr;

The Memory and access management system 100 will return 2 as the answer of this code. If this code is used literally for CETS with ((int *) ((long) ptr2)) substituting for ((int *) encode(decode(ptr2))), then CETS will still throw a violation since it will assign an INVALID_KEY to the resulting pointer.

According to another embodiment, there is no capability store or capability table or capability page table in the memory and access management system 100 that is

required to be looked up each time a memory access using an object is carried out. According to another embodiment, the overheads for temporal access error checking in the memory and access management system 100 may asymptotically be guaranteed to be within constant time. Furthermore, since each object has a dedicated version field, the space of capabilities in the memory and access management system 100 is partitioned at the granularity of individual objects and is not shared across all objects and may be more efficient than a capability as a virtual page notion of Electric Fence, PageHeap, etc. This feature lets the memory and access management system's versions to be represented as a bitfield within the word that effectively contains the base address of the referent (as an offset into a pre-allocated space for an incremental heap), which means that the memory and access management system 100 saves one word for capabilities in comparison to the encoded fat pointers for Safe-C without compromising on the size of the capability space. Since versions are tied to objects, the object or storage space may be dedicated to use solely by re-allocations of the same size and object size may be saved with the object itself, thus freeing one more word from pointer metadata. The resulting standard scalar sizes means that the memory and access management system 100 encoded pointers assist backward compatibility, avail of standard hardware support for atomic reads and writes, and achieve higher optimization via register allocation and manipulation.

While only one version number may be generated per allocated object in the memory and access management system, a large object may span a sequence of virtual pages, all of which may populate the memory management unit (MMU) and affect the performance of MMU as is typical. Versions are typed by object size and are table-free in terms of lookup. This implies that the version lookup cost is guaranteed to be constant for the memory and access management system.

According to another embodiment, the memory and access management system 100 may treat memory violations both temporal and spatial in an integrated manner. Versions are substantially more efficient in the virtualization they offer to objects. The virtualization overhead for memory and access management system 100 may comprise of a small constant addition to the object size. Virtual space overuse (simultaneously live objects) has no concomitant performance degradation for memory and access management system.

The memory and access management system 100 detects memory access errors at the level of memory blocks. A memory block may comprise the least unit of memory allocation such as a global or local variable, or the memory returned by a single invocation of malloc. The memory and access management system 100 detects all memory access errors at this level. By detecting memory access errors at the level of memory blocks, the memory and access management system 100 targets the general pointer arithmetic model with dereferences disallowed only when they cross allocation bounds and not while they remain within and comply with the layout. So for instance, a safe memcpy( ) may be written that takes an element pointer of a struct and copies up or down without exception so long as the function remains within the allocated memory for the struct and does not trespass upon encoded pointers (or copies encoded pointers and does not trespass upon non-pointer data). Arithmetic may cause a pointer to cross allocation boundaries arbitrarily, only dereferences have to be within the allocated memory.

According to another embodiment, the memory and access management system 100 may not impose any object padding for out-of-bound pointers either. The memory and access management system 100 supports general pointer arithmetic (inbound/out-of-bound) over referent objects.

According to another embodiment, the memory and access management system 100 may capture all dangling pointer errors and spatial errors (e.g. dereference of a reallocated freed object or dereference past a referent into another valid but separate referent).

According to another embodiment, the memory and access management system 100 may allow complete flexibility on how non-pointer storage is accessed, compliance only verifying that pointer accesses occur to pointers and arbitrary non-pointer access occurs to non-pointers.

In the memory and access management system, since all pointers are scalar, atomic reads and writes over the pointer type are obtained. In the memory and access management system, efficiency over wild pointers and objects may be obtained by not having tags per object and instead working with the compact, pointer-grained, static layouts of static types. Further, efficient compliance checking may be carried out in type casts and pointer arithmetic of encoded pointers with the effects of this checking shared with the checks carried out for pointer dereferences so that bulk efficiency is obtained. This set of static and dynamic compliance checks may be based on layout representation of the static types of objects and operations. The type of an object may be static as far as defining its pointer locations is concerned in the type layout. The non-pointer storage may be allowed any non-pointer type assignment or interpretation. Finally, the memory and access management system 100 may provide a fully manual and fully automatic space management where free( ) is not a no-op.

The memory and access management system 100 allows all modes of safe and efficient operation of a program, with free( ) calls, or with garbage collectors alone or both. Manual management in the memory and access management system 100 may be used to defer and reduce garbage collectors expenses so that improved overall performance is obtained while safety is fully preserved.

According to another embodiment, the memory and access management system 100 may provide much better support for backward compatibility using scalar-sized fat pointers. The memory and access management system 100 may provide encode and decode primitives that automatically translate a (long) scalar to an encoded pointer and vice versa. Using a try block for backward compatibility provided by the memory and access management system, data structures with encoded pointers may be translated to data structures without encoded pointers and library code called with Standard C assumptions from the try block. The returned results may have their un-encoded pointers encoded, for use outside the try block. Similarly, unprotected code manipulating pointers as integers may be provided unencoded pointers at the time of the cast to integer and a cast from integers can be converted into encoded pointers using the encode( ) support of the memory and access management system.

According to an embodiment, the memory and access management system 100 presents a comprehensive solution of the version recycling problem that can handle all kinds of live straggler pointers and non-live/dangling straggler pointers to live/non-live objects and make progress in version recycling by making the optimal choice among the options it exposes while working within constant space overhead.

### Data Structures

### Objects and Encoded Pointers

An object in the heap memory pool may be characterized by version, multiple purpose-overlapped watermarks (or multi-purpose watermarks or markers), and bookkeeping data, as shown in the code 2 below. The version of an object may be a name of an incarnation or lifetime of the object. Incarnations are separated by free-to-heap and allocate-from-heap commands. The total set of names is 2^{VERSION}^{_{—}}^{BITS}, where VERSION_BITS=bits in a machine word—HEAP_OFFSET_BITS, so names must be recycled by the memory and access management system 100 when objects run out of names for their incarnations. In memory and access management system, the names supply may be tracked on an object-size-wise shared basis, with version recycling or name reuse carried out safely by the memory and access management system 100 ensuring that a reused name cannot clash with a remembered name (of a past incarnation), while maximizing the supply of names for incarnations.

According to yet another embodiment of the invention, the object data part may comprise a meta-data part, the meta-data part may include one or more fields for storing next and previous links of objects for a doubly-linked object arrangement and for storing an object layout link, version, size, markers or multi-purpose markers.

According to another embodiment of the invention, the pointer of the object may be maintained in an encoded state.

### Code 2: A C Pseudocode Describing an Object and an Encoded Pointer is as Follows:

```
typedef unsigned long word;
#define HEAP_OFFSET_BITS ... // user-specified number
#define HEAP_SIZE (1 << HEAP_OFFSET_BITS)
#define VERSION_BITS
    (sizeof(word) * CHAR_BIT − HEAP_OFFSET_BITS)
#define NUMBER_OF_VERSIONS (1 << VERSION_BITS)
typedef struct object0 { // Assumes Big Endian Layout
        word overlapped_marker1 : HEAP_OFFSET_BITS;
        word v : VERSION_BITS;
        word next0 : HEAP_OFFSET_BITS − VERSION_BITS;
        word layout : 2 * VERSION_BITS;
        // typical settings
        word next1 : VERSION_BITS;
        word prev : HEAP_OFFSET_BITS;
        word marker2 : VERSION_BITS;
        word size : HEAP_OFFSET_BITS;
} object0;
typedef struct { // Assumes Big Endian Layout
        word b : HEAP_OFFSET_BITS;
        word v : VERSION_BITS;
        word ptr; } ep;
typedef unsigned long long epv;
```

Watermarks, or fixed, random bit patterns, also called markers, namely marker2 and overlapped_marker1, are used by the memory and access management system 100 as digital signatures on the objects to distinguish them from a random memory. The watermarks are further overlapped with tag and count purposes safely, while retaining the watermark purpose with very high efficacy. The use of multiple, large watermarks summing typically to one word of bits amplifies and ensures the effectiveness of the watermarks. Multiple assignments to memory are required to generate the watermark pattern of an object as the watermarks are more than one word apart in memory. The amplified watermarks typically commit one word of memory so the performance of the watermarks is minimally guaranteed, while overall budget for the metadata of an object is kept down to two double words (doublewords). Like the C-standard malloc( ) object allocation in the memory and access management system 100 occurs on double word boundaries because each object needs to be capable of storing data of all alignments. Minimum metadata for an object therefore commits one double word of extra memory, which is largely taken up by bit fields storing next and previous links for enabling a doubly-linked-list structure of objects for constant-time insertion and deletion from the lists. The memory and access management system 100 commits a second double word of memory for each object, so as to store the version, size and type layout of an object with itself for quick lookup for safety checking purposes. Layout checking guarantees the inviolability of safety properties, regardless of user intent. Layout checking also reduces cost by replacing multiple individual checks by bulk checks. Watermarks piggyback these two double word commitments for object metadata space and achieve tremendous benefit as the rest of this disclosure shows.

Code 2 provides for an encoded pointer representation comprising of a bit-field containing the base address, b, of an object, the name or version, v, of a particular incarnation of the object, and an ordinary, un-encoded pointer, ptr, to a specific address (typically within) the object. Since out-of-bound excursion for ptr is allowed, the entire machine memory may be accessible by ptr. Among other benefits, this decision allows fast decoding of an encoded pointer if checking is not mandated. This may comprise a simple lookup of ptr, which is just the second word of the double word encoded pointer. Additionally, the design of an encoded pointer ensures fast access of the two bit-fields. The bit-fields are accessible by structure member lookup in the encoded pointer structure. Alternatively, as illustrated in code 3, the bit-fields lookup for v, get_v(p), comprises masking off the higher bits in the first word of the encoded double word pointer using a bit-wise & operation which is typically implemented in parallel in hardware registers. This ensures a fast lookup of the version bitfield, the implementation of which may be specified in C (high-level language) or assembly language (low-level language), following code 3. Similarly, accessing b, get_b(p) comprises a right shift, >>, of the first word of the double word pointer. Since right shift may be implemented sequentially in hardware registers, the right shift occurs by only VERSION_BITS, which is typically the smaller bit-field occupying the word. This keeps the cost down in sequential register implementations and get_b(p) cost comprises the right shift and a parallel and masking operation. Accessing the layout, size and version bit-fields in an object is fast similarly, comprising reading the corresponding word of the object metadata and masking off the higher bits using a bitwise &.

Within the memory and access management system 100 implementation, an encoded pointer is allocated and passed around as a double word unsigned long long quantity (type epv). The epv view ensures that the encoded pointer is aligned on double word boundaries. This simplifies the layout checking and speeds up the searching for pointers in memory during garbage collection. Although, the encoded pointer may be passed around as epv, the epv view and the ep view of an encoded pointer are not made available to a user code so the user cannot inspect or manipulate the encoded pointer as a long long or a struct quantity. The layout checking described in this disclosure ensures that the encoded pointer may be visible to the user solely as some black box pointer type that only supports standard pointer operations but otherwise cannot be inspected or modified. The epv view remains the memory and access management system 100 implementation-specific type, providing an internal, alternative view of an ep, ensuring encoded pointers are double word aligned.

### Code 3: A C Pseudocode Describing Alternate Bitfield Lookup Methods:

#define HEAP_OFFSET_MASK (HEAP_SIZE − 1)
#define VERSION_MASK (NUMBER_OF_VERSIONS − 1)
#define get_v(p) (*((word *) &p) & VERSION_MASK)
#define get_b(p) ((*((word *) &p) >> VERSION_BITS) &
HEAP_OFFSET_MASK)

Referring now to code 4, Data structures underlying the memory and access management system 100 are shown. Protected_heap_first is the first location in a contiguous space that may be supplied incrementally and non-contiguously by the surrounding process during program run. Many definitions for this are possible, one preferred definition may be placing the initial contiguous space with which memory and access management system 100 begins to run, at the smallest location in the overall contiguous space. INITIAL_LAST_VERSION is the initial value assigned to various last version variables that track version reuse in memory and access management system. A management structure is identified by its size field, which defines the double word rounded size of objects tracked by the structure in the heap. Management structures are arranged in a doubly linked sorted-by-size list, wherein each management structure tracks five allocated/free object lists and one gap header (gh) pertinent to allocations of the structure's size. The last_version variable tracks version reuse among objects in the management structure's lists. The free_count variable tracks pending commitments to freeing objects of the management structure's size back to surrounding process/OS, whenever safely possible. A map of the Heap may be consulted when freeing memory from the Heap to ensure that the heap does not get fragmented as a result, as per user specification. The doubly linked management structures are sorted by size and the head of this list is pointed to by the variable queues (queues is called mgmt structures in FIG. 1). Global variables to all the management structures explicitly illustrated in FIG. 1 are shown by code 4. The global variable gaps_head points to the head of the sorted doubly linked list of egaps in the Heap (referred to as first gap in FIG. 1).

According to an embodiment, an extended gap (egap) structure, a type of memory management structure is disclosed. The extended gap structure may comprise of at least four fields stored at one end of an unused memory block of a heap memory pool comprising of a first field pointing to the other end of the memory block, a second field pointing to a list of gaps, a third and fourth field maintaining a doubly-linked list of gaps according to location-wise sorted order among gaps representing the entire set of unused memory blocks in the heap memory pool.

According to yet another embodiment of the invention, the extended gaps in a sorted state may defragment the heap memory pool by maximizing matched memory allocations that consume an extended gap apiece, and enable linear time coalescing or addition of gaps within a constant-space garbage collector.

The egap may be designed to represent unused memory in the Heap. The garbage collector inherits leftover spaces or egaps from a previous garbage collector phase, followed by adding new spaces for the free objects collection. So long as each free object can be represented by an egap, all the added spaces may be represented in the system without losing track of any. The smallest free object is the eNULL object, of size sizeof(object0)=2 doublewords. The egap may be able to represent this smallest space and therefore is sufficient to represent all the spaces that are enountered in the Heap.

The extended gap (egap) of two double words size with no requirements of padding and comprising four pointers is the basic data structure of the gap system contained in the memory and access management system. The egap structure is laid out within the free memory block it represents. The egap structure may occupy the last two double words in its memory block. The first field of the egap structure, start, points to the beginning of the free memory block. The next field of an egap is used to construct linked lists of egaps for management purposes. It is desirable to arrange the memory blocks represented by egaps sorted according to their memory positions. This may be possible in the disclosed structure of egaps since an egap and the associated memory block are designed collocated so the order among the egaps also gives the order among its memory blocks. The location_next and location_prev fields of an egap are used to maintain all egaps in sorted order according to memory location.

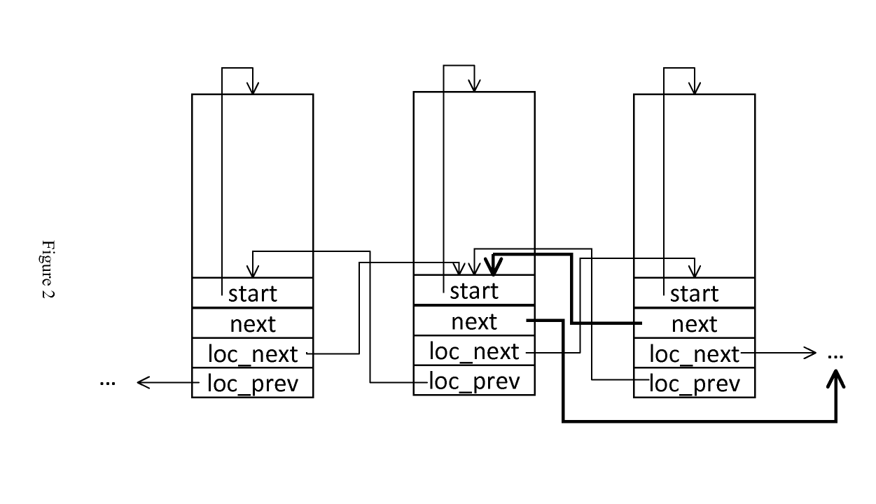

FIG. 2 illustrates the layout of a few egaps diagrammatically in accordance with an embodiment of the invention. This figure shows three egaps arranged left-to-right according to location order. The middle egap provides its information completely—its start field point to the beginning of its memory block; there are three pointers to the egap; one of these incoming pointers comes from the next field of another egap (the right egap) and two of the incoming pointers come from the loc next and loc prev fields of location-wise neighboring egaps (left and right); the middle egap itself points to some unspecified next egap and its loc next and loc prev fields point to the right and left egaps respectively. As the egap is consumed, the start field continuously gets modified and moves across the memory block towards the end of the memory block. When the start field of egap ends up pointing to the egap itself (the start field), the egap has no free memory left and the two double words it represents comprise the egap itself. Such an egap may still be allocated from for the two double words and the egap then gets consumed and no track of it is left in the egap system. In such a case the egap ends up getting deleted from the location-wise doubly linked list-comprising egaps. Such a consumption of an egap is preferred, as it helps de-fragment the system. When egaps are created as a result of garbage collector, the egaps doubly linked list is modified by the insertion of new egaps into it.

According to another embodiment of the invention, maintaining egaps as a doubly linked location-wise sorted list of egaps has many advantages:
Defragmenting the memory system, by merging adjacent gaps into larger gaps is straightforward, given a sorted list.
Deletion of a gap upon consumption in allocation takes constant time and a similar benefit may be obtained for position-specific insertion of a gap. Concretely, a garbage collector adds a sorted list of free objects as gaps to the existing sorted, doubly-linked list of egaps, which requires linear time traversal of the two lists. This amortizes to constant cost per existing egap and the free object, for the combined activities of gaps coalescing and new gaps insertion.
Since the sorted order is always maintained, there is no explicit, single, expensive sorting activity encountered by the memory and access management system 100 for managing its gaps and the constant-space design of Memory and access management system's garbage collectors is simplified.
All memory blocks, regardless of size are tracked seamlessly in the heap memory pool, without the memory and access management system 100 losing track of any (i.e. lossless tracking of gaps).

The gap header (gh) points to gaps through its three list pointers (gaps, fit_nxt, fit_nxt_nxt). The gap header may be pointed to by management structures in turn. The size of a gap header equals the size of some management structure that it is said to match. Each egap pointed to by the gap header is guaranteed to have enough space in it to meet an allocation request of the size of its matching management structure in a non-consuming allocation. A consuming allocation relates to deleting egap from the location order of egaps and the memory block of egap, including the egap is fully used to satisfy the allocation. A non-consuming allocation is one in which the memory block of an egap is only partially consumed and the egap structure is left intact for representation in the location order and a (next-based) list of egaps. Every allocation in the memory and access management system 100 is either consuming or non-consuming.

Memory and access management system 100 maintains the invariant that the range of egaps pointed to by a non-zero-sized gap header comprises all egaps that may allocate without consumption for its matching management structure size minus egaps that can allocate without consumption for larger management structures.

In the above invariant, the excluded larger egaps are left for larger sized gap headers that would match the larger-sized management structures.

The gap header of size 0 entertains no allocation requests (any such request summarily returns (an encoded) NULL pointer). This gap header may therefore allowed the exception of storing all small gaps (i.e. gaps with less space than what a non-consuming allocation for this gap header would require). Examples of such gaps are egaps with no space beyond the doubleword egap structure itself and egaps with one doubleword of space besides the egap structure itself. The space in these gaps may not be enough to store the two double word object0 metadata of an object in a non-consuming allocation. In short, the gap header that matches a 0-sized management structure serves as a bin for tracking all small gaps.

A management structure points to the smallest gap header from which it may get gaps for a non-consuming allocations or NULL if none exist.

According to yet another embodiment, the gap header points to lists of gaps using fields gaps, fit_nxt, or fit_nxt_nxt wherein fit_nxt and fit_nxt_nxt point to consumable gaps and gaps points to non-consumable gaps.

The gaps pointed by a gap header are partitioned into three singly linked lists. The fit_nxt list contains gaps that may meet consuming allocations of a size equal to the matching management structure's larger neighbor, in case it exists. The fit_nxt_nxt list contains gaps that may meet consuming allocations of a size equal to the matching management structure's larger neighbour's larger neighbor, if it exists. All the other gaps for the gap header are placed in the gaps list of the gap header. Whether a gap may be used for a non-consuming allocation or a consuming allocation depends on the supply-demand situation of allocation requests and gaps at runtime. The ordered-by-size management structures are indexed at three places by global variables. The 0-sized structure may be indexed by queues, which typically serves as the head of the doubly linked management structures. The management structure that serves allocation requests for gap headers may be often used, justifying the use of a direct index to it called gap_header_management.

Similarly, management_management serves allocation requests for management structures. Quarantine points to a management structure used for tracking objects with pointers to expired object incarnations. These dangling pointers complicate recycling of incarnation names (versions) and are tracked separately via the quarantine structure.

The head of the location-ordered gaps is gaps_head (points to the gap with smallest location). OVERLAPPED_MARKER1 and MARKER2 are arbitrary bit patterns used for watermark definitions. OVERLAPPED_MARKER1 is a multi-purpose marker with co-existing marker and non-marker interpretations. The bit pattern of OVERLAPPED_MARKER1 may also be interpreted along its overlapped meaning that co-exists with its marker purpose. The bits interpretable as count bits find that their interpretation as count or marker occurs at disjoint times. Thus full flexibility to specifying bit patterns in these overlapped bits is available. The bits interpretable as tag bits (lower 4 bits) find that their interpretation as tag bits occurs concurrently as marker bits. The marker bit pattern for the live tag bit is taken to mean free object; the marker bit pattern for the progress tag bits is taken to mean unprogressed/initial status and the marker bit pattern for the quarantine tag bit is taken to mean not quarantined. For convenience of this disclosure, these marker bits are all assigned the 0 value, thereby reserving 0 for the overlapped meanings above. This is solely for convenience and efficient implementation and any other bit pattern could well have been chosen.

### Code 4: A C Pseudocode Describing Management Related Data Structures and Definitions is as Follows

```
void * protected_heap_first;
#define INITIAL_LAST_VERSION (NUMBER_OF_VERSIONS − 2)
typedef struct gap {
    void * start;
    void * end;
    struct gap * next;} gap;
typedef struct extended_gap {
    void * start;
    struct extended_gap * next;
    struct extended_gap * location_next;
    struct extended_gap * location_prev;} egap;
typedef struct {
    word size;
    egap * gaps;
    egap * fit_nxt;
    egap * fit_nxt_nxt;} gap_header;
typedef struct management {
    word size;
    word last_version;
    word free_count;
    object0 * allocated;
    object0 * free;
    object0 * unusable_free;
    object0 * internal_allocated;
    object0 * internal_free;
    gap_header * gh;
struct management * next;
struct management * prev; } management;
management * queues = NULL;
management * gap_header_management;
management * management_management;
management * quarantine;
egap * gaps_head;
#define MARKER2 ... // a value representable in VERSION_BITS
#define MARKER_TAG_BITS 4 // 4 lsbits encode marker variants.
#define OVERLAPPED_MARKER1_MASK (HEAP_SIZE − 1 − 0XF)
#define OVERLAPPED_MARKER1 ... // a value representable in
    // HEAP_OFFSET_BITS keeping lower 4-bits at default tag value
#define OVERLAPPED_MARKER1_COMMON
OVERLAPPED_MARKER1
#define QUARANTINE_MASK 2
#define QUARANTINED 2
#define NOT_QUARANTINED 0
```

An object is ordinarily not quarantined, unless a garbage collection phase discovers dangling pointers for it. Once quarantined, the allocation and deallocation requests treat the object differently since insertion/deletion from allocated/free queues now has to occur off the quarantine structure as opposed to ordinary management structures. Testing the overlapped_marker1 value after masking with the QUARANTINE_MASK tells whether an object is quarantined or not.

A quarantined object is segregated from version reuse by allowing at most one free( ) operation on it while it is in quarantine. The quarantine status is discovered and modified during garbage collection, when all dangling pointers are collected. The quarantined object may be de-quarantined once garbage collector discovers that all dangling pointers to it have disappeared. Likewise, a normal object is quarantined once garbage collector discovers a dangling pointer for it. Since a quarantined object is not reallocated as a live object while in quarantine, it does not reuse the version space. This is useful in working with the object and its version in the isolated setting of the quarantine and later in successfully de-quarantining it. For normal objects, versions are routinely reused via garbage collector, with version analysis proceeding under the partitioning assumption that a quarantined object is not a part of the objects and versions it analyzes. Thus, version analysis may be simplified by removing non-live or dangling straggler pointers to both live and free objects from its purview. Three queues of the quarantine management structure are actively used—quarantine->allocated (for storing live, quarantined objects), quarantine->internal_allocated (for storing ready-to-dequarantine objects that are awaiting acceptance by the corresponding normal structure), and quarantine->free (for storing quarantined free objects).

### Internal Object Management

Gaps, gap headers and management structures comprise internal objects of the memory and access management system. The safe use of these objects is guaranteed by the memory and access management system 100 implementation and hence encoded pointers for the objects are not needed. Since these objects do not have encoded pointers to them, the root set of encoded pointers in a program (stack, globals data, registers) cannot trace out these objects. If the objects are kept on the same allocated lists as ordinary, encoded-pointer objects, the objects may find that they are not traced out or marked by garbage collector, thereby identifying them as memory-leak objects (object live, yet no pointers to it). To prevent this from happening, the gap headers and management structures are kept on internal allocated lists pointed from management structures, separate from the allocated lists of encoded-pointer objects.

A dynamically created management structure is allocated as a pair, with a gap header being allocated along with it. The management structure allocation operation comprises the pair allocation and is said to be successful if the pair is allocated as a whole. Within the pair allocation, the management structure is allocated first, with the gap header allocation occurring second. An unsuccessful pair allocation is rolled back, so the management structure allocation operation is atomic in nature. Depending upon space availability, three possibilities are encountered: both members of the pair are allocated, only the first member is allocated, neither is allocated. If both members are allocated, the operation is said to be successful and is not rolled back. If neither is allocated, the allocation is unsuccessful and the rollback is trivial (no effort required).

If only the first member (the management structure) is allocated, then the operation is unsuccessful and is rolled back as follows: the allocated management structure is freed to the free queue (see management_management structure, code 4). In this case, the object0 of the freed management structure continues to participate in the version tracking carried out by memory and access management system, typically acquiring a successor version to the one that the management structure was allocated with.

According to an embodiment, outside of paired creation times the total number of free or live gap headers equals the total number of arranged management structures in the heap memory pool at any time.

According to another embodiment, explicit deallocations of management structures are not carried out. This means that if management structure (pair) allocations are viewed atomically (fully carried out or not at all), then management structures only increase monotonically in a program run. Furthermore, continuing the treatment of management structure allocations as atomic operations, memory and access management system 100 maintains the following invariant: the number of gap headers equal the number of arranged management structures at any time. Once a gap header has been allocated from fresh space paired with a management structure, it undergoes deallocations and allocations throughout the program run. However, these deallocations/allocations only shift the gap header in-between the internal free and internal allocated queues, with the gap header never being used for any purpose other than a gap header. This is illustrated by the circumscribing of gap headers and arranged management structures in FIG. 1 with dotted lines. By undergoing timely de-allocations, each gap header satisfies the following invariant: the gap header is immediately deallocated upon being emptied of gaps. Objects maintained on the internal allocated/free queues (specifically gap headers, management structures) never change the version of their first allocation.

eNULL: The Encoded NULL Pointer and Object

The encoded equivalent of a NULL pointer is an eNULL pointer of type ep. Decoding an eNULL pointer yields NULL, which then specifies the value of the ptr field of the eNULL pointer (eNULL.ptr==0). Just as NULL dereferences are illegal, eNULL dereferences are disallowed as follows: The eNULL object is kept as a free object, so eNULL dereferences are disallowed by memory and access management system's temporal check against dereferencing free objects (a version mismatch check). The temporal error check (version check) carried out in a free attempt of the eNULL free object catches the attempt as freeing a free object. Thus the singleton version test common to all memory and access management system 100 checking against regular objects doubles as an overloaded check peculiar to the eNULL pointer and allows its treatment as a special case. No extra burden is imposed by eNULL checking along the fast path (check passes path) of memory and access management system 100 checking. Only when a check fails (viz. slow path, specifically the version check), does the memory and access management system 100 do the extra work of discriminating eNULL treatment against other objects' treatment.

The eNULL object may be a free object of 0 width. The eNULL object comprises the metadata object0 alone (see FIG. 1). The spatial check for ensuring inbounds dereferences alone may catch the eNULL pointer dereferences straightforwardly, since no eNULL.ptr value is inbound, given its 0 width.

Encoding a NULL pointer/decoding an eNULL pointer is cognizant of the special representation of the eNULL pointer and object (that the pointer is both out-of-bounds and non live) unlike other encoded pointers, which are required to be inbound and live.

Given that the eNULL pointer is non-live, the eNULL object may be quarantined. However, since it is a special case, an implementation can choose to keep it out of quarantine on the free list of queues, the management structure of size 0, as shown in FIG. 1.

### Safe Dereferences in Memory and Access Management System

Prior to memory dereference, an encoded pointer is checked for safety as it is decoded. In case safety is otherwise known, then a simple decode operation may be carried out. Both the operations are described below:

1. Check and Decode an Encoded Pointer:

From an encoded pointer p, a pointer o to the object is computed as o=protected_heap_first+p.b. The metadata for the object is looked up. The temporal check comprises comparing p.v for equality with the object's version. The spatial check for object dereference comprises checking that p.ptr>=o && p.ptr+t<=o+size, where t is the size of the type of data being dereferenced and size is the object's size obtained from its metadata. The spatial check for freeing/deallocating the object comprises checking that p.ptr==o. All these computations are constant time operations and use the inexpensive bitfield accessors for p and its object as described earlier.

2. Decode:

Decode is a constant overhead operation comprising of simply reading the un-encoded pointer field of an encoded pointer.

### Secure Encoded Pointers: Layout Compliance

At a user level, Memory and access management system 100 disallows internal inspection and manipulation of an encoded pointer. So for instance, a user is not allowed to union an encoded pointer with the type ep and read the internal bit fields of the encoded pointer. Similarly, the user may not be allowed to construct an encoded pointer by casting a non-pointer value, e.g. long to a pointer value. Using dynamic checks, this disallowance is system-verified, ensuring that encoded pointers comprise only the ones that memory and access management system 100 itself generates. Encoded pointers are thus secure values that cannot be altered regardless of malicious or mistaken intent and encoded pointers may guard resources requiring security.

According to another embodiment, the invulnerability compliance checks placed by the memory and access management system 100 to ensure security of encoded pointers are herein described.

Every object in memory and access management system 100 carries a pointer to a layout, showing at double word alignment, which locations contain encoded pointers and which do not. Since encoded pointers are double word aligned, layout provides complete resolution for individual pointers as atomic entities that an object may store. The layout abstracts away details of finer non-pointer values that the object may store such as bit fields, padding, byte-aligned characters, etc.

The object may be required to acquire its layout at the first pointer cast undergone by its pointer. Thereafter, access to the object with any pointer is allowed, so long as the type of the pointer is compliant with the layout of the object viz. does not view a pointer as a non pointer or view a non pointer as a pointer. As shown in code 2, the layout bitfield of an object stores an index/key for the layout it is affiliated with. The number of layouts is bounded by the first cast operations (of allocated objects) in a program and is typically less, since many such operations may share the same layout. The layout field therefore requires log₂(N) bits to index the layouts, where N is the total number of type layouts in the program. This number is expected to be a small quantity, with the memory and access management system 100 reserving bits spared by next and previous links in a double word of metadata space to support the layouts. The next and previous links require minimally HEAP_OFFSET_BITS apiece to index the Heap leaving a total of 2 * VERSION_BITS free. This quantity may typically be used by memory and access management system 100 for the layout field, unless the program requires more, in which case bits are first taken away from marker2, followed by the count-overlapped bits of the overlapped marker1, leaving a minimum of a half word of bits for the overlapped_marker1 bit field. This lower-bounded marker space ensures that the marker function guarantees at least half word worth of efficacy, while typically providing more as layouts are not expected to require so much of space.

### Code 5: A Code Describing Layout Grammar for C99 Types is as Follows:

Bytes::= B
Pointer ::= P
Doubleword ::= Bytes | Pointer
Doublewords ::= Doubleword Doublewords | [ Doubleword ]
Prefix ::= Doublewords
Repeat ::= Doublewords
Layout ::= Prefix Repeat Times
Times ::= Number | *

Code 2 also shows the layout bit field for the typical setting of 2* VERSION_BITS. Given this setting, the storage for next0 and next1 bit fields gets decided, which together provide the bits for storing the next link (as an offset into Memory and Access Management System, requiring HEAP_OFFSET_BITS space total). The next link is scattered thus, since it is one of the least used bit fields in the object metadata during the non-garbage collector part of a program run. When garbage collection begins, a sweep through the objects straightforwardly changes the scattered next link into a single bit field (scattering another field in exchange, e.g. layout or size) for efficient access to the next field. This ensures that the small memory footprint of the memory and access management system 100 (only 2 double words of object metadata) continues to be efficient time wise also. Implementations of the memory and access management system 100 may choose alternate bit fields to scatter instead of the next link, for example scattering the prev link. Such variations are a part of the method described herein. The grammar for layouts is provided in code 5 with [ ] denoting an optional entity.

A memory layout for a static type is disclosed. The memory layout comprises a bitwise representation of pointer-sized or pointer-aligned entities including pointer and non-pointer data, with one bit value representing a pointer datum and the other bit value representing non-pointer data.

According to yet another embodiment, the memory layout is generated by compacting a recognized repeat pattern in the layout into an un-repeated representation.

Each object in the memory and access management system 100 is allocated on doubleword alignment, of a size that is rounded to a multiple of doublewords. The layout covers the allocated object and labels each doubleword in the object with a B or P. P, pointer, represents storage for an encoded pointer in the object, while B represents storage for non-pointer data or bytes. B-labeled storage may be accessed anywhere within its space using a pointer of any alignment, of non-pointer type, e.g. using a char * pointer. P-labeled storage can be accessed only with a pointer type, which in the memory and access management system 100 has double word alignment.

In order to keep the number of layouts small in a program, layouts are not defined as object-specific strings, but rather as type-specific strings. Objects are dynamically generated of different sizes, while types comprise a static, code-related entity tied to operations in the program such as casts and pointer arithmetic. Due to arrays such as flexible member arrays in C structures, for a given type, there can be many objects of different sizes that fit the type. The layout may be described by a prefix string and a repeat string wherein the repeat string characterizes the flexible array member of the object. In case the object is simply an array (sized, unsized, variable-sized), the prefix string is absent and the repeat string alone characterizes the array. When an array is statically sized, the Times field of a layout records the size of the array, in terms of repetitions of the repeat string that cover the array. If an array is not statically sized, the Times field is *, which signifies a dynamic number of repetitions, that can dynamically be obtained by looking up an object's size.

The memory and access management system 100 endeavors to find a minimal representation of an object layout by identifying the smallest repeat and prefix strings for the object. Thus, if the prefix preceding a flexible array member has a layout pattern identical to the array's repeat, the prefix is shortened and the repeat quantity increased to reduce the object layout. Similarly, if a repeat string itself is a multiple of a smaller repeat pattern within itself, the smaller repeat pattern is used, with the repeat quantity appropriately modified (multiplied by the multiple). Minimization thus reduces the storage requirements of layouts and also speed up compliance checks by ensuring smaller string comparisons or common factor comparison (when repeats are compared). As regards efficacy of string comparisons, since the bit strings comprise only Bs and Ps, which can be coded as 0s and 1s respectively, one double word of a 64-bit machine (unsigned long long) represents 128 individual bits equaling 128 double words or 128*16=2048 bytes of object memory in the program. Thus bit manipulations and equality comparisons on register contents can with great speed carry out bulk checks for even large objects.

In C, interpretation of the storage of an object can be changed only by pointer cast operations and unions. Additionally, pointer arithmetic may cause a storage region to be reached and interpreted according to the type of the pointer undergoing arithmetic. Thus layout compliance with an object is checked by the memory and access management system 100 for these operations in a program, with checking often ruled out statically itself, as described below. Compliance failure is either detected statically (e.g. for unions), or at run-time an exception is thrown.

The memory and access management system 100 does not rule out manipulation of pointers as arithmetic types. For this, a decode primitive provided by the memory and access management system 100 translates an encoded pointer into a decoded pointer—a long value containing the standard C pointer that a user can then manipulate. An arithmetic type can similarly be translated to a void * encoded pointer using a provided encode primitive. The encode primitive succeeds only if the standard C pointer is inbound to a live object or it is special (e.g. the NULL pointer, or a function pointer). Similarly, a decode operation succeeds only if an encoded pointer is live and inbound, or is special. Decode/encode failure results in an exception being thrown. It is to be noted that such translation to-and-from arithmetic types of encoded pointers is carefully controlled. In particular, it is not possible to generate encoded pointers to a non-heap object in any way.

Each cast or pointer arithmetic operation yields a pointer 1 to an object o and identifies it with a type T with which the storage from the 1 until 1+sizeof(T) is to be interpreted. The type T is statically available and commonly has a statically available sizeof(T). For each such operation in the program, the layout of type T is therefore statically available. The endeavor of compliance checking is to ensure that all accesses to the object o using location 1 with type T comply with o's layout.

According to yet another embodiment, the pointer invulnerability compliance checks are carried out dynamically for compliance operations comprising pointer casts, pointer arithmetic and stored pointer reads.

The pointer invulnerability compliance checks are static or dynamic and comprise layout or bitstring or layout key comparisons.

Layout checking for a stored pointer is not carried out with the containing object (that stores the pointer). It is carried out individually, upon actual dereference of the contained pointer. Read accesses to a contained pointer are staged as follows. First a dereference stores the pointer in a local variable. In this stage the compliance check of the pointer is carried out with its object. Next the local variable is used to access the pointed object. The object accesses of this second stage can save dereference check costs by bulking them in the compliance check of the first stage. The local variable can be optimized away also in this process (e.g. if multiple uses of the variable are not encountered).

Compliance operations that check for compliance of an object layout with the operation type comprise pointer casts, pointer arithmetic, and stored pointer reads, as discussed above. Additionally, unions generate static compliance checks.

### Compliance Checking Algorithms

According to yet another embodiment, pointer invulnerability compliance checks based on a static type layout are disclosed.

According to an embodiment, the pointer invulnerability compliance checks are static or dynamic and comprise layout or bitstring or layout key comparisons.

Code 6, as stated below, describes the data structures used for representing layouts in accordance with an embodiment of the invention. Given a type (of an object or compliance operation), a layout structure represents the type's layout. Layouts are stored in a layout store indexed by an integral key. An object carries the key of a layout in its layout bit field using which the layout structure of the object can be looked up. The key of a layout also facilitates a most common cast operation in programs, that is the cast of an object pointer to the object type (e.g. void * to T * where T is the type of the object). The compliance check for this cast comprises a check that the pointer is the base pointer of the object and a check for the equality of the object layout key and the cast operation's type layout key.

Once a base pointer has been cast to the object type using the fast check above, the pointer may be specialized to any inbound, member pointer of the object using a compliance check that is carried out statically (and hence is free at run-time). So for instance, once void * p has been cast to struct {int a; T1 * b; char[4] c; T2 * d;} *, the cast (int *) p may be carried out free of run-time cost as its compliance is verified statically. Similarly, the member pointer &(p->b) may be derived to be of type T1** and &(p->c[3]) derived to be of type char * without any runtime cost. All these member derivations occur statically free of cost because they represent subsets of the original struct object type. Using these member derivations, the object can be accessed as per the struct view of the object, with dereference costs minimized. In of themselves, the member derivations, representing various pointers to the object do not comprise accesses to the object (the storage of the object is not dereferenced).

A pointer cast, T1 * to T2 * engenders layout comparisons of the two types. If T2 is a subset of T1, or if the layout of T2 and T1 are the same, then the cast is statically determined to be a compliant cast. No dynamic check may be carried out for such a cast. Otherwise, the cast cannot be determined to be compliant and a dynamic check for compliance is carried out. Generally, cast non-compliance is harder to prove than cast compliance statically, even if T1 and T2 are non-compliant, since it requires knowledge of the pointer being inbound or not. Out of bound pointers are compliant to everything so type T1 * may be meaningless. Static non-compliance can be proven if the T1 type view of a pointer can be established to be inbound, followed by establishing non-compliance with the type T2. In case static non-compliance is determined, the program translation halts with a compilation error message.

The cast from the incomplete type void * to type T *, where T is not void engenders a dynamic compliance check. The cast from T * to void * is always compliant and is not checked at all.

Pointer arithmetic gets special treatment in deriving pointers to an object. In the example above, deriving a member &(p->c[i]), where i is an unknown variable, generates a dynamic check since the pointer increment from &(p->c[0]) is unknown. Depending on the value of i, the derived pointer may superimpose a char type for accessing the object at any location in the object. This then faces a compliance check, at run-time. Additional flexibility is allowed to pointer arithmetic if the derived pointer is cast without use to another type (or is simply abandoned). The compliance check of the pointer arithmetic is then eliminated and in the case of the cast, replaced by a compliance check to the cast-to type. So for instance, in the above example, the following sequence passes the static compliance check despite the pointer arithmetic in it being non compliant, if viewed in isolation: (void *) (((long long *) p)+1). The (long long *) cast makes p acquire a view of the int field and padding as a long long. The pointer arithmetic then has p acquiring a view of the pointer type as a long long, which is a non-compliant view. Finally, the cast to void * without use brings back compliance to p.

According to yet another embodiment, the memory layout is represented in a data structure comprising bitstrings of appended combinations of un-repeated bitstring pattern and one or more unrolls of repeat bitstring pattern.

The pointer invulnerability compliance checks are static or dynamic and comprise layout or bitstring or layout key comparisons.

For dynamic checks, layout bits are represented using the bitstring type, as shown in Code 6. A bitstring is the largest unsigned arithmetic-type holding 0s and 1s for Bs and Ps respectively. On a 64-bit machine, a bit string represents 128 Bs and Ps, amounting to 2048 bytes of object memory.

Among the members of a layout struct, the prefix is a pointer to a first bitstring doubleword in possibly a contiguous array of bitstring doublewords. The prefix array may be accessed at any offset by incrementing the prefix pointer appropriately. The size of the prefix bitstring is given in the field prefix size. The repeat string in a layout is given similarly. The layout size provides the size of the layout if it is a static constant. In this case, the number of times the repeat bitstring is unrolled is known and the layout size comprises these repeat unrolls and the prefix string. When the unrolls of the repeat string are not a static constant viz. the repeat string represents a dynamically-sized array, e.g. a flexible array member, then the layout size represents the layout till one unrolling of the array type. Besides the prefix bitstring, this additionally represents one or more unrolls of the repeat bitstring (due to layout minimization). Representing a dynamically-sized array of type T[ ] with the unroll for its 0-index allows the array member to be viewed as a pointer (to T) with non-zero indices of the array reached by pointer arithmetic. Compliance checking for the higher indices of the array is thereby deferred to the pointer arithmetic checks for the array. The 0th index is checked for compliance as a part of the object type that the array is a last member of. The boolean flag constant sized identifies if the layout_size is of a constant-sized type or otherwise.

### Code 6: A C Pseudocode Describing a Layout Data Structure is as Follows:

typedef unsigned long long bitstring;
typedef struct Layout {
word key;
bitstring * prefix;
int prefix_size;
bitstring * repeat;
int repeat_size;
int layout_size;
bool constant_sized;
bitstring * object_expanded_repeat;
bitstring * object_expanded_layout;
bitstring * operation_expanded_layout;
bool monontonous;
} Layout

The object_expanded_repeat field is used only by object layouts. The field contains a bit string for k+1 unrolls of the repeat bit string where k is such that k unrolls form a larger bit string than the largest layout_size of a compliance operation layout. When a compliance operation layout chances to superimpose on the repeat region of an object layout, compliance check reduces to bit string comparison starting from some initial offset into the first unroll of the object's repeat region, and then continuing on at most till the end of the operation layout. All possible bit string comparisons are covered if object_expanded_repeat is used to provide the object's bit string in the comparison. Its size choice described above caters to all comparisons. Similarly, if the operation layout chances to superimpose on the prefix region of an object layout, then compliance check begins from some offset into the prefix region and then continues on into the repeat region till the operation layout runs out. Again all possibilities are covered if the field object_expanded_layout is used to provide the object's bitstring, with the definition of the field being append(prefix, object_expanded_repeat).

Operation_expanded_layout is used by compliance operation layouts, for bitstring comparisons. The size of this field is the same as layout_size and it represents the prefix and repeat unrolls counted above in layout_size.

According to an embodiment, a memory layout for a static type is disclosed. The memory layout comprises a bitwise representation of pointer-sized or pointer-aligned entities including pointer and non-pointer data, with one bit value representing a pointer datum and the other bit value representing non-pointer data.

According to yet another embodiment, pointer invulnerability compliance checks based on a static type layout are disclosed.

It is to be noted that none of the fields in a layout depends on an actual dynamic size of an object's layout. Thus layouts, defined over static entities, viz. types, continue to be static entities themselves. They are statically constructed and used to populate a layout store that is then used for compliance checks at compliance operations in the program.

According to an embodiment, the object layout key identifies a layout data structure or a constant to represent that the object does not yet have a layout or the object's layout is special, such as for an eNULL object.

A freshly allocated object does not have an object layout associated with it till it has undergone a first pointer cast. The layout bit field of the object has 0 stored as its layout key. The pointer cast on a 0 key attempts to be the first cast on the object. For such a cast to be successful, the cast type has to define a complete layout (e.g. void * does not define a layout) and the layout defined by the cast type has to cover the object completely. The object size has to be large enough to ensure that all member accesses for this type are inbound, barring optionally a flexible member array (all of whose indices can be out-of-bound, following C's standard practice). For a constant sized type, the type size has to match the object size. Meeting these requirements ensures that in-boundedness checks carried out for bulk checking are obviated whenever possible (e.g. pointer to base object cast).

eNULL is a special object in that its size is 0 and hence both its prefix and repeat strings have size 0. All pointers to eNULL thus are out of bounds and hence an eNULL pointer can be cast to anything. A convenient way of representing this is to give the layout key 0 to eNULL also and never initialize it. Every cast operation on the object will assume itself to be a first cast operation that will successfully do nothing in an initialization attempt and pass the cast. So eNULL gracefully maintains its special status in the running of the program.

According to an embodiment, the pointer part comprises of one or more live pointer, dangling pointer, inbound pointer, out-of-bounds pointer, uninitialized pointer, manufactured pointer or hidden pointer.

Object layout initialization in a first cast also initializes the pointer locations in the object with eNULL pointers. Since an eNULL pointer can stand for any pointer type, initialization with eNULL pointers is semantically consistent. This ensures that an attempt to read an uninitialized pointer at most throws an eNULL dereference error. As a compiler option, the non-pointer or byte data in an object can also be initialized to 0 in this step.

For completeness, memory and access management system 100 keeps one unused global un-initialized pointer around (initialized to an eNULL pointer as above). Since an un-initialized pointer may be considered as belonging to any object, the global unused pointer is minimally an un-initialized pointer of each object.

According to an embodiment, the pointer invulnerability compliance checks are optimized if an object's layout does not comprise an un-repeated bitstring or if the repeat bitstring is not manifested in the un-repeated bitstring. The pointer invulnerability checks are shared with memory access checks.

According to yet another embodiment, the shared checking occurs when a compliance check operation dominates a memory access operation or a memory access operation dominates a compliance check operation or a set of one or more compliance check operations effectively dominates a memory access operation or a set of one or more memory access operations effectively dominates a compliance check operation.

A layout 1 is homogeneous, if it only has a repeat string (viz. no prefix string). Homogeneous layouts are worthwhile to specialize for, in compliance checking, since they represent all arrays and more (due to layout minimization). In a homogeneous layout, the repeat string is called the elementary layout of the object. A pointer to a homogeneous object is elementary if the pointer is compliant with the object layout and the layout of the type of the pointer is the elementary layout of the object, optionally repeated one or more times and an element worth of its type view is inbound. Compliance checking of a homogeneous layout is simplified as pointer arithmetic on an elementary pointer to a homogeneous object is always compliant.

All that pointer arithmetic operations have to do, to check for compliance is to first see if the object's layout is homogeneous (viz. prefix_size==0) and if its repeat string matches the operation_expanded_layout of the pointer arithmetic operation when the arithmetic operation has a prefix string also. Otherwise, if the arithmetic operation has no prefix, then the check for compliance comprises seeing if the object layout is homogeneous followed by comparing its repeat string with the repeat string of the arithmetic operation. The pointer arithmetic operation does not have to check if the initial pointer is compliant, an earlier operation would have ensured that. The arithmetic operation does have to check an element in-boundedness of the initial pointer a requirement that goes away if the following optimization is carried out.

Optimization 1. A compliance operation does not have to check for a pointer's in-boundedness if it is dominated by a dereference operation on the same location within its operation type.

Optimization 2. A pointer arithmetic operation does not have to check for a pointer's element in-boundedness if it is dominated by a set of dereference operations on the same location accessing an element within its operation type.

A pointer arithmetic operation is likely to be preceded by a use of the pointer on its present value. If the use comprises a set of dereference operations that together access an element of its operation type then the in-boundedness check for the element does not need to be carried out.

Optimization 3. A compliance operation does not have to check for a pointer's in-boundedness if all paths to it from program start have a dereference operation on the same location within its operation type.

In other words, so long as a compliance operation is dominated by dereference, regardless of whether the dereference comes from one operation or more (effective domination), in-boundedness checking can be relaxed.

Note that the optimizations above comprise the grounds for elimination of in-boundedness checking in all cast compliance operations also.

Optimization 4. A pointer arithmetic operation does not have to check for a pointer's element in-boundedness if all paths from program start have element-accessing dereference operation sets using the same location and operation type

The field monotonous in a layout as shown in Code 6 is true if the repeat bitstring of the layout does not occur anywhere outside the repeat region of the layout. In layouts with a prefix, this ensures that knowledge of monotonocity, coupled with knowledge of an elementary, compliant pointer is sufficient to pass monotonously-incrementing pointer arithmetic (e.g. ++), since that only yields a pointer in the repeat region of the layout which then is compliant analogous to homogeneous layouts. Address decrementing arithmetic however (e.g. −), cannot be certified given the monotonous flag however, since the arithmetic can bring a pointer out of the repeat region into the prefix region where a detailed compliance test would have to be carried out.

### Bulk Checking

According to an embodiment, the pointer invulnerability checks are shared with memory access checks.

According to yet another embodiment, the shared checking occurs when a compliance check operation dominates a memory access operation or a memory access operation dominates a compliance check operation or a set of one or more compliance check operations effectively dominates a memory access operation or a set of one or more memory access operations effectively dominates a compliance check operation.

A cast or pointer arithmetic operation with a compliance check is typically followed by accesses to the object using the type of the operation e.g. member accesses of a struct type. Each access carries out spatial and temporal checks that may be merged with the compliance check so that the compliance check represents a bulk check of all the accesses that follow using the operation type of the compliance check. A dereference operation's checks (spatial and temporal) may be lifted up to a compliance check if the compliance operation dominates the dereference operation and no free( ) operation on the object occurs on a path from the compliance operation to the dereference operation. This guarantees that the compliance operation will always be executed prior to the dereference operation and its results will be valid for the dereference operation. Shifting dereference checks from a set of operations to a compliance operation may make the compliance operation overly restricted. It may demand dereference strictness from its operand while there may be outgoing paths from the compliance operation that do not traverse any of the dereference operations i.e. paths that do not invoke dereference checks ordinarily. The overly strict checks at a compliance operation may well be acceptable, and specified thus by a user using a compiler flag, viz. that dereference checks have to be lifted up to a compliance operation whenever the opportunity above exists. On the other hand, a user may seek flexibility for pointers undergoing compliance operations and may not wish such overly strict shifts. In this case, checks may be shifted as follows:

Optimization 5. A dereference operation d's checks can be shifted to a compliance operation c if and only if c dominates d without an intervening free( ) operation and d post dominates c.

The post-domination clause above ensures that all paths from c (to program end) go through d.

In shifting dereference checks from a set of dereference operations to a compliance operation, the range of validity to be ensured by the shifted dereference checks has to be specified. So for instance, if the operation type of the compliance operation is a pointer to struct, and accesses in question dereference the struct from the 2nd to the 6th member only, then the shifted dereference checks have to do bounds checks only for these two members. The in-between members are certified automatically. In case overly strict shifting of dereference checks is allowed, entirety of the spatial view may be checked by default, viz. the whole struct. The shifting of dereference checks from a set of dereference operations to a compliance operation therefore adds at most the following:
A version check for liveness.
Up to two offsets to be checked for being spatially inbound.
   In case the type view of a compliance operation involves an array member (e.g. in the prefix layout of the type), then accesses involving the array have to be statically qualified, viz. have to be known to be statically inbound (e.g. have a constant index) so that they are on par with other struct member accesses whose offsets are statically known. If this is not the case, the dynamic index of the array would engender a pointer arithmetic operation with its own compliance check (the dereference check of the array may be shifted to this).

Relaxing the conditions above further for effective domination by a set of compliance operations:

Optimization 6. Dereference checks from an operation op can be eschewed in favor of the checks in a set of compliance operations C if all paths from the start of the program to op go through a member of C without a free( ) operation between the member and op and the dereference checks of op are included in each member of C.

In typical code, the dereference-check shifting/eliminating opportunities are likely to occur commonly. Tuning a program for such opportunities should be simple in particular.

Finally, note that shifting up-to-two offsets to a compliance operation for in-boundedness checking can be done for free for the most common of cases of a pointer to base object. When such a pointer is established, it is also established that all member accesses excluding a flexible array member are inbounds. Flexible array members have to be checked explicitly. On parallel lines, if an elementary pointer to a homogeneous/monotonous region can be established, and it can be established that each elementary region is either wholly inbounds or out of bound, then the multiple inboundedness checks for the multiple member accesses originating from the elementary pointer can be reduced.

Encoded pointers only exist for objects on the Heap. Safety checking for objects on the stack and among global data is carried out as follows. Among these objects, those that are pointer accessed, e.g. arrays, variables whose address is taken, are shifted to the heap using standard techniques. Thus, all pointers to the stack also end up becoming encoded pointers.

### Function Pointers

According to an embodiment, a method of shielding a vulnerable resource in the heap memory pool is disclosed. The method comprises steps of storing the vulnerable resource in an object in the heap memory pool and representing the vulnerable resource by an invulnerable pointer to the object.

According to yet another embodiment, the method further comprises of storing the resource in a free object in the heap memory pool and referencing the free object by a dangling pointer allowing only special-purpose accesses to the resource through the dangling pointer and disallowing other accesses such as dereferences of the dangling pointer through normal access checking.

Function pointers get a special representation like eNULL in the memory and access management system. The function pointer may be substituted by an encoded pointer to a wrapper object that contains the function address and descriptor details. The wrapper object is a free object, so that the encoded pointer is actually a dangling pointer to the object. The encoded pointer is passed around the program in place of the function pointer. The encoded pointer may allows pointer arithmetic and disallows dereferences or frees on itself using normal temporal checks. A function call using the encoded pointer is special in being allowed to dereference the object to call the function according to the address and type details stored with the object. Thus, type-mismatched calls via function pointer calls are ruled out.

From a compliance perspective, the function type is treated analogous to void *, so all casts from one function pointer type to another are allowed. The check only occurs when a function pointer is called and then the function descriptor for the pointer is used.

Finally, addresses on the stack (e.g. a return address) do not need to be wrapped explicitly as described above, since they are protected by the heap shift of pointer-based user data structures on the stack. So buffer overruns on the stack are ruled out and the stack mechanism continues to be as fast as before.

### Safety for Vulnerable Resources

A method of shielding a vulnerable resource in the heap memory pool is also disclosed. The method may comprise the step of storing the vulnerable resource in an object in the heap memory pool and representing the vulnerable resource by an invulnerable pointer to the object. The method may further comprise of storing the resource in a free object in the heap memory pool and referencing the free object by a dangling pointer allowing only special-purpose accesses to the resource through the dangling pointer and disallowing other accesses such as dereferences of the dangling pointer through normal access checking.

An attack typically begins by overwriting a pointer with malicious characters from an overflowed string buffer. This overwrite (even in an intra-struct context) is ruled out in the memory and access management system 100 since all non-pointer overwrites of (an encoded) pointer are ruled out. Another encoded pointer may only overwrite an encoded pointer. However, there is no external representation of an encoded pointer, which can be input from outside a program and overwritten on an encoded pointer variable. So an encoded pointer overwrite cannot be supplied with a target from outside a program.

Due to type checking of variadic function calls, format string attacks may write an integer to a compliant location only so pointer overwrite by such attacks is ruled out. The integer may only be written to a program supplied location, to an object within the memory and access management system. The writing cannot be carried out to malicious locations provided by the attacker. As described earlier, an attacker cannot define and supply a location from outside the program. Attacks based on temporal invalidity, such as dangling-pointer attacks cannot be carried out in the memory and access management system 100 due to its comprehensive temporal checking.

Finally, an attack on a vulnerable resource, such as a file name, command name, user id, authentication data can be obviated if the resource is wrapped in a minimal object and an encoded pointer for the object passed around as the handle to the resource (instead of the resource itself).

Intra-object overwrites (e.g. a string member of an object adjacent to a userid) comprise places of exposure. Such places are explicitly protected by the wrapper mechanism described here without preventing intra-object overwrites by heavy-handed methods such as banning inter-member overflows curtailing legitimate expression of C programs such as taking a member pointer in an object and copying up/down the object from there on. In memory and access management system, all kinds of C idioms allowing arbitrary access within the Bytes region of an object are allowed. Similarly, all kinds of pointer accesses within a Pointer region of an object are allowed. The two are kept disjoint as the one clear security policy of memory and access management system 100 and this allows the wrapper scheme above to protect vulnerable resources within an object.

Finally, since overwrite of a pointer by non-pointer data is completely ruled out in the memory and access management system, the pointer for a wrappered vulnerable resource, as described above, cannot be spoofed by an integer overwrite of the pointer data. The spoofed pointer cannot be dereferenced as it may be out of bounds while the same is not possible in the memory and access management system. Thus, memory and access management system 100 provides superior protection compared to prior art through its invulnerable encoded pointers.

### Backward Compatibility

According to an embodiment, a try block for backward compatibility is provided such that the try block runs in a scope where free variables comprising of pointers consist only of decoded pointers.

Encoded pointers are not backward compatible since programs compiled outside memory and access management system 100 expect standard (undecoded) C pointers. For backward compatibility, a try block may be provided that operates on decoded pointers and objects in a standard C setting. The try block runs in a scope where free variables comprising pointers only consist of decoded pointers. The use of the try block comprises of three steps:

Step 1— Decoding the data structures—In this step, the user code recursively walks the data structures to be used by the try block and decodes the encoded pointers in the data structures. Since an encoded pointer is a double word quantity while the decoded pointer is a single word unsigned long, the objects end up getting compacted as the decoding proceeds. For this, walking duplicates the encoded objects into decoded objects, using single word space for the double word pointers in the copying process.

Step 2. The try block comprises: try compound_statement. The compound statement in the try block is executed in a standard C setting. All the types in the try block are standard C types (decoded pointers only). The decoded pointer may be passed into the try block only as an unsigned long from the outside, where all the pointer types are encoded pointers. Free variables are used for this purpose. Free variables may hold any non-pointer scalar value. Among these values unsigned longs are particularly interesting and may be unioned with the appropriate pointer type to gain access to a decoded data structure. The compound statement is executed with these decoded objects and pointers.

Step 3. Encoding the data structures—In this step, the user code recursively walks the decoded data structures passed to the try block and using an encode primitive provided by the memory and access management system, copies back the results in the data structures to their original encoded data structures.

According to an embodiment, a method for encoding an un-encoded pointer is disclosed. The method comprises steps of identifying an object for the un-encoded pointer by searching through a cache of previously decoded pointers' objects or using the object of a hinted encoded pointer or deferring the identification till a hash table of objects is dynamically constructed and using the address location or version of the object to build the encoded pointer.

The decode primitive is a straightforward encoded pointer decode, allowing only live, inbound pointers or eNULL and function pointers to be decoded. All other decode attempts throw an exception. The encode primitive searches for a live object in which its argument (decoded) pointer is inbound. Using such an object, or eNULL/function pointer objects, the encode primitive encodes the decoded pointer. The search for an object may be carried out by searching the memory addresses until a first marker set is found indicating the discovery of object0 metadata for the pointer. By pursuing the preceding links of the object0, the veracity of the findings may be ratified (by the continued discovery of preceding object0 objects). When the head of the list containing the objects is found, if the head represents an allocated list, the pointer may be found to be of the original object0 discovered for it. An inboundedness check further may identify whether the pointer is to be encoded or not. Only inbound pointers are required to be encoded by the encode primitive, besides eNULL/function pointers. All other encode attempts throw an exception.

Encodes are sped up by caching support for decodes. When a pointer undergoes a decode, the encoded pointer (and hence the live object) may be stored in a cache such that encodes later may check against the cache for speedier encodes. This scheme prioritizes pointer encodes when decoded pointers continue to remain in-bound to the objects they were originally associated with. Saving encoded pointers in the cache means the garbage collector's reclamation of these objects may be blocked as long as the cache contains the pointers. The pointer may also become dangling as a result of a user free( ). Dangling pointers in the cache are scrubbed from the cache at the next garbage collector occurrence. The cache may be a fixed sized FIFO (viz. first in, first out), so an old, saved pointer gets overwritten by a newer pointer in FIFO order. The size of the cache is specified by a compiler flag. The flag may also pacify alternate recycling strategies, such as LIFO (last in, first out). The memory and access management system 100 may not guarantee the behavior of a program within the try block as it is unprotected code. The behavior is guaranteed outside the try block. For the try block and binaries, the behavior has to be certified independently.

Decoding an encoded pointer is an inexpensive operation. Encode on the other hand is expensive if the pointer to be decoded does not fall in an object in the cache built for supporting encodes. Encodes are not expected to be common, so the support provided by the memory and access management system 100 may be enough for their purpose. There are however idioms discussed below where encodes may be enough to justify running the memory and access management system 100 under the compiler setting of larger metadata per object. In this setting, the object metadata is expanded by another doubleword to allow the maintenance of a permanent hash table of objects as opposed to the temporary one that comes into place during each garbage collector. The garbage collector table may be built temporarily using the prev field of each object. The permanent table abandons this approach, has the hash table using a permanent next field forever, and thus saves on garbage collector by garbage collector building and deconstructing of a hash table. As a cost however, it uses extra object space.

Given a permanent hash table, encode becomes a fast exercise. Once an object's marker has been located its hash index based on the base pointer may be computed. Next, the presence of the object in the bucket for the hash index may be checked straightforwardly. Thus, instead of traversing a large number of objects in the heap in looking up a queue head, now encode scans through just one bucket to verify an object, which is much faster.

Idioms that might benefit from fast encodes are programs where pointers are saved to file as a part of computation. In memory and access management system, the only way to do this is via decoded pointers. Later these pointers have to be encoded so cheap, bulk encodes may be necessitated. Such saving and recovering in the context of memory and access management system 100 would have to happen within one garbage collector phase (a variable identifying garbage collector phase is available in memory and access management system) or the object moving option turned off such that meaningful encodes of decoded pointer may be done later.

A user may have a handle on the object that a decoded pointer is inbound to. Allowing this to be expressed would yield immense efficiency benefit as follows. The interface for an alternate encode operation becomes:

bool encode(hint, d, result), where hint is an encoded pointer to an object. The encode is carried out using hint. Since hint is valid encoded pointer, if it is live (version matches), then no further checking of membership of hint's object in any hash table or object lists has to be carried out. The success or failure of encode using hint is the Boolean answer returned. The encoded pointer itself, if applicable is provided back as *result.

A user may try out one or more encodes using the interface above prior to shifting to the normal encode or an alternate encode mechanism below.

void encode (d, result, chunksize): This command is executed for effect. When *chunksize such commands have been executed, then, all the encodes are carried out together in bulk for efficiency using a hash table implementation built on the fly. Each d's encoded pointer is made available via the result pointer, as *result. Each *result is unmodified till the bulk encode occurs.

The chunksize pointer provides a group identity to the bulk encode. A barrier operation may be provided for carrying out a bulk encode before *chunksize encodes have been sought in order to prematurely terminate a bulk encode. This may be executed by an intervening GC, for instance.

### Allocation and Deallocation Routines

eMalloc

In order to retain standard C's malloc interface for the purposes of eMalloc, the memory and access management system's allocation routine for the user, the procedure does not specify the alignment boundaries of its allocations. Hence, the most general alignment, viz. double word alignment may be ensured for all its allocations. Analogous to malloc, which may return NULL for allocation requests of size 0 or less, eMalloc returns eNULL for such requests. A positively sized allocation request sees the requested size being rounded up first to a double word size for allocation. The management structure for such size is next looked up or created if it does not exist. In the commonplace scenario, the number of allocation sizes requested by a program may be a constant, so the lookup (not creation) for the management structure of a given size takes a small constant time, even in a simple list organization for such structures. In case the management structure creation fails (e.g. due to lack of space), eMalloc returns eNULL.

According to an embodiment, an allocation request with an existing management structure uses a free object or a consumable gap on the fit_nxt or fit_nxt_nxt lists unless none exist.

Once the pertinent management structure m has been looked up/created, eMalloc first tries to allocate from a free list object. This comprises a straightforward deletion of an object from the m->free list. If no such object exists, then the allocation may be carried out from an egap. The procedure uses m as an argument. If no satisfactory egap exists, then eMalloc returns eNULL. Otherwise, the allocated object may be put on the m->allocated list, initialized, and the encoded pointer to the object created and returned. Initialization comprises assigning the object size, 0 layout, markers, and version fields. For an allocation from the free list, the amount of initialization is less (marker and version fields are pre-populated).

### Management Structure Creation

According to an embodiment, the management structures comprises of a dsizeof(0) structure where dsizeof(0) is doubleword sizeof(0) and a dsizeof(gh) structure where gh is a gap header and a dsizeof(m) structure where m is a management structure, such that one or more of the structures are created at system initialization time.

According to yet another embodiment, the management structure creation leads to a re-partitioning of the lists of gaps such that consumable-gaps stored on fit_nxt or fit_nxt_nxt lists are maximized.

According to yet another embodiment, all objects and gaps in the heap memory pool are doubleword aligned.

The first step in creating a management structure is a special-purpose eMalloc_management of the same. This differs from general eMalloc by (a) a guarantee that the management structure (management_management, code 4) to be looked up for this purpose pre-exists and does not need to be created, (b) a global variable pointing to the same, such that the lookup does not incur a search cost, and (c) allocation to the management_management->internal_allocated queue for internal objects. The fact that management_management structure preexists is ensured by the fact that it is created at the time of initialization of the memory and access management system. The management structure is never freed once it has been allocated with the accompanying gap header. Thus post initialization, the abovementioned management structure is always available for management structure allocations.

With management structure guaranteed, eMalloc_management can call eMalloc_from_gap using the guaranteed structure as an argument and conclude its allocation activities. If the Memory and access management system 100 design was different and did not guarantee management structure thus, then the alternate design would have to create the required management structure dynamically without the benefit of eMalloc from gap as described below (which pre-supposes a management structure). This would cause unnecessary complexity and duplication of gap allocation functionality in the system of the alternate design. The simplicity of memory and access management system 100 arises in part from its reliance on the initialization-guaranteed management structure.

Success above in eMalloc management of a management structure m is followed by its initialization with the pertinent doubleword size, initial last_version, and all empty queues. This is followed by a fresh gap header creation, gh. The header gh is allocated for paired creation. The procedure for allocation of a fresh gap header (gh) follows the same organization and similar guarantees as eMalloc_management above. The pre-existing management structure guaranteed in this case is gap_header_management, see code 4.

Failure to eMalloc m or gh implies failure in paired management structure creation. In case the failure is in gh allocation, the eMalloc_management of m is rolled back by freeing m to the management_management->free queue. The only tangible residue of the rollback is a (version-advanced) free object compared to the earlier state. Only when both m and gh allocations succeed may the paired creation become successful. In this case gh is freed to reside on the gap_header_management->internal_free queue and m is inserted into the Memory and access management system's arranged management structures' list (pointed by queues, code 4). The gap header gh must reside on the internal_free list till a management structure actually has some gaps to populate the gap_header, in which case a gap header is allocated from the internal_free list and populated with the gaps. This discipline enforces another of the system invariants that an empty gap header is never pointed to by a stable management structure. Only when a management structure is in transition can its gap header become empty, in which case it is removed from the management structure and freed to reside on gap_header_management->internal_free queue.

After m has been inserted into the system's list of management structures headed by queues, code 4, the gaps stored in the management structures are re-partitioned. For an m insertion creating an n^{th} position, only gaps stored at the (n−1)^{th} position bear the re-partitioning. In case such gaps exist, the following occurs:

If (before the n^{th} position creation) the (n−1)^{th} position gaps have valid fit_nxt and fit_nxt_nxt queues, then:
If the n^{th} position is one doubleword smaller than the (n+1)^{th} position, then the fit_nxt_nxt queue of the (n−1)^{th} structure is the legitimate fit_nxt_nxt queue for the n^{th} structure. The gaps and fit_nxt queues of the n^{th} structure are empty. The fit_nxt queue of the (n−1)^{th} structure is now legitimate to become the fit nxt nxt queue of the (n−1)^{th} structure. These changes are effected. The gaps and fit_nxt queues of the (n−1)^{th} structure are formed from the remaining gaps in the structure by appropriate filtering.
If the n^{th} position is two doublewords smaller than the (n+1)^{th} position, then the fit_nxt and fit_nxt_nxt queues of the (n−1)^{th} structure are the legitimate queues for the n^{th} structure. The gaps queue for this structure is empty. The new queues of the (n−1)^{th} structure are formed by appropriate filtering from the gaps queue of the (n−1)^{th} structure.
If the n^{th} position is more than two doublewords smaller than the (n+1)^{th} position, then the fit_nxt and fit_nxt_nxt queues of the (n−1)^{th} structure are the legitimate queues for the n^{th} structure. The gaps queue for this structure, as well as all the new queues of the (n−1)^{th} structure are formed by appropriate filtering from the gaps queue of the (n−1)^{th} structure.

If (before the n^{th} position creation) the (n−1)^{th} position gaps have a valid fit nxt queue, but not fit_nxt_nxt queue, then partitioning occurs as follows. Note that since the n^{th} position is being created, the (n−1)^{th} position and the (n+1)^{th} position are at least 2 doublewords separated, which means that if the (n+1)^{th} position exists, then a valid fit_nxt queue also exists. Note also that the (n−1)^{th} position always exists since we have from initialization that the eNULL management structure or the 0^{th} structure always exists so that a management insertion is preceded by at least one management structure, always.
If the n^{th} position is one doubleword smaller than the (n+1)^{th} position, then the gaps queue of the n^{th} structure is formed by appropriate filtering from the gaps queue of the (n−1)^{th} structure. The fit nxt nxt and fit nxt queues of the n^{th} structure are empty. The fit nxt queue of the (n−1)^{th} structure is now legitimate to become the fit nxt nxt queue of the (n−1)^{th} structure. The gaps and fit nxt queues of the (n−1)^{th} structure are formed from the remaining gaps in the structure by appropriate filtering.
If the n^{th} position is two doubleword or more smaller than the (n+1)^{th} position, then the fit nxt queue of the (n−1)^{th} structure becomes the fit nxt queue of the n^{th} structure. The fit nxt nxt of the n^{th} structure is empty. The gaps queue of the n^{th} structure is formed from the gaps queue of the (n−1)^{th} structure by appropriate filtering, as also are all new queues of the (n−1)^{th} structure.

If (before the n^{th} position creation) the (n−1)^{th} position gaps do not have a valid fit nxt queue (i.e. the structure that should become the (n+1)^{th} position does not exist), then partitioning occurs as follows.

The n^{th} structure gets only a gaps queue, by appropriate filtering from the (n−1)^{th} structure's gaps queue, which also yields the new gaps and fit_nxt queues of the (n−1)^{th} structure. Memory and access management system 100 design includes and relies on the fact that all objects and gaps are doubleword aligned.

eMalloc from gap

According to an embodiment, an allocation request with an existing management structure uses a free object or a consumable gap on the fit_nxt or fit_nxt_nxt lists unless none exist.

According to yet another embodiment, each gap created from a free object of doubleword size s by a garbage collector can serve allocation requests of doubleword size s among possibly others.

eMalloc_from_gap takes place using a pointer m to a management structure that is already present in queues, the system's list of management structures. The eMalloc allocates for the double word size stored with m. So m does not need to be searched for when doing eMalloc_from_gap. According to an embodiment, m is directly available.

The first step in eMalloc from a gap is to look up m's predecessor for the presence of a non-empty fit_nxt queue. If available, a gap removed from the queue supplies the allocation. Since this step consumes the gap completely, the gap is removed from the global gaps order ( . . . ->location next, . . . ->location prev) also. In case, the gap removal empties its gap header, then the gap header is freed to gap_header_management->internal_free and management structures are adjusted accordingly.

Similarly, an attempt to allocate from the pertinent fit nxt nxt queue is made, in case the above fails. If this also fails, then a non-consuming allocation from any available matching or larger gap is tried. A matching gap is a gap of requested size, without considering the egap part of the gap. When allocating from the matching gap, the gap reduces to a zero sized gap, which ends up residing on the eNULL management structure's gaps queue. This does not remove the gap from global gaps order and hence the allocation is non consuming. The non-consuming allocation searches for gaps in the gap headers of management structures of size equal or larger than the requested allocation's double word size. This search takes constant time, given the organization of gap headers in the system, viz. the requested size's management structure points to the first non-empty gap header that can supply the gap. The gap may be picked from the gaps queue of the gap header, if needed by shifting the gap from its other queues to the gaps queue (if the gaps queue is empty). Picking from the gaps queue is preferred, since the other queues may conserve their gaps for gap-consuming allocations later, which is better for system health (de-fragmentation benefit, fewer gaps to manage and concomitant overhead). This scheme of prioritizing picking from a gaps queue (over fit nxt and fit nxt nxt queues) may be emphasized further, in alternate embodiments, by looking up gaps queues of larger-sized gap headers first.

Once a gap has been picked for a non-consuming allocation, the post-allocation space of the gap is computed. If that makes the gap ineligible to continue in the present gap header, a transfer to a smaller gaps header is carried out. First the matching management structure for the present gap header is looked up. If transfer of the gap is noted to make the present gap header empty, the gap header is freed to reside on the internal free queue of gap headers and management structures are updated to replace pointers to the freed gap header with pointers to the next larger gap header (or NULL if one does not exist). Finding the management structure to which the gap may be transferred takes another traversal through the management structures.

For the transfer of a gap to its destination gap header to take place, the gap header must first be made available. In case the destination management structure has a NULL gap header or the gap header is a shared gap header of a larger size, then first the gap header must be allocated from the internal free queue of gap headers. This takes constant steps, except for the time taken to reset the gap header pointers in the management structures from their old values to the new ones reflecting the newly allocated gap header. Once availability of a gap header has been ensured, transferring the gap to the gap header requires checking for the queue that it must be transferred to. All the three queues of the gap header may exist and be transferred to, with the decision among the three taking constant time of computation and prioritizing fit nxt or fit nxt nxt placement over gaps placement.

eFree

eFree, the memory and access management system's allocation routine for the user, decodes an encoded pointer first, to ensure its live and points to the base of a non-eNULL, live object. eFree of eNULL is legitimate, the result returns without effect (analogous to freeing NULL in standard C).

After ensuring legitimacy of a non-eNULL request, efree checks the object's marker for its quarantine status.

A non-quarantined object's management structure is looked up if required. Within constant steps, the object is removed from the structure's allocated queue followed by a singleton increment of its version field, modulo NUMBER_OF_VERSIONS. If the resulting version comprises the structure's (last_version+1) % NUMBER_OF_VERSIONS, then the removed object may be placed on the structure's unusable free queue, else the object is placed on the free queue. For efficiency, the actual check occurs prior to increment, so equality with last_version is checked.

Freeing a quarantined object first removes the object from the quarantine->allocated queue and places the object on the structure's free queue after a singleton increment of its version field (modulo NUMBER_OF_VERSIONS). Since quarantined, free queue objects are not re-allocated till de-quarantined and re-assigned versions by an intervening garbage collector, their discrimination via two free queues is not necessary.

In memory and access management system, an allocation request with repeated garbage collections always succeeds, unless a fragmented heap comprising live or quarantined objects arises. A management-structure-creating allocation request can be decided within one garbage collection.

### Constant Spacegarbage Collector

The garbage collector may be designed to handle even extremely challenging circumstances of stack and heap depletion by requiring only a small constant amount of memory overhead (stack, heap and globals combined) for its operation. The stack pointer registration/screening scheme costs extra but does not occur during garbage collection time. The garbage collector maximizes performance by utilizing the waste space in free objects and gaps scattered in the Heap. If such waste space is not to be found, then the small constant space footprint of the garbage collector guarantees a minimal acceptable performance of the garbage collector. The size of the constant minimum space underpinning the garbage collector may be user specified.

### Conservative Garbage Collector

The garbage collectors are well placed for collecting pointers because:

1. While the memory and access management system 100 program may generate an arbitrary inbound or out-of-bound pointer for a live/free Object supporting the flexibility of C/C++, the program cannot generate a pointer to arbitrary memory unrelated to any object. Collecting objects' related pointers is a sufficient exercise for the garbage collector to conservatively collect all pointers.

2. All objects' related pointers collected are encoded pointers. Encoded pointers are not unstructured quantities, but rather are amenable to collection because they are:

(a) Doubleword aligned, doubleword scalars

(b) Point to doubleword-aligned objects occupying the memory range within which the Heap resides, with intricate metadata structure including marker fields that may be inspected for screening out false, putative encoded pointers. The definitive test for such screening is whether a pointed object belongs to the free/live object lists in the Heap.

A common use of garbage collector is to identify memory leaks wherein objects are identified that are live (not freed using free( ) by a user), yet no pointers to them exist in the program (so a user cannot free them even if the user wanted to). Optionally, such objects may be reclaimed as free memory by the garbage collector. Although, such reclamation may be carried out by ordinary conservative garbage collector, the practice may be hazardous since a program can easily generate a pointer to such an object dynamically after garbage collector, denying the reclamation decision of the garbage collector and access the free memory thereafter. Such garbage collector repudiation is not possible in memory and access management system 100 where dynamic generation of a pointer to reclaimed, un-allocated memory is ruled out. For example, an attempt to encode an integer (obtained for example after juxtaposing several bitfields together) to a pointer to such a reclaimed object would throw an exception instead of generating such a pointer. Hidden pointers in the memory and access management system 100 are treated as manufactured pointers and generate fresh pointers only to the live objects that are present when the manufactured pointer is created (barring eNULL and function pointers).

The memory and access management system's conservative garbage collector is a truly conservative garbage collector. This is because despite all the structure offered by encoded pointers, a doubleword aligned, doubleword scalar in a program's memory image can be anything—an encoded pointer, or anything else. Even if the value turns out to be valid as an encoded pointer, namely it points to the Heap object, the value need not be an encoded pointer and may well be anything else e.g. two juxtaposed integers. So, the garbage collector in the memory and access management system 100 proceeds in the conservative school of garbage collection, by treating all doubleword scalars as putative encoded pointers.

The structure offered by an encoded pointer, listed above, ensures that collecting all putative encoded pointers is an efficient exercise. Each putative pointer is filtered according to the structure listed above, eliminating non-pointer quantities very effectively. Note that the definitive filter—whether a pointed object is the Heap object or not—is applied, which means that the search for pointers proceeds only through the stack, global data and Heap objects and not the entire computer memory.

### Garbage Collector Hash Tables

According to yet another embodiment, the garbage collector builds or uses a hash table comprising a plurality of buckets for containing lists of live or free objects. The memory and access management system 100 further comprises of a hash table built by a garbage collector such that one or more lists of free or live objects stored in the hash table are built by re-using one of the links of the doubly-linked objects in the heap memory pool. The hash table comprises of buckets for containing lists of objects. For each object to be inserted or looked up in the table, a hash function may be used to compute an index for the object. The bucket corresponding to the index is further accessed for inserting or looking up the object. A linked list of objects in each bucket are made with zero space overhead by reusing a prev link of each object0 stored in the list. Object lists in the heap are doubly linked. During garbage collection, when the hash tables are built, the prev links among all these double links are abandoned. The space recovered may be used for storing the links of object lists in each bucket.

### Code 7: A Code Describing Garbage Collection Related Data Structures and Definition in C Pseudocode is as Follows:

```
#define LIVE_MASK 1
#define LIVE 1
#define FREE 0
#define PROGRESS_MASK 0XC
#define INITIAL 0
#define EXCESS 4
#define DEFINITIVE 12
#define COUNT_MASK
    (((1 << (HEAP_OFFSET_BITS − 4)) − 1)
    << MARKER_TAG_BITS)
typedef struct tree {
    struct tree * left;
    struct tree * right;
    word start;
    word end;
    object0 * buckets[ ];} tree;
typedef struct cache {
    struct cache * next;
    word end;
    object0 * os[ ];} cache;
tree * root; // root of hash table.
word treesize; // power of 2.
word log_treesize;
#define TRANSITIVE_MARKING_BOUND ...
    // minimum bound permitted is 2
cache * cache_head = NULL;
cache * cache_ptr = NULL;
word cache_offset = 0;
```

The hash function used to build the buckets preserves location ordering among buckets—namely all the objects in an earlier-index bucket occur location-wise earlier than all the objects in a later-index bucket. The number of buckets in the hash table is kept to a power of 2. The hash function is simple—the heap may be divided by location into stripes of memory, one per bucket. An object falls in a stripe if the address falls in the stripe. The object may well span several stripes, the address is the starting location and the membership in a stripe is unique. Since the heap size is a power of two and the number of buckets is also a (smaller) power of two, the stripes are all equi-sized and have a power of two. For object 0 pointer o, the hash function simply looks up the most significant bits of the offset of o into heap to identify the bucket/stripe it falls in viz. ((void *) o—protected_heap_first)>>(HEAP_OFFSET_BITS—log_treesize), where log_treesize is log₂(number of buckets). Here, for simplicity, the Heap may be assumed to be non-incremental, of a single large block of memory. In the context of an incremental heap, first the base of the containing block would be computed followed by relative bucket identification vis-a-vis the base as above. The choice of a hash function based on equal stripes offers a well-bounded worst-case behavior, as in one stripe, the maximum number of objects that may fall is the stripe size divided by the number of smallest object allocations in a program (ignoring eNULL, which is solitary). No bucket will face a larger clash than this in the hash table. Since stripes are location ordered, by ordering the linked list of objects within a bucket by location, a complete location wise order on all the objects in the hash table is obtained. This is a very useful property to have for the free objects in the table, since they have to be freed up as gaps and coalesced with existing gaps. A location-wise order is very useful in this context and free objects are all ordered thus in the hash table.

When garbage collection is called, the distribution of stripes into live and free objects is not fully known. Buckets of the hash table may be partitioned apriori as live object buckets and free object buckets, but such partitioning may be badly mismatched with the actual spread that is encountered. Hence, the memory and access management system 100 decides to share all the buckets across live and free objects. The membership query is designed to answer whether an object is present in the hash table as a live object or as a free object. To do this, the objects themselves are tagged with a live/free bit in the least significant tags bit of the objects (see code 7). As shown in this code, the LIVE MASK pulls out the least significant bit of the overlapped marker for use as the live/free tag bit. A 0 value of the bit signifies that the containing object is a free object and a 1 value signifies that the object is live. As one of the first steps in garbage collection, the live object lists of all sizes in the heap are traversed, inserting the objects one-by-one in the hash table as live objects (liveness bit set to 1). Then the free and unusable free lists are traversed, putting the objects in as free objects (liveness bit set to 0). The live and free objects in the quarantine lists are also put in the table in this step, so that the hash table is comprehensive in responding to membership queries.

A common design of a hash table may have a contiguous array of buckets. However, if garbage collection occurs when the program is out of memory then contiguous space for the hash table is unlikely to be available. This difficulty is solved by the garbage collector demanding only non-contiguous memory from the heap. Free object lists in the heap are traversed to locate a free space per object such that the space may be cast to the tree struct shown in Code 7. Each tree struct contains an array of buckets, as many as the object can hold along with a range of hash indices covered by the buckets (viz. start to end). The struct points to a left tree struct and a right tree struct that may be used to build an ordered, preferably balanced, binary tree out of the structs. Besides free object lists, the egap lists in the heap are traversed to construct tree structs out of the free spaces recovered. A heterogeneous binary tree is constructed out of all the structs that provides a handle to the buckets of the hash table. The tree is heterogeneous since the number of buckets per node of the tree can be different. For a hash index, the bucket in the tree is located as follows. If the hash index is in-between the start and end indices of the root struct of the tree, the corresponding bucket in the root node is identified in the root's array of buckets. Else, if the index is smaller than the start index, then the index/bucket falls in the left child tree of the root and the left child is searched recursively. Otherwise the index falls in the right child tree of the root and the right child is searched recursively. Thus, a binary search through the (balanced) binary tree identifies the bucket to be accessed in the hash table.

Since the binary tree of buckets is heterogeneous, one node for the tree may comprise a stack allocated tree struct with a user-specified, constant number of buckets (declared by a compiler flag). This node takes up a part of the overall, constant stack space overhead of the garbage collector algorithm, and ensures that the hash table at the very least has many buckets available to it, regardless of the space it is able to generate out of heap objects and gaps. The constant stack space guarantees a minimal acceptable performance of the hash table, independent of what the heap adds. If adequate space is found from the heap to build the hash table, then the constant stack space from the stack may not be taken up and the hash table built solely out of the heap. According to another embodiment, if the garbage collector finds that it has enough contiguous space for the hash table buckets, then the tree reduces to a singleton node tree and garbage collector may use that (or a further stripped down version of it).

As discussed above, the total number of buckets in the hash table is a power of 2. During construction of the binary tree of buckets, once a desirable number of buckets has been obtained (e.g. specified by a compiler flag), the remaining space (for buckets and tree structures) is ceded to another data structure built by the garbage collector called the cache (see Code 7).

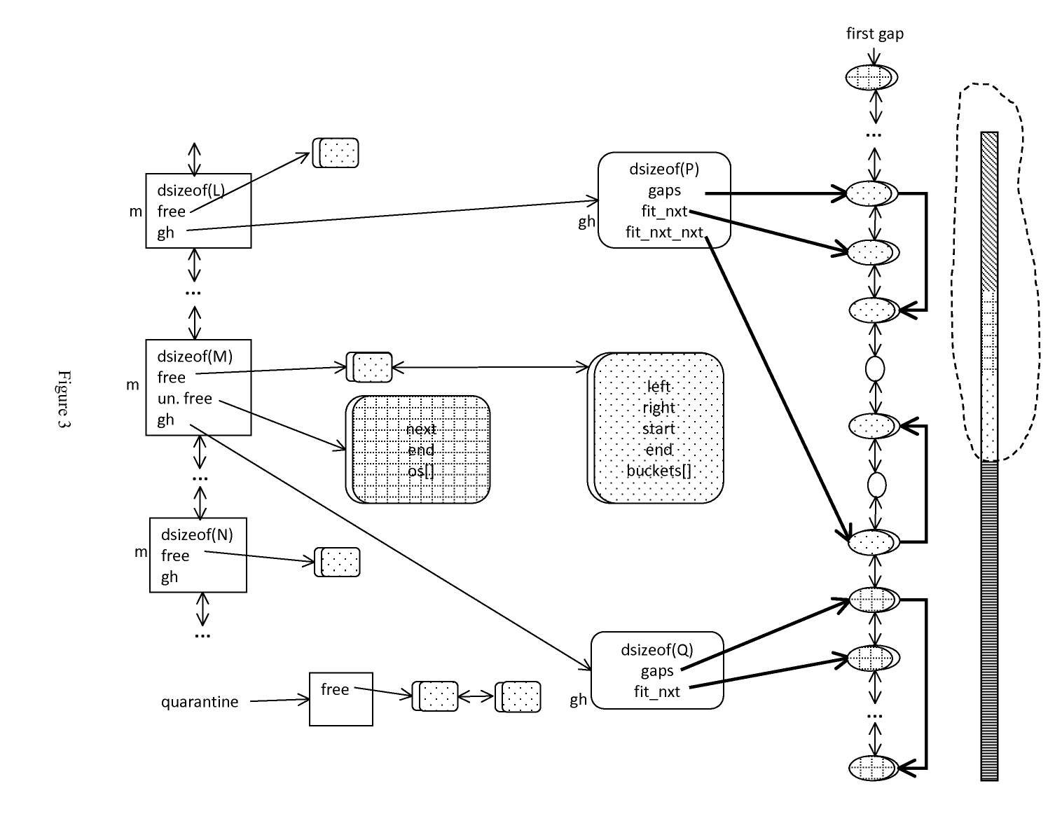

FIG. 3 illustrates a storage deployment for the hash table and cache according to an embodiment of the invention. The bar on the right illustrates the constant stack space used by garbage collector, circumscribed in a dashed circle. The dotted spaces illustrate space taken up by the hash table in the stack and the heap. The check-hatched spaces illustrate the space taken up by the cache structure. Diagonal-hatched space is the colour of the other stack use by the garbage collector such as in the recursive marking algorithm. Horizontal-hatched space is the stack use outside the garbage collector. Entities shown are not to scale. The layout of a tree struct and a cache struct are shown magnified in the center of the figure.

It is to be noted that besides the preferred embodiment of the hash table discussed above, there are many variants of this hash table design that those skilled in the art may choose to follow.

A mark method for a conservative garbage collector, such that the method identifies memory reachable from a root set of an application program is disclosed. The root set may comprise of a stack, globals and static data section, and registers for the application program. The mark method may comprise step of identifying putative encoded pointers in the root set and recognizing a putative encoded pointer as a discovered encoded pointer only if a live or free object in the heap memory pool exists for the putative encoded pointer. The mark method may further comprise step of marking a live object pointed by a live putative encoded pointer as reachable memory, adding marked live objects to the root set and repeating the above steps again till the root set stops changing.

According to yet another embodiment, an object in the heap memory pool may be marked or traversed only once to identify the reachable memory.

The mark method may further comprise steps of tracking a putative encoded pointer effectively by screening the pointer for proper size and alignment, the proper alignment and memory range of the pointer's pointed object, the presence of proper markers in the pointed object, the putative validity of the next or previous objects linked from the pointed object, or the equality or non-equality of the pointer and pointed object versions the former of which is indicative of a live pointer to a live object and the latter of which is indicative of a dangling pointer.

A recursive formulation of a mark method of a garbage collector is disclosed. The recursive formulation may comprise steps of marking an object with a deferred-marking tag for deferring the recursive marking of the object when the recursion depth has exceeded a user-specified bound and executing the mark method on the deferred-marking tagged objects.

According to yet another embodiment, the recursive formulation may further comprise of storing deferred-marking objects in a cache.

A method for re-cycling object version in a memory and access management system 100 is disclosed. The method may comprise steps of enumerating locally optimized last version candidates and choosing the best last version candidate among locally optimized last version candidates by selecting the candidate with maximum total version space for objects.

According to yet another embodiment, the method may further comprise of reusing one of the links of doubly linked objects and a multipurpose marker for computing the best last version candidate.

According to yet another embodiment, the method may further comprise of a gap creation method execution before the version-recycling method.

A probabilistically-applicable deterministic, precise garbage collector comprises of a precise garbage collector with object moving functionality having a lightweight screening mechanism for determining applicability that decides whether collected putative pointers are also precise pointers.

According to yet another embodiment, the lightweight screening mechanism comprises comparing a count of putative pointers that cover all actual pointers with a separately collected count of actual pointers, equality indicating that each putative pointer is an actual pointer.

### Garbage Collector Algorithm

The garbage collector algorithm searches conservatively for encoded pointers in the memory image of a program. The algorithm records a putative encoded pointer as a discovered encoded pointer only if the heap object exists for the pointer. If the heap object and the pointer are live (viz. the object is live and the pointer's version matches the object's version), then the heap object is searched through for further encoded pointers that it may contain. The algorithm starts the search (for doubleword-aligned, doubleword scalars candidates) in the memory image comprising the stack, global data and registers of the program. Then as live objects pointed from live discovered encoded pointers are found, the search expands to include and run through these live objects also and further on transitively, till all live-pointer-reachable live objects have been searched. The results of the pointer discoveries then are finalized for garbage collector-based analyses.

According to an embodiment, the process of transitively searching through objects, only considers live objects and live pointers, since the program may only access (viz. validly dereference without exception) the live objects of the program using live pointers. No other memory may be dereferenced/accessed by the program, so for example free objects are not searched through transitively in the garbage collector process.

The core garbage collector algorithm for this transitive search, mark_transitive, is shown in Code 8. For a live object o pointed by a live discovered encoded pointer, mark_transitive searches through o as follows. The search may be carried out only once through o for the many different discovered pointers that may point to o. This once-only search occurs for the first live pointer discovery for o, at which point o's overlapped_marker1 comprises the INITIAL tag (0) in its PROGRESS MASK bits (bits 2 and 3 from the least significant side; bit 0 is reserved for LIVE MASK). As has been mentioned earlier, the overlapped_marker1 outside of a garbage collector phase stores 0 in its PROGRESS tag bits, so the INITIAL tag is the PROGRESS bits' initial state that any object starts out with. The first live pointer discovery for o triggers a mark_transitive call on o. As a first step, mark_transitive changes the INITIAL tag of o to DEFINITIVE. This transition signals that one mark_transitive call on the object is entered and that no further mark_transitive entries for the object need to be performed.

After setting o's tag to DEFINITIVE, mark_transitive checks all the doubleword-aligned doublewords within o using a for loop. The beginning of allocated data space for o (start, code 8) is a doubleword-aligned address, so all doublewords in o are enumerated from that. Each doubleword is treated as a putative encoded pointer, with ep * ptr pointing to it. Filter(ptr) screens the putative pointer by first checking that ptr->b is properly doubleword aligned and within the proper memory range of the Heap (so that the putative object metadata is well-aligned and positioned as it should be and further can be accessed without core-dump) followed by checking the markers present in the putative metadata. If the markers in the putative object (beyond the tag bits) are valid and the version stored with the object matches the version stored with the putative encoded pointer ptr, then filter(ptr) deems its screening of ptr to be successful and returns as b, the putative object for ptr. Optionally, the screening can insist that the object pointed by the next field of the putative object also be validly aligned, positioned and have valid markers. This insistence can check some k number of next objects as a part of the screening. In this entire exercise, the putative object's ptr->ptr is not used at all, since all values of ptr->ptr are conservatively treated as derivable from each other by pointer arithmetic. Independently of the value of ptr->ptr, the maximum impact of ptr is assumed, such that ptr may access the entirety of the object b and hence b is returned. Finally, if the screening of ptr is unsuccessful, then b acquires the value NULL.

If filter is successful (b is non-NULL), then the only action that is taken is to call mark_transitive recursively if b is a live object and b's PROGRESS tag bit is not DEFINITIVE. Since the object is live, it has a real marker assigned by the system and can only have the tag INITIAL from the system, if not changed to DEFINITIVE by a preceding mark_transitive call. Thus, when a live b with non-DEFINITIVE tag is ncountered, the only tag possible for b is INITIAL, signaling that this is the first discovery of a live encoded pointer for b. Thus a triggering of mark_transitive recursively is justified.

If mark_transitive is not triggered thus, then (i) either the PROGRESS tag is DEFINITIVE, or (ii) b is not live. If the PROGRESS tag is DEFINITIVE, then either the DEFINITIVE tag has been acquired due to a preceding mark_transitive call, or the DEFINITIVE tag reflects the contents of random memory and not a Heap object. In the former case, nothing needs to be done by mark_transitive this time as the preceding mark_transitive call is a sufficient record of all live discovered encoded pointers for b, i.e. all possible live discovered encoded pointers for b differ only in their ptr field, which as argued above (for ptr->ptr) is immaterial. In the latter case, ptr stands exposed as a falsely assumed encoded pointer as memory and access management system 100 cannot generate encoded pointers to non-objects. In either case, no record or action needs to be carried out by mark_transitive.

In case (ii), b is not live and hence is either free or spurious (i.e. not a Heap object). If b is free, then a version-matched pointer to it indicates a false assumption of ptr as an encoded pointer because a free object is always more version advanced than all existing pointers to the object in program memory. Similarly, if b is spurious, then ptr again stands exposed as a wrongly assumed pointer, as memory and access management system 100 cannot generate encoded pointers to non-objects. Again, in either case, no record or action needs to be carried out by mark_transitive.

If filter is unsuccessful (b is NULL) then format_filter(ptr) is called with the results stored in b. This call is identical to filter, except that version-equality of the pointer and object is not checked. If the resulting b is non-NULL, then b's membership in the objects' hash table indicates that ptr is a non-live or dangling, discovered pointer to b. This information is of use to the quarantine system of garbage collector and is duly recorded by the call to record_quarantine.

### Code 8: A Code Describing a Garbage Collection Algorithm in C Pseudocode is as Follows:

```
void mark_transitive(object0* o, word count) {
// if (count == TRANSITIVE_MARKING_BOUND)
// {save_transitive_excess(o); return; }
  o->overlapped_marker1 = o->overlapped_marker1
    − (o->overlapped_marker1 & PROGRESS_MASK) +
    DEFINITIVE;
void * start = (void *) (o + 1);
void * end = start + o->size − 2 * sizeof(word);
for (void * p = start; p <= end; p+= 2 * sizeof(word)) {
  ep * ptr = (ep *) p;
  object0* b = filter(ptr);
  if (b != NULL) {
    if ((b->overlapped_marker1 & PROGRESS MASK)
      != DEFINITIVE && is_live(b))
      mark_transitive(b, count + 1);
    }
    else {
      b = format_filter(ptr);
      if (b != NULL) {
        if (is_Heap_object(b)) {
          record_quarantine(ptr, b);
        }
      }
    }
  }
}
```

### Hybrid and Precise Garbage Collector

The globals/static data may be statically analyzed to count the number of encoded pointers. At garbage collector time, the globals data may be screened explicitly using format_filter( ) of Code 8 to count the number of putative encoded pointers. If the garbage collector count and the static counts match, then there are no putative encoded pointers beyond the pointer slots counted by the static count. The number of live pointers may be less than the number of pointer slots, because of free( ) operations. However, since format_filter( ) is used to count the putative pointers and not filter( ) the freed pointers would be accounted accurately. Knowledge that there are no putative pointers beyond the pointer slots means that garbage collector analysis results such as pointer updation upon object relocation may be applied in the globals memory image by simply looking up putative encoded pointers and updating them (since they have to be actual pointers). Finally, since the likelihood of non-pointer data in the memory and access management system 100 looking like encoded pointers is low, the applicability of the procedure above will straightforwardly generate opportunities for precise garbage collection on the globals data. The precise garbage collector may generally be applicable, with high probability as reasoned above; and when the collector is applicable, it may work just like a deterministic precise garbage collector.

The efficacy of format_filter( ) may be improved by inspecting not just the metadata of the object of the filter's argument. That object's next field may be traversed to inspect the next object's metadata also all the way up to a depth of some k objects. The accuracy of metadata and markers in k objects would eliminate false putative pointers with very high efficacy.

A similar exercise may be carried out vis-a-vis the stack as follows: A global tracked_pointers variable is kept. Each procedure is instrumented to increment the variable with the number of local pointer variables it adds to the stack. The increment is done upon procedure entry and the same quantity is decremented upon procedure exit. At stack bottom, the variable is initialized to zero. When garbage collector occurs, then the number of stacked pointers is established from inspecting tracked_pointers. Like the globals data above, the stack is screened with format_filter( ) from bottom onwards and the count of encoded pointers found compared with tracked_pointers. If the counts are the same, then there are no false putative pointers on the stack.

The stack scheme above faces standard difficulties in handling nested scopes and long jumps, which are handled as follows: for addition of pointer variables in nested scopes within a procedure, a couple of options are possible—lift the pointer variables to the outermost scope, or track scope entry and exit individually within the procedure itself updating tracked_pointers accordingly. A combination of the two options may also be possible. At long jumps, the stack gets popped abruptly. For this, the tracked_pointers variable may be saved when setjmp occurs and restored each time a long jump occurs. Exceptions may be treated similarly.

The exercise for the stack may be complicated by pointer passing via registers. In this case, a stacked pointer may be eliminated and passed via a register. The tracked_pointers count then has to equal the number of pointers found on the stack and registers.

Probabilistically-invoked precise garbage collector above may be simple to implement and has very little overhead over normal conservative garbage collector. Its invocation chances are high, given that false putative encoded pointers are few. The stack and globals data may independently become precise garbage collector ready using the method above. If both are found to be precise ready, then garbage collector is precise completely.

Thus, precise garbage collector, in varying quantities is enabled by memory and access management system. Minimally, the object layouts in heap objects allow precise garbage collector.

For hybrid or partially-precise garbage collector, the hash tables may be avoided if the number of putative encoded pointers is small. Such pointers can be verified in a manner similar to the way encode( ) works.

When precise garbage collector is enabled in its entirety, then a moving collection may straightforwardly be carried out by garbage collector by relocating fragmented live objects to fill gaps in otherwise occupied heap spaces. A full copying collection using standard techniques is of course also possible with the garbage collector shifting all objects to an unoccupied heap space. An object to be relocated may be done by first copying it to its destination, followed by marking it as moved in the original location. For this, the EXCESS tag in PROGRESS tags may be reused as a moved tag. Objects marked DEFINITIVE undergoing relocation will have their tag changed to MOVED, where MOVED=EXCESS. After an object has been copied to its destination, its data in the original location can be changed to comprise a pointer to the new location. Next when old pointers are updated, an old pointer to a MOVED object may be reconstructed using the pointer saved in the data part of the MOVED object.

Moving objects is straightforward, as described above, for the completely precise garbage collector. For a partially precise garbage collector, only those objects may be moved whose pointers all fall in precisely known locations. The way to determine this is as follows: Disable from a moving perspective, all objects pointed by putative encoded pointers (as opposed to precisely known encoded pointers). The remaining objects are eligible for moving. Three PROGRESS tags are defined in Code 7. A fourth, IMMOBILE may be defined using the unused tag in PROGRESS for this purpose (bits value=8). For marking objects as immobile, the non-precise region (stack or globals data) has to be scanned again in the end for putative pointers and the pointed objects marked as IMMOBILE. As another option, this extra scan in the end may be eliminated and the initial marking itself used to mark the pointed objects directly as IMMOBILE instead of DEFINITIVE. In this, the IMMOBILE tag would override a DEFINITIVE tag in the mark phase and reset a DEFINITIVE object to IMMOBILE if so discovered. Otherwise, DEFINITIVE and IMMOBILE work as the same.

If a complete, precise garbage collector is carried out, then dangling pointers discovered by garbage collector may be replaced by say NULL pointers as a compiler option. Otherwise, dangling pointers may be reconstructed as dangling pointers to moved objects also.

Finally, a non-probabilistic, completely deterministic precise garbage collector is also provided by the memory and access management system. In this case, the memory and access management system 100 incurs non-constant overhead outside the garbage collector part of program computation for a shadow stack scheme that registers stack pointers as follows: Using a source-to-source transformation, each procedure takes the address of pointer variables on the stack and saves the addresses in a local data structure of the procedure itself. This local, stack data structure points to the preceding stack frame's such data structure as that structure's address is passed to this procedure either as an extra argument, or via a global variable. Thus, a chain of local data structures with addresses of stacked pointers may be created in the chain of procedure frames on the stack. When garbage collector is called, this chain of data structures is consulted to determine the precise locations of stack variables. Similarly, the precise location of global data pointers is also pre-computed and used.

The moving option for the deterministic precise garbage collector is similar to the moving option discussed for the probabilistic precise garbage collector.

### Bounded Recursion Garbage Collector

Mark_transitive is called recursively, as a live pointer to a live object is discovered. For a data structure such as a linked list, the recursive calls may number as many as the number of objects on the list. If the data structure is filling the memory, then the corresponding chain of recursive calls and the stack frames it engenders can be very large. Garbage collection is capable of working under all circumstances, including when stack is already overused or small. In this section, the garbage collector's technique in bounding its recursion frames to a constant size is described.

The algorithm in Code 8 is changed to uncomment its first if statement. This immediately makes the heretofore unused count argument of mark transitive relevant, as count==TRANSITIVE_MARKING_BOUND truncates the mark transitive call. TRANSITIVE MARKING BOUND is a user-specified bound (via a compiler flag), which ensures that the depth of mark transitive's recursion never equals or exceeds TRANSITIVE MARKING BOUND. When recursion reaches this depth, then using save_transitive_excess(o), the object o is marked as EXCESS in its PROGRESS tag bits so that the object's visit by mark transitive may be deferred to a later time instead of this time.

From the root set pointers (taken from stack, global data and registers), the first call to mark transitive occurs with count set to 1. From here on the depth of the recursion is counted and bounded. An object marked EXCESS in one recursive unfolding may be visited in a second recursive path of lesser depth and its EXCESS tag overwritten to DEFINITIVE. Regardless, after all the recursive calls engendered from the root set have been exhausted, garbage collector shifts its attention to search through all the allocated object lists (various m->allocated, quarantine->allocated, quarantine->internal allocated) for objects that may have been left over with an EXCESS tag. Each such object is then made the subject of a mark transitive call. The trawl through allocated lists is carried out repeatedly till a complete trawl of memory is made without finding even one EXCESS-tagged object. This indicates that all objects have been visited and that the mark transitive phase is over.

The method described above bounds recursion effectively, but it incurs a cost of one or more trawls through all allocated lists in memory. The cost of the trawls can be largely eliminated using a cache for EXCESS objects as follows: Code 7 describes a cache data structure comprising a cache_head pointing to a list made of cache structs. A cache struct stores an array os[ ] of pointers to live objects, with end storing the highest index that os[ ] supports. Looking up a location in cache requires two handles: (i) A cache_ptr, that points to a specific struct in the list pointed by cache_head, and (ii) a cache_offset that looks up os[cache_offset] within the specific struct. The cache is built from the same fragmented heap memory (free objects, egaps) that the hash table is built out of Once the hash table of a desirable size has been built up, then the remaining fragmented heap memory is used to build the cache. Like the hash table, the cache is also a heterogeneous data structure, with the size of os[ ] varying from struct to struct. The cache is a linear data structure with no requirement of random access to it. Only trawls through the cache are needed. Thus no ordering of information in the cache is built up for facilitating complex access. The desirable cache size may also be user specified by a compiler flag. Once the cache of the desired size has been built up, any further remaining memory is ignored. Like the hash table, the cache is also underpinned by a minimum, constant amount of space provided by the stack, which is used if the heap does not provide enough space.

Save_transitive_excess now works by first trying to save its argument to the cache. The handle pair <cache_ptr, cache_offset> is advanced after each argument saved. Initially the pair starts with the empty cache, with cache_ptr=cache_head and cache_offset=0. As the cache fills up, the pair advances. Cache_offset advances fully through all of a struct's offsets prior to the cache_ptr advancing to the next struct. At any time, the pair points to the first empty slot in the cache (with preceding slots of the cache already filled out). When the cache runs out of empty slots, the cache_ptr finds itself pointing to NULL. Once this happens, the cache is full. If save_transitive_excess finds the cache full, it stops marking objects by storing them in the cache and instead starts marking them by flagging the EXCESS tag.

GC now works by first running through the recursion engendered by the root set pointers. Next, GC runs through the objects saved in its cache by calling mark transitive on the objects (the ones that are still not DEFINITIVE). Since this activity can engender further additions to the cache, the <cache_ptr, cache_offset> are sampled into local variables prior to running through the cache. The samples mark how far the cache has to be run through from the start. Once the cache has been run through (from the start) till the sampled values, then the <cache_ptr, cache_offset> are sampled again. If the new and the old samples are identical and the cache is not full, the end of mark transitive phase is signalled. Otherwise, the cache is run through from the old sample values till the new sample values and the process repeated (of running through the cache from the old samples to the new samples). If the cache becomes full (sample shows cache_ptr==NULL), then after the cache has been run through, a trawl through allocated objects is done wherein all EXCESS-tagged objects are used to re-fill the cache. This re-filling is possible because the cache stands emptied after it has been run through. The re-filling of the cache provides new values to <cache_ptr, cache_offset> and the process of running through the cache from the start till the sampled values of <cache_ptr, cache_offset> begins afresh. The process continues till new and old sampled values match, as described earlier. A more elaborate scheme of utilizing the cache adds the following optimization. Once the cache has become full, instead of tracking out-of-cache objects by EXCESS tags, the tracked objects are added at the start of the cache, overwriting processed/run through cache entries. Thus, the cache re-filling starts immediately upon the cache being full and is bounded by a <processed_cache_ptr, processed_cache_offset> pair that tracks the beginning of the first un-processed entry in the cache. The <cache_ptr, cache_offset> and <processed_cache_ptr, processed_cache_offset> move round robin in the cache, with the latter chasing the former in trying to finish all processing and empty the cache. The processing on the other hand engenders filling of the cache causing <cache_ptr, cache_offset> to chase the processing pointer round robin in trying to fill the cache. If the cache runs out in this process, then out-of-cache objects are tracked by EXCESS tags as before. The out-of-cache objects are shifted to an emptied cache for continued processing similar to the un-optimized process.

### Quarantine Processing

Quarantined objects comprise live/free objects that may be found by garbage collector to have non-live/dangling pointers. A non-live pointer is a pointer with an earlier version than the version of the object.

Quarantine processing takes place in the following steps:

1. Quarantine tags of quarantined objects (quarantine->allocated, quarantine->free) are reset to NOT_QUARANTINED such that their quarantine status may be discovered afresh. Function pointer objects are skipped in this step as they are kept around forever as quarantined free objects. The eNULL object is not reset similarly, if it is optionally maintained on the quarantine->free list.

2. Record quarantine in mark transitive/garbage collector may be used to mark objects with non-live pointers to them as QUARANTINED.

3. Objects are shifted between the un-quarantined lists and quarantine lists based on the newly discovered quarantine status from step 2.

In the above, record quarantine may optionally try to discriminate between the tag-resetted quarantined objects (of step 1) from normal objects in step 2. Record quarantine may figure out the valid version range of normal objects using the last version values relevant for the objects in their corresponding management structures. By contrast the last version information for step 1 objects is lost (never tracked). Using the valid version range of normal objects, spurious encoded pointers passed to record quarantine may be filtered out. For step 1 objects however, no such filtering may be carried out. Record quarantine may optionally choose to screen for such spurious pointers in its recording activity as follows. For each object it is recording for, record quarantine may visit the pertinent quarantine list and check if the object belongs there. If so, then the object is a tag-reset quarantined object, else its normal.

Once the mark transitive phase is over, objects on the quarantine->allocated and quarantine->free lists that find themselves sporting a NOT QUARANTINED tag are shifted to the un-quarantined objects' lists. Each NOT QUARANTINED quarantine->allocated object o is shifted to an m->allocated list if o->v !=(m->last version+1) %

NUMBER_OF_VERSIONS, otherwise, o is shifted to quarantine->internal_allocated for deferred return. Each object on the quarantine->internal_allocated list is similarly shifted to an m->allocated list unless it sports the not-allowed version above. An object on the quarantine->internal_allocated list therefore is one that awaits multiple garbage collections if needed prior to shifting to an un-quarantined list once its version is no longer denied. Since objects on the quarantine->internal_allocated list are simply those that have been determined to have no non-live pointers and this status does not change as they await garbage collections, the quarantine status re-discovery exercise for these objects is bypassed. Thus in step 1 above, the quarantine tags of these objects remain QUARANTINED. This tag is ignored as the objects are considered for transfer to un-quarantined lists, garbage collection after garbage collection. The procedure followed above for quarantine->internal_allocated objects is therefore impervious to the effects of spurious encoded pointers in the quarantine rediscovery process, since repeated re-discoveries are not carried out.

Each NOT QUARANTINED quarantine->free object shifted to an un-quarantined free list is assigned the version (m->last version+2) % NUMBER_OF_VERSIONS.

Shifting of objects takes place to the quarantine lists also, for un-quarantined objects that have been tagged QUARANTINED. Free/unusable free objects go to quarantine->free and allocated objects go to quarantine->allocated.

### Memory Leak Analysis and Gaps Creation

Memory leak analysis is carried out by visiting all allocated lists and checking if the PROGRESS tag of any object is INITIAL. Optionally, such leak objects are automatically reclaimed by freeing them to their applicable queues (m->allocated and quarantine->internal_allocated to m->free/unusable_free; quarantine->allocated to quarantine->free).

Gaps are created from free objects that have been determined to be un-quarantined. Such objects are extracted from the hash table into a location-wise sorted list of free objects, destroying the hash table in the process. This sorted list of free objects is traversed in conjunction with the sorted egaps of the Memory and access management system, converting the free objects into egaps and merging them in the sorted egaps list. The expanded egaps list is then traversed again, coalescing gaps into larger gaps whenever they share a boundary. The final gaps are partitioned back into the gap headers of management structures, prioritizing their insertion into fit_nxt and fit_nxt_nxt lists over the gaps lists of gap headers, thereby maximizing consumable gaps.

Both gaps creation and the version analysis described below destroy the hash table. Since version analysis does not use the hash table, while gaps creation does, the Memory and access management system 100 ensures that the gaps creation occurs as a preceding step in the version analysis.

### Optimal Version Analysis

Version analysis seeks to maximize the supply of versions to objects such that re-allocations may be maximized, thereby deferring the need for the next garbage collection. The method presented here, in conjunction with quarantine processing earlier is the first work for a shared version-tracking mechanism, to ensure an optimal supply of versions, using only constant space garbage collector algorithms for this purpose.

Version analysis proceeds after free objects have been converted to gaps. At this time, the only occupants of versions on un-quarantined lists are the allocated objects. Version analysis seeks to re-position last version such that the average distance of last version from live object versions is maximized, per m->allocated list. For this to be carried out, valid new positions for last-version have to be found.

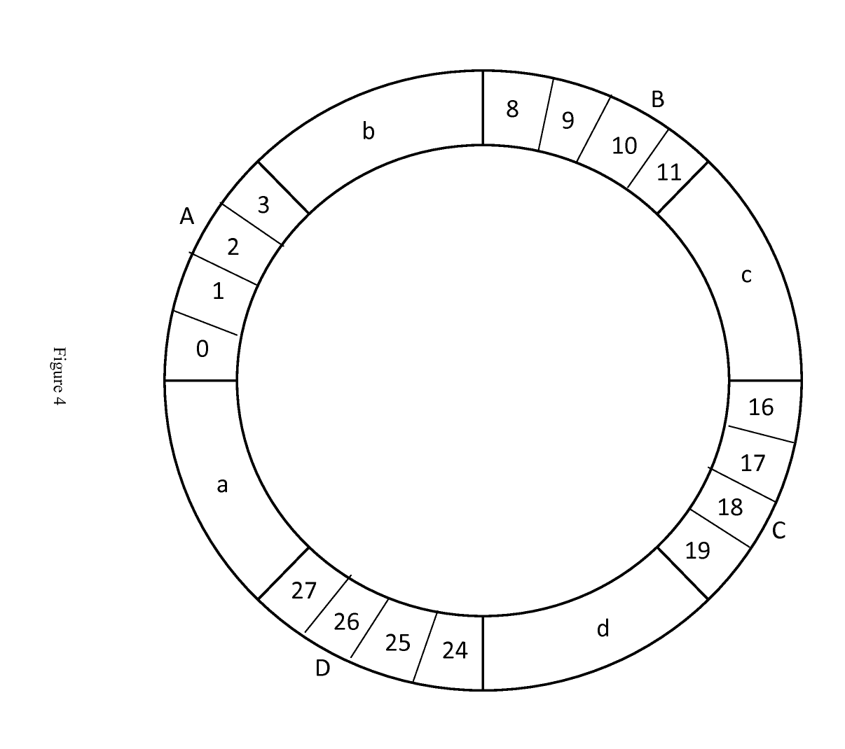

Post free-objects-to-gaps conversion, each live version represents both an object version as well as any number of co-incident live pointer versions. There are no other versions. Each stretch of un-occupied versions in the version space provides candidates for placing last version. As many last version positions are provided by a stretch as the number of un-occupied versions within it. FIG. 4 provides a visualization of the occupied and un-occupied versions in the circular version space. In the figure, NUMBER_OF_VERSIONS=32 versions, numbered versions represent unoccupied versions and occupied version stretches are labeled a, b, c, and d.

### Algorithm

The algorithm for optimal last version placement is given below. The algorithm may be invoked after hash tables have been abandoned, so the prev link of an allocated object is available for re-use in this constant-space overhead algorithm.

The algorithm uses the number of live objects of each version in each allocated objects list. This count is represented without any space overhead in the count-overlapped bits of overlapped_marker1 of allocated objects as follows. In the Heap, the maximum number of objects that may be stored is bounded by the maximum number of smallest objects that may be placed in the heap. The smallest object is an object0 like eNULL. Object0 occupies 2 doublewords or 16 bytes in a 32-bit architecture and 32 bytes in a 64-bit architecture. So in a 32-bit architecture, HEAP OFFSET BITS—4 bits may be used to represent the count of such objects and in a 64-bit architecture, HEAP OFFSET BITS—5 bits may be used to represent the count of such objects. The overlapped marker1 typically has HEAP OFFSET BITS available to it. Of these bits, 4 tag bits are of use to garbage collector and are left alone. Thus, the remaining HEAP OFFSET BITS—4 bits are available for the count purpose and are sufficient for version analysis as count-carrying overlapped marker1 bits.

Algorithm Last Version Advancer Input: m->allocated list for a management structure m manifesting at least two distinct versions in its allocated objects.

1. Using the prev links of the allocated objects, form a list of live objects such that each object in the list has a distinct version number and the list is sorted in ascending order. The size of the list would equal the number of distinct versions in allocated objects. In the count-overlapped bits of each object, store the count of the number of objects of that version in the allocated list.

2. Let the list of sorted versions above (represented by allocated objects) be V=υ₀, υ₁, . . . , υₙ. Let count(υᵢ) be the count of live objects of version vᵢ stored in its count-overlapped bits. Let C be the total number of objects in the allocated objects list (C=Σ_{υε}v c(υ)). A traversal of V enumerates the stretches S=<υ₀, υ₁>, <υ₁, υ₂> . . . <υₙ₋₁, υₙ>, <υₙ, υₒ>. A stretch υᵢ, υⱼ comprises unoccupied versions if d(υᵢ, υⱼ)≧2, where d(υᵢ, υⱼ) is the distance that υⱼ is ahead of υᵢ. Traverse V and find the first stretch with an unoccupied version. Let this stretch be υₓ, υ_{y}. Let the integer variables delta and max_delta be initialized to 0. Let the version max_delta_v be initialized to υ_{y}.

3. In a circular traversal over V starting from υ_{y}, enumerate all the stretches of S in one circle ending with υₓ, υ_{y}. At each <υᵢ, υⱼ> in this enumeration, compute delta=delta+C×d(υᵢ, υⱼ)—NUMBER_OF_VERSIONS×count(υᵢ); max_delta=d(υᵢ, υⱼ)≧2 && delta>max_delta ? delta: max_delta; max_delta_v=d(υᵢ, υⱼ)≧2 && delta>max_delta ? νⱼ:max_delta_v;

The algorithm computes the stretch ending with max_delta_v as the best stretch to place the new last_version in. The algorithm works by enumerating candidate last version positions in V, by taking the best candidate from each stretch with an unoccupied version. This recording of a candidate happens each time max_delta and max_delta_v conditionally update themselves. The conditional updates only record for unoccupied stretches. A conditional update only records an improvement if it makes one. This happens till the best overall candidate has yielded the highest max_delta.

For the best candidate last version from the stretch vₓ, v_{y}, the total distance of all allocated objects in m->allocated from the candidate is taken as an unspecified reference distance R of the algorithm. Next, the change, delta, in this reference distance is recorded for each candidate last version (in max_delta), as the algorithm shifts from one unoccupied stretch to another (in V) in one circular enumeration. In going from one unoccupied stretch to another, many occupied stretches may be passed, all of which add their incremental contributions to delta (but not max_delta) in the circular enumeration. Only when an unoccupied stretch is reached does the recording of the sum of all increments to delta gets logged conditionally as the new candidate's offering in max_delta. The circle ends back at <vₓ, v_{y}> and the last version with the highest recording in max_delta is selected as the answer of the computation.

The algorithm enumerates and considers stretches and versions one at a time. No memory is kept of a version/stretch passed by, except for the information stored in local variables such as delta, and max delta. These local variables comprise the only space overhead in the circular traversal over the version list. Hence, the algorithm computes within constant space overhead.

Algorithm Last Version Advancer is given for m->allocated lists containing at least two distinct versions. For fewer versions (e.g. the eNULL list of no versions), no exercise of choosing among multiple options needs to be carried out and the answer is straightforwardly available.

### Approximation and Variants

When overlapped marker1 does not contain enough count-overlapped bits to store the object counts per version in an allocated object, then the following approximate algorithm may be used. The approximation first traverses the m->allocated list to collect the number of objects per version in sorted_versions list V, storing only the counts in the allocated objects that are representable in the count bits of the objects. Larger counts are thrown away, except for tracking the largest count for a version in a local variable. This largest count represents the version in m->allocated that has the maximum number of live objects. Let L be this count. For k count bits in overlapped marker1, 2^{k}<L. An adjustment factor f=┌L/2^{k}┐ is computed. The counts in overlapped marker1s are all divided by f to yield normalized counts. The larger counts are re-computed, divided by f

and stored in the corresponding overlapped marker1s. Thus the counts stored for objects record the objects in multiples of f, with remainder/fractional multiple of the counts being
rounded away. Using the normalized counts, the Algorithm Last Version Advancer computes as before to provide the best last version position.

Variants of Algorithm Last Version Advancer may be derived as follows: In the quarantining process, the live objects from the quarantine lists with a version equal to the successor of last version in m->allocated are not diverted/blocked to quarantine->internal allocated. Instead, they are returned to m->allocated. Next, sorted_versions, V, for m->allocated are computed as before. If the sorted versions indicate at least one unoccupied stretch in V, then clearly, a new last version can be placed there. In this case, Algorithm Last Version Advancer computes as before and finds the optimal unoccupied stretch to place a last version in. If there is no unoccupied stretch in V, then the version in V with a minimum object count against it may be eliminated by shifting all its objects to quarantine->internal_allocated with the quarantine tag set. This shift implies that the objects have been shifted for a deferred return to m->internal_allocated, and allowing in the meantime, an advancement of last version. More than one version with a small count can be eliminated, allowing Algorithm Last Version Advancer to choose among the multiple last version positions. Finally, once the best last version has been chosen, the multiple elimination decisions can be reversed, allowing objects whose versions do not clash with the chosen last version to be returned back to m->allocated. The process of elimination of a version can also be directed by the total distance change formula in ensuring useful last version candidates.

Efficacy of Count/Tag Overlap with Markers

Overlapping the tag/count purpose with the marker purpose in overlapped marker1 is carried out with very high efficacy for both the co-existant purposes. The count is used when the marker purpose is un-needed in the version analysis phase of live objects. Post the version analysis phase, marker bits are re-instated, such that their use for normal marker purpose is completely met. Thus, both these purposes are met with 100% efficacy despite being overlapped.

Outside of the garbage collector phase, only one tag/count bit is in use as a non-marker bit. This is the quarantine tag bit. All other marker bits carry a marker purpose during this time. The marker purpose is of use solely for the encode primitive, that takes an un-encoded pointer and finds its encoded equivalent. The primitive works as follows: memory preceding the location pointed by the un-encoded pointer in the heap is searched for the marker patterns. Upon finding the patterns, an object is assumed and its validation carried out by moving along its prev links till the head of the queue it represents is found. A valid head implies the object was indeed the object and using the object, the pointer is encoded.

In this encode exercise; if the marker is found to have its quarantine bit set, then the object falls in the quarantine list. As the search for the queue head proceeds (through the prev links), the markers of all the objects passed through have to show the quarantine tag set. Similarly, for a non-quarantine object, all the markers encountered have to show the quarantine tag re-set. In other words, after the assumed object for an unknown pointer has been found, all the preceding objects for this object find their marker patterns being fully utilized (with all bits used) for the screening purpose. Only the assumed object is unable to use the quarantine tag bit for the screening purpose. Thus, the quarantine tag bit only affects the marker purpose one-object deep in the screening exercise over a list of objects. In case a screening with markers is good enough if carried out k-objects deep, then with the quarantine tag in use, the screening needs to be carried out only k+1 objects deep for getting (much) more than the same effect. In short, the quarantine tag bit does not really compromise the marker purpose outside of the Garbage Collector phases.

Garbage Collectors may be made available by the memory and access management system 100 as a library function that the compiler and user can call in the memory and access management system 100 programs. Garbage Collector is restricted to not be called in the try block of backward compatibility in Memory Management System. The try block contains decoded pointers in its memory image, which the Garbage Collector is not equipped to track.

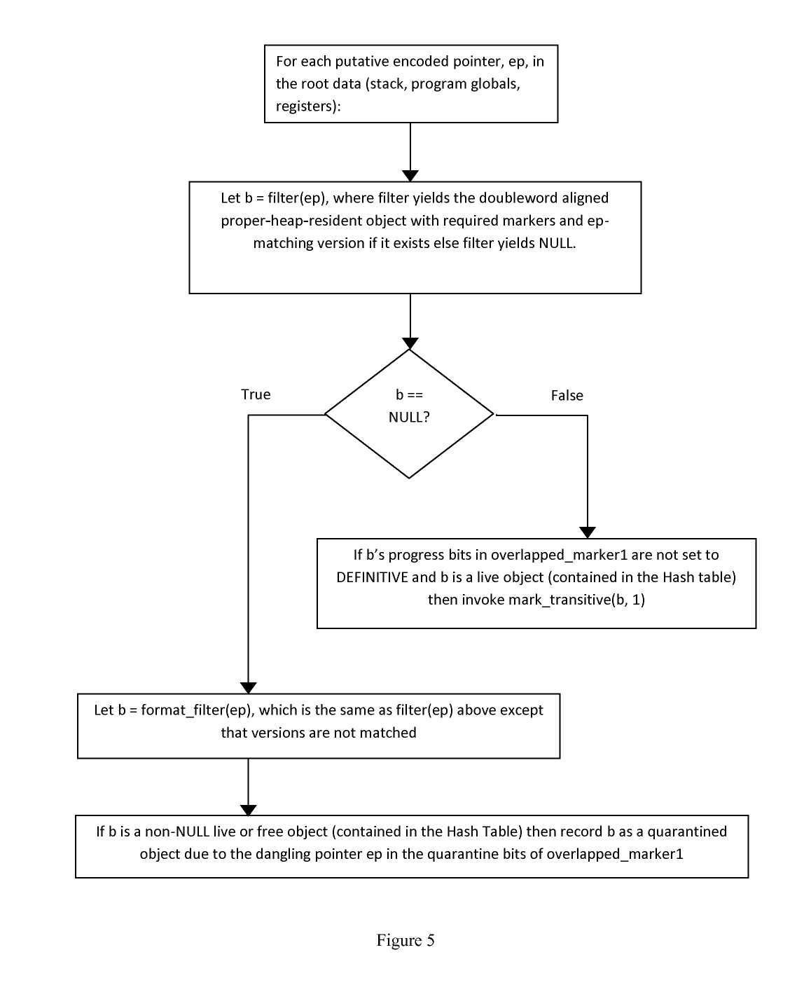

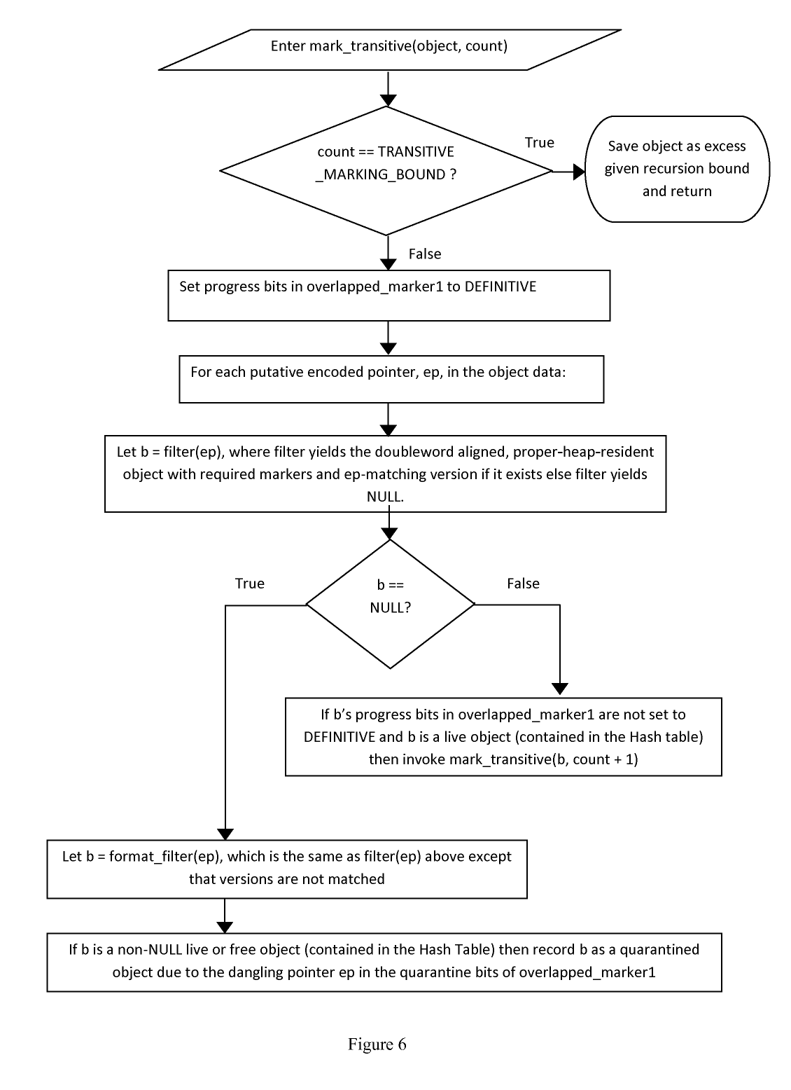

FIGS. 5 and 6 illustrates a Conservative Garbage Collector in accordance with an embodiment of the invention. For contrast, the traditional conservative collector cannot restrict recursive mark transitive calls to live objects only, as in standard C/C++, non-objects and even free objects may also be accessed and dereferenced in the application program memory by pointers to them. The power and simplicity of the mark_transitive in the conservative garbage collector arises from its exception-based explicit ruling out of such memory accesses in the application program. More contrast is presented by the elaborate filter operation using markers and versions and the discrimination and recording of dangling pointers for quarantine purposes.

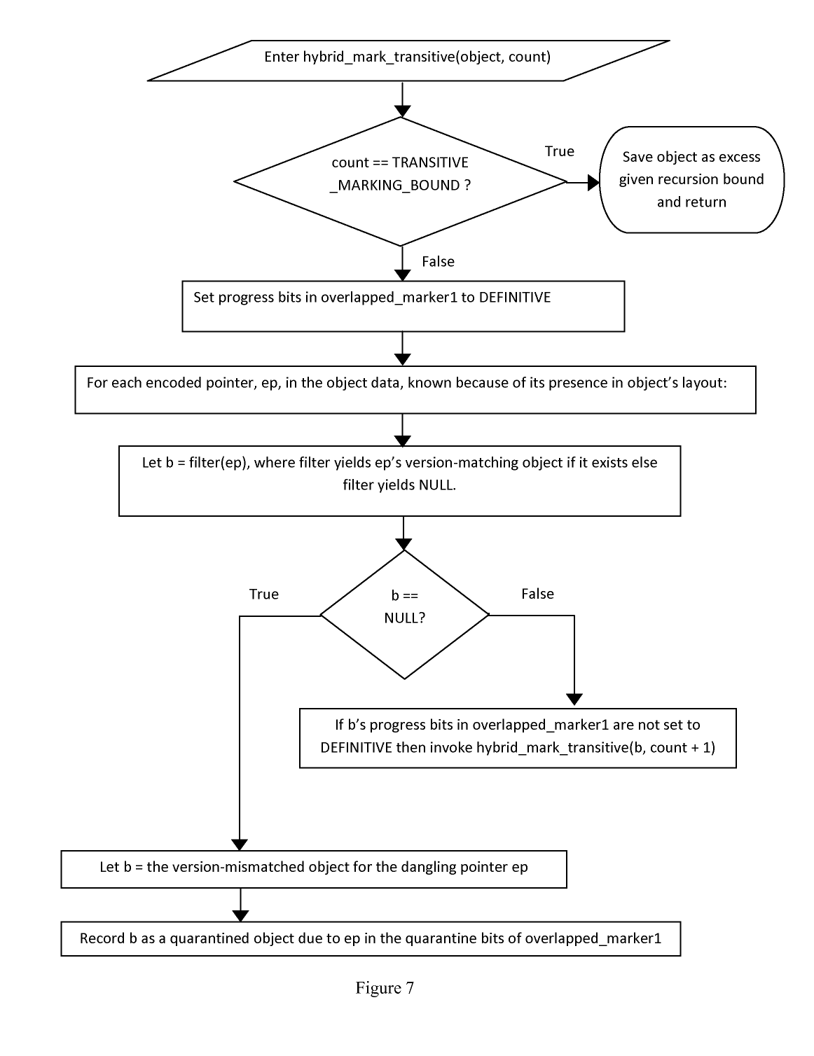

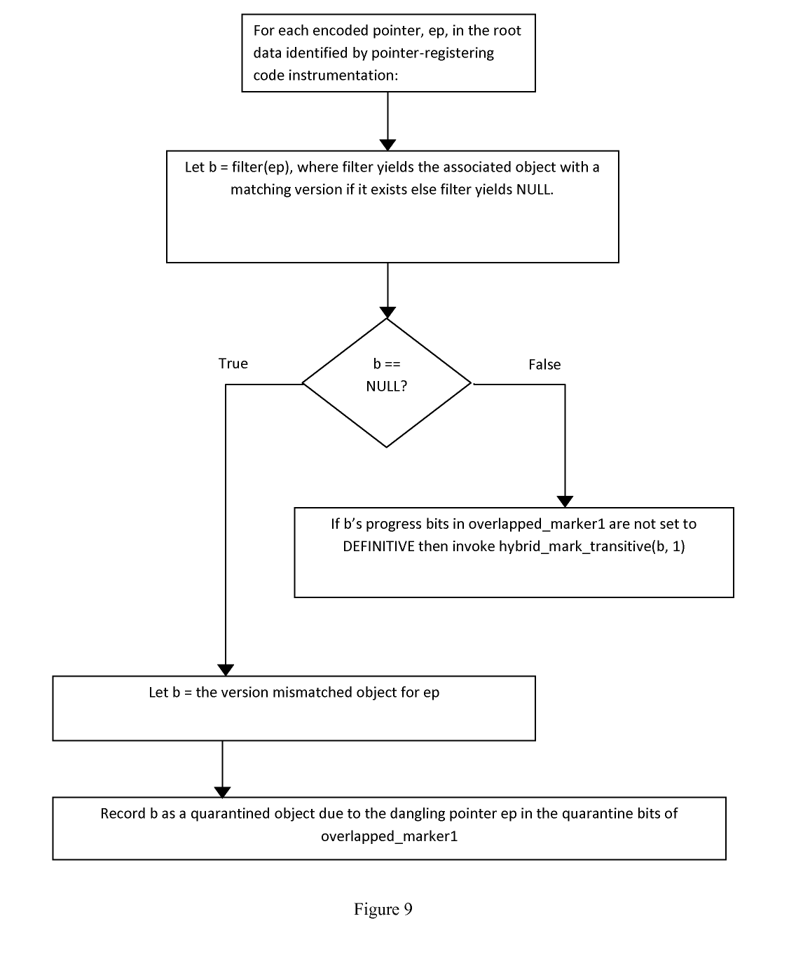

FIGS. 5 to 9 provide the looping, recursion and marking structure of the method that permits constant space marking of all objects.

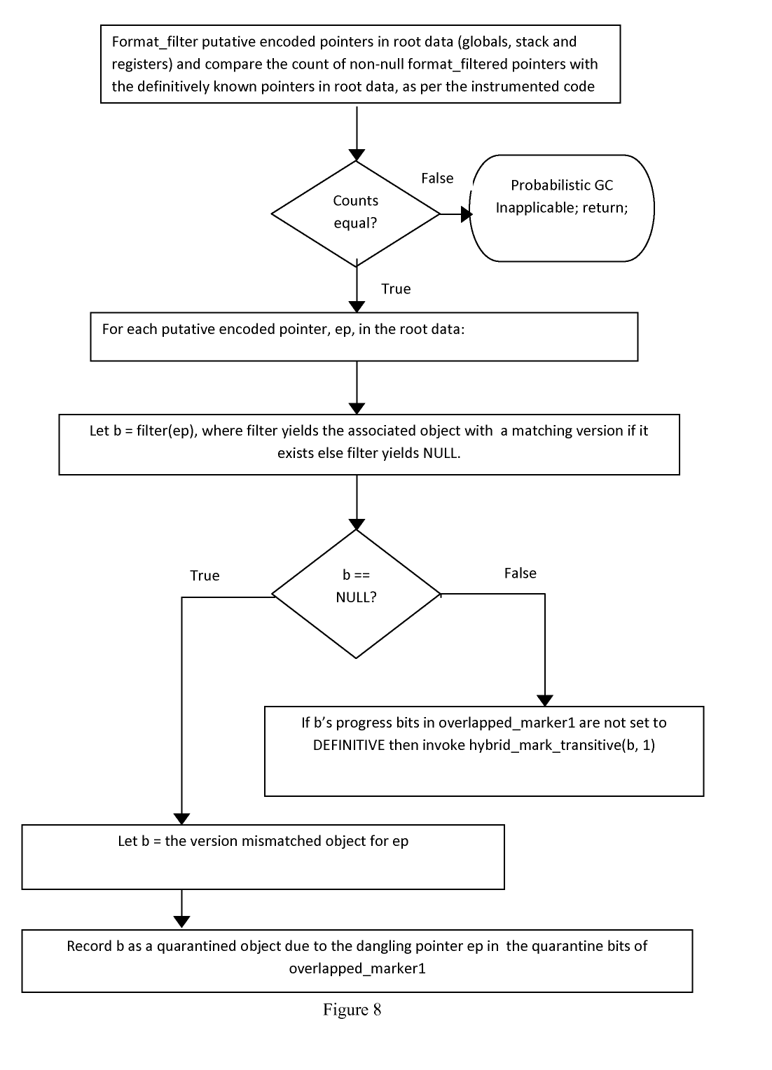

FIG. 8 describes a probabilistic garbage collector in accordance with an embodiment of the invention. This figure is also applicable on a category-by-category basis for the root data viz. globals alone, stack and registers together, all together.

According to an embodiment, the rounded flowchart box is for procedure return, not program termination in the various flowcharts.

FIGS. 5 to 9 use bounded recursion as shown in the various mark_transitive flowcharts. The garbage collector marking algorithm comprises first an invocation of the mark_root process. This may engender the saving of objects as excess in the mark_transitive calls. After mark_root, garbage collector may process the excess-saved objects by visiting them and calling mark_transitive afresh on them as and when needed.

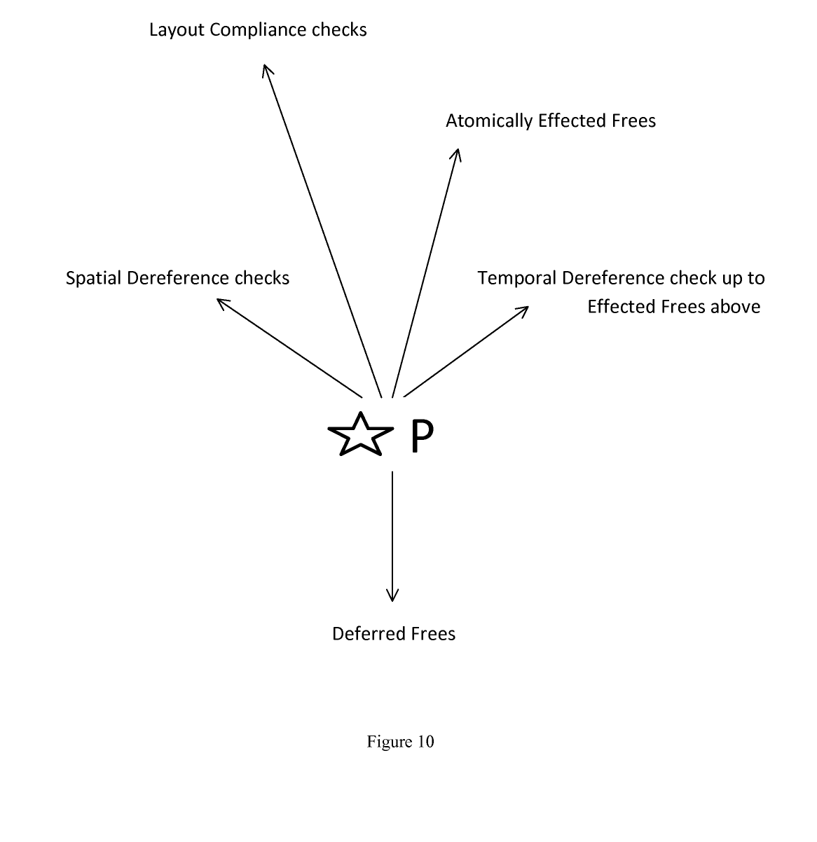

FIG. 10 illustrates an invulnerable pointer and dereferences in accordance with an embodiment of the invention. In this figure, each arrow has a precedence relation. This figure points out that encoded pointer dereferences (for read and write) are made invulnerable by the preceding compliance checks on the pointer p that ensure that any stored pointer is only dereferenced as a pointer alone. The preceding spatial dereference checks ensure that no dereference beyond an object's bounds are made so no “compliant” out-of-bounds access from a different object may read or write the present object and that *p dereference itself is within bounds. A temporal check ensures that the dereference *p can only succeed if the object is live when dereferenced viz. the preceding atomically effected frees have not reclaimed the object and any (deferred) free on the object occurs only in succession of the dereference if at all.

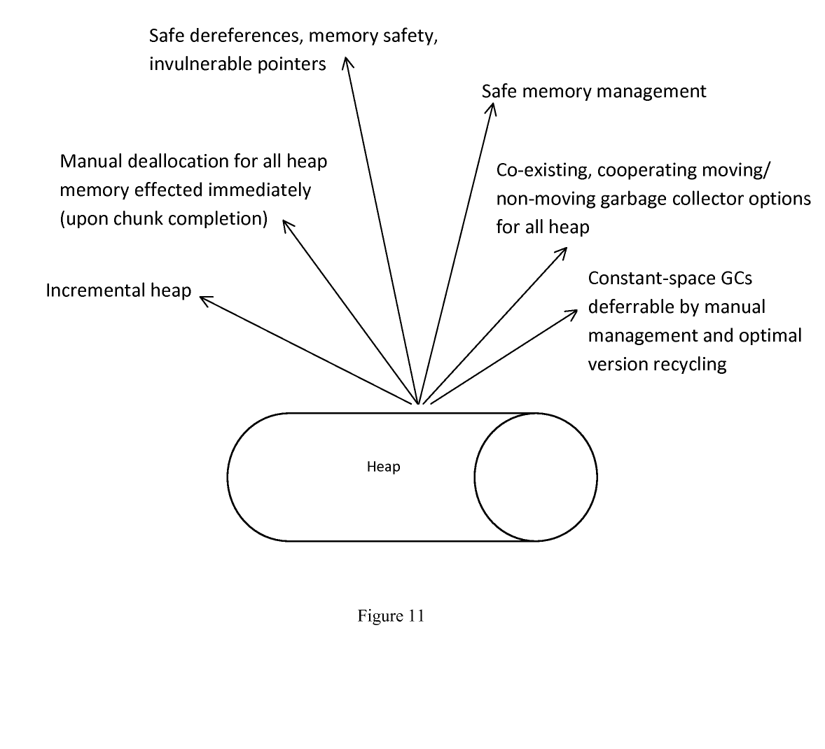

FIG. 11 illustrates a diagram showing the heap memory pool in accordance with an embodiment of the invention. This figure shows that the heap is incremental, and all allocated memory can be deallocated either manually or automatically using one of the many garbage collectors as discussed above. The memory and access management system 100 and garbage collector co-exist and cooperates in reclaiming all memory of the heap memory pool. Once a manual free( ) command is given, the freed memory is immediately and safely provided back to the allocator for new use in allocation without waiting for any intervening garbage collector. Frees may be chunked as deferred frees for efficiency, optionally, primarily in a concurrent implementation. All aspects of memory management and use have safety guarantees, based on built-in checks. Garbage Collector expenses may be controlled by the sparing use of resources by garbage collectors (constant space) and the ability to defer garbage collectors by using manual memory management for safely recycling memory in the context.

A method for reducing memory access errors or management errors or runtime errors while dynamically allocating, moving or de-allocating memory to one or more objects of an application program is disclosed. The object may have a data part containing one or more values and a pointer part containing one or more pointers. The method may comprise steps of dynamically allocating, moving or de-allocating the data part of the object to defragment, manage or optimize a heap memory pool. The heap memory pool may contain a memory space to be allocated to the object of the application program. The method may further comprise step of updating the address location of the data part contained in one or more pointers in the pointer part upon moving the data part, thereby reducing memory access errors or management errors or runtime errors while allocating, moving or de-allocating memory to the object.

According to an embodiment, the one or more pointers are invulnerable pointers, invulnerable encoded pointers, scalar invulnerable encoded pointers or atomic scalar invulnerable encoded pointers. The pointer invulnerability compliance checks are disclosed wherein the checks are lock-free.

The steps of the illustrated method described above herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, micro controller, or state machine. A processor may also be implemented as a combination of computing devices, e.g., a combination of a DSP and a microprocessor, a plurality of microprocessors, one or more microprocessors in conjunction with a DSP core, or any other such configuration.

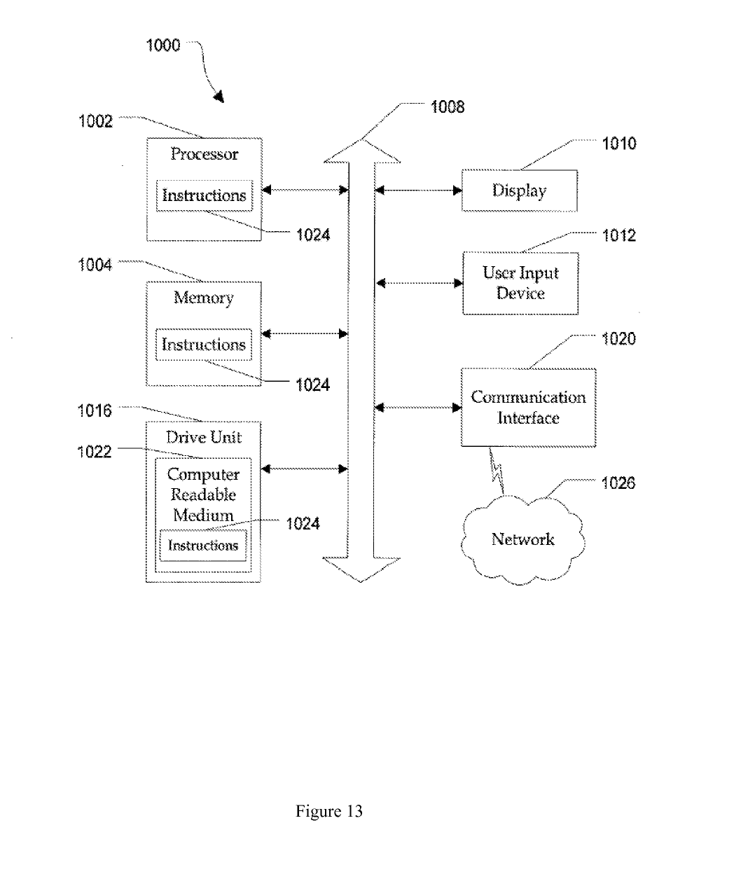

FIG. 13 illustrates a computer system 1000 in which the memory and access management system 100 may be implemented in accordance with an embodiment of the invention. The computer system 1000 may include a processor 1002, e.g., a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data The processor 1002 may implement a software program, such as code generated manually (i.e., programmed).

The term “module” may be defined to include a plurality of executable modules. As described herein, the modules are defined to include software, hardware or some combination thereof executable by a processor, such as processor 1002. Software modules may include instructions stored in memory, such as memory 1004, or another memory device, that are executable by the processor 1002 or other processor. Hardware modules may include various devices, components, circuits, gates, circuit boards, and the like that are executable, directed, or otherwise controlled for performance by the processor 1002.

The computer system 1000 may include a memory 1004, such as a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1004 includes a cache or random access memory for the processor 1002. In alternative examples, the memory 1004 is separate from the processor 1002, such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may or may not further include a display unit 1010, such as a liquid crystal display (LCD), an organic light emitting diode (OLED), a flat panel display, a solid state display, a cathode ray tube (CRT), a projector, a printer or other now known or later developed display device for outputting determined information. The display 1010 may act as an interface for the user to see the functioning of the processor 1002, or specifically as an interface with the software stored in the memory 1004 or in the drive unit 1016.

Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control or any other device operative to interact with the computer system 1000.

The computer system 1000 may also include a disk or optical drive unit 1016. The disk drive unit 1016 may include a computer-readable medium 1022 in which one or more sets of instructions 1024, e.g. software, can be embedded. Further, the instructions 1024 may embody one or more of the methods or logic as described. In a particular example, the instructions 1024 may reside completely, or at least partially, within the memory 1004 or within the processor 1002 during execution by the computer system 1000. The memory 1004 and the processor 1002 also may include computer-readable media as discussed above.

The present invention contemplates a computer-readable medium that includes instructions 1024 or receives and executes instructions 1024 responsive to a propagated signal so that a device connected to a network 1026 can communicate voice, video, audio, images or any other data over the network 1026. Further, the instructions 1024 may be transmitted or received over the network 1026 via a communication port or interface 1020 or using a bus 1008. The communication port or interface 1020 may be a part of the processor 1002 or may be a separate component. The communication port 1020 may be created in software or may be a physical connection in hardware. The communication port 1020 may be configured to connect with a network 1026, external media, the display 1010, or any other components in system 1000, or combinations thereof. The connection with the network 1026 may be a physical connection, such as a wired Ethernet connection or may be established wirelessly as discussed later. Likewise, the additional connections with other components of the system 1000 may be physical connections or may be established wirelessly. The network 1026 may alternatively be directly connected to the bus 1008.

The network 1026 may include wired networks, wireless networks, Ethernet AVB networks, or combinations thereof. The wireless network may be a cellular telephone network, an 802.11, 802.16, 802.20, 802.1Q or WiMax network. Further, the network 1026 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” may include a single medium or multiple media, such as a centralized or distributed database, and associated caches and servers that store one or more sets of instructions. The term “computer-readable medium” may also include any medium that is capable of storing, encoding or carrying a set of instructions for execution by a processor or that cause a computer system to perform any one or more of the methods or operations disclosed. The “computer-readable medium” may be non-transitory, and may be tangible.

In an example, the computer-readable medium can include a solid-state memory such as a memory card or other package that houses one or more nonvolatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement various parts of the system 1000.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof

Memory and access management system 100 is a low-resource and automatically managed memory system supporting complete manually managed memory standards of programming languages such as C and C++.

The high concurrency and efficiency of the memory and access management system 100 has been highlighted throughout the disclosure for e.g., consumable gaps are maximized and prioritized, object metadata is fully packed, scalar single-word encoded pointer option, and the tradeoff between space and time by using more metadata space in objects, etc.

The epv, scalar, atomic view of an encoded pointer ensures that a pointer may be passed around and copied atomically (without locks) and freely throughout a concurrent implementation of a program. Overwriting a pointer (i.e. assigning to a pointer variable) may be done atomically without locks also. Further support, e.g. reading a pointer, doing some computations, and then writing the pointer back may require locks or critical sections, as is the case for other atomic types like integers also. This is because between the read and write of a pointer variable, another thread may write the pointer variable, changing the typical assumptions of the first thread. Thus, pointer arithmetic may be both possible and not possible as lock-free atomic operation. It is possible when a pointer is read and an incremented pointer is derived and stored in a second variable.

Among other pointer operations, cast compliance check may be carried out atomically without locks for an object that has acquired its layout. A compliance check in this case involves just an atomic reading of a pointer variable followed by the compliance verification that involves reads only of the concurrency-amenable, static layout data. For an object that has not acquired its layout, a race condition may be possible among multiple first casts to set the layout of the object. However, this is a very unlikely programming scenario and first casts on the object that set the layout are commonly, statically discernible allowing their atomic lock-free treatment also.

Dereference checks may be carried out atomically without locks also, with the caveat that an object may find itself freed concurrently while a thread that has passed the dereference checks is still reading the object. A concurrent free similarly denies the shifting of dereference checks to a preceding compliance check in the optimization. To prevent the deleterious effects of concurrent free( ) operations, efree( ) may be replaced by the following deferred free( ) operation.

A deferred free operation over an object for manual memory management is disclosed. The deferred free operation may comprise the steps of saving the object in a cache of objects and freeing the cached objects later as a group using barrier synchronization. According to an embodiment of the invention, the barrier synchronization may be lock-free.

A deferred free operation saves the object to be freed in a cache of deferred free( ) objects. The object is not freed by a deferred free operation. Instead, deferred free objects are freed only when no concurrent thread is involved in a dereference operation (with or without shifted checks). The decision to free deferred frees may be taken when the cache containing the deferred frees reaches a threshold of fullness. At this point, the thread trying to add to the cache may become the cache clearing thread as follows: the thread writes to a global variable I the intention to clear the cache and waits on a global count variable C. All threads follow the following protocol: before entering a dereference check (shifted or otherwise), the threads read I for any thread's intention to clear the cache. If the threads find I set, they increment C (using a lock) and wait for I to be reset. Once the I-setting thread finds C equal to the number of all other threads, it resets C, clears the cache, and resets I. To do the above in a lock free manner, the count variable C may be replaced with an array for all the threads. Each thread sets its own slot in the array to signal its waiting for I status. The I-setting thread waits for the slots of other threads to all be set prior to resetting their slots and doing its work.

Since dereferences are common, the above barrier would be straightforwardly entered by all threads without much delay engendered for others. Clearing the cache would be fast since the actual frees would occur without locks since all threads are in a barrier. Thus for a nominal, constant cache size, the deferred free mechanism above would execute with efficiency for all threads. Finally, since free( ) operations are not the most common in a program, the number of barriers would be few and efficient as described above. Instead of I-checking at each dereference, such checks may be carried by a thread at the granularity of a few dereferences apiece, reducing the overhead of I-checking also. So the cost of the scheme above would be little in the program and would allow optimizations such as checks shifting/sharing to be carried out and lock-free atomicity of dereference checks to be enforced.

Allocation operations, since they involve manipulation of queues would require lock operations in general. Decode of an encoded pointer is straightforwardly atomic without locks. Encode may require a lock for atomic implementation.

A single word encoded pointer may be used by the memory and access management system. The memory and access management system 100 under this compiler setting is appropriately modified for the purpose.

The memory and access management system 100 runtime system may be embedded in C/C++ by modifying a compiler front end for this purpose. This approach provides the best efficiency for the system with the option of code transformations occurring at the AST level or the IR level of the program. In this modification, the sizeof( ) a pointer type becomes twice the sizeof( ) a C standard pointer. The sizeof( ) functionality is modified to reflect doubled pointer sizes in all its (compound) types. The epv is passed around everywhere as the scalar implementation of a pointer type. Object accesses and casts are modified to include the checks specified in the memory and access management system. The compiler generated type layouts are consulted (e.g. using a modified offsetof( ) functionality) to generate the layout objects and layout store used by the memory and access management system. The source-to-source transformations and analysis specified in the memory and access management system 100 may be implemented as a part of the compiler front-end pass in the above, or they may be implemented as a prior first pass ahead of the above compiler pass.

Another alternative scheme for embedding the memory and access management system 100 may be done using a source-to-source transformation as outlined here. In this scheme, pointers are replaced by epvs in the program. Each pointer declaration in a program may be substituted by an epv declaration of the same variable. Each pointer arithmetic expression may be replaced by an inline library function call on the epv for the pointer. Arguments for the call, such as the statically generated layout for the pointer type in the original expression are supplied to the call. The call implements any necessary checking in the pointer arithmetic expression and yields a post-arithmetic epv as its result.

A statically checked pointer cast expression becomes a non-operation. A dynamically checked pointer cast becomes an inline library cast check call comprising the pointer epv and type-related details (e.g. layout). The call does the necessary compliance and other checking for the call as identified by the analysis.

A pointer read dereference expression takes a pointer and returns a value as per the type T of the pointer (T *). This is implemented by replacing an original pointer dereference expression by a custom function call on the epv representing the pointer that returns a value of type T′ as its answer where T′ is T modified to replace each pointer by epv. The inline custom function is generated as per the type T and the checking identified for the dereference operation. The function does dereference checking to the extent identified by the static analysis. Since custom functions are generated for many program dereferences, duplication may be avoided by reusing an already generated custom function in case a second dereference requires the same custom functionality.

Pointer write dereferences are treated similar to pointer read dereferences, with the custom function taking the value to be written as one of its arguments.

Static sizeof( ) expressions are replaced by statically computed sizes for types with epv substituting the pointers in the types.

The above transformations are not carried out inside the try block for backward compatibility. All types in the try block are standard types. The try block is replaced by a standard compound statement as a part of its translation to standard C code.

Examples of the above transformation are given below: int * foo; *foo=bar( ) is translated to: epv foo; fun1(foo, bar( );, where the custom writer function prototype comprises int fun1(epv foo, int v);, for carrying out the write and any identified checks. int ** foo; . . . ; foo++; return **foo; is translated to epv foo; . . . ; lib_arithmetic_plus_plus(&foo, layout); return fun3(fun2(foo));, where the custom reader function prototypes comprise epv fun2(epv foo); and int fun3(epv arg), for carrying out the reads and any identified checks for dereference and compliance. void * foo; . . . ; return ((int *) foo); is translated to epv foo; . . . ; return lib_castcheck(foo, layout);, where the library function does compliance checking.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the disclosure, any limitations arising on account of the same are not intended. As would be apparent to a person in the art, various working modifications may be made to the process in order to implement the inventive concept as taught herein.

### REFERENCES

[1] P. Akritidis. Cling: A memory allocator to mitigate dangling pointers. In Proceedings of the 19th USENIXconference on Security, USENIX Security '10, Berkeley, Calif., USA, 2010. USENIX Association.
[2] P. Akritidis, M. Costa, M. Castro, and S. Hand. Baggy bounds checking: an efficient and backwards-compatible defense against out-of-bounds errors. In Proceedings of the 18th conference on USENIX security symposium, SSYM'09, pages 51-66, Berkeley, Calif., USA, 2009. USENIX Association.
[3] T. M. Austin, S. E. Breach, and G. S. Sohi. Efficient detection of all pointer and array access errors. In Proceedings of the ACM SIGPLAN 1994 conference on Programming language design and implementation, PLDI '94, pages 290-301, New York, N.Y., USA, 1994.

### ACM.

[4] E. D. Berger and B. G. Zorn. Diehard: probabilistic memory safety for unsafe languages. In Proceedings of the 2006 ACM SIGPLAN conference on Programming language design and implementation, PLDI '06, pages 158-168, New York, N.Y., USA, 2006. ACM.
[5] J. Devietti, C. Blundell, M. M. K. Martin, and S. Zdancewic. Hardbound: architectural support for spatial safety of the c programming language. In Proceedings of the 13th international conference on Architectural support for programming languages and operating systems, ASPLOS XIII, pages 103-114, New York, N.Y., USA, 2008. ACM.
[6] D. Dhurjati and V. Adve. Backwards-compatible array bounds checking for c with very low overhead. In Proceedings of the 28th international conference on Software engineering, ICSE '06, pages 162-171, New York, N.Y., USA, 2006. ACM.
[7] D. Dhurjati and V. Adve. Efficiently detecting all dangling pointer uses in production servers. In Proceedings of the International Conference on Dependable Systems and Networks, DSN '06, pages 269-280, Washington, D.C., USA, 2006. IEEE Computer Society.
[8] D. Dhurjati, S. Kowshik, and V. Adve. Safecode: enforcing alias analysis for weakly typed languages. In Proceedings of the 2006 ACM SIGPLAN conference on Programming language design and implementation, PLDI '06, pages 144-157, New York, N.Y., USA, 2006. ACM.
[9] R. Hastings and B. Joyce. Purify: Fast detection of memory leaks and access errors. In In Proc. of the Winter 1992 USENIX Conference, pages 125-136. Usenix Association, January 1992.
[10] M. Hauswirth and T. M. Chilimbi. Low-overhead memory leak detection using adaptive statistical profiling. In Proceedings of the 11th international conference on Architectural support for programming languages and operating systems, ASPLOS-XI, pages 156-164, New York, N.Y., USA, 2004. ACM.
[11] T. Jim, J. G. Morrisett, D. Grossman, M. W. Hicks, J. Cheney, and Y. Wang. Cyclone: A safe dialect of c. In Proceedings of the General Track of the annual conference on USENIX Annual Technical Conference, ATEC '02, pages 275-288, Berkeley, Calif., USA, 2002. USENIX Association.
[12] R. W. M. Jones and P. H. J. Kelly. Backwards-compatible bounds checking for arrays and pointers in c programs. Automated and Algorithmic Debugging, pages 13-26, 1997.
[13] L. Li, C. Cifuentes, and N. Keynes. Practical and effective symbolic analysis for buffer overflow detection. In Proceedings of the eighteenth ACMSIGSOFT international symposium on Foundations of software engineering, FSE '10, pages 317-326, New York, N.Y., USA, 2010. ACM.
[14] A. Loginov, S. H. Yong, S. Horwitz, and T. W. Reps. Debugging via run-time type checking. In Proceedings of the 4th International Conference on Fundamental Approaches to Software Engineering, FASE '01, pages 217-232, London, UK, UK, 2001. Springer-Verlag.
[15] S. Nagarakatte, J. Zhao, M. M. Martin, and S. Zdancewic. Softbound: highly compatible and complete spatial memory safety for c. In Proceedings of the 2009 ACM SIGPLAN conference on Programming language design and implementation, PLDI '09, pages 245-258, New York, N.Y., USA, 2009. ACM.
[16] S. Nagarakatte, J. Zhao, M. M. Martin, and S. Zdancewic. Cets: compiler enforced temporal safety for c. In Proceedings of the 2010 international symposium on Memory management, ISMM '10, pages 31-40, New York, N.Y., USA, 2010. ACM.
[17] G. C. Necula, J. Condit, M. Harren, S. McPeak, and W. Weimer. Ccured: type-safe retrofitting of legacy software. ACM Trans. Program. Lang. Syst., 27(3):477-526, May 2005.
[18] N. Nethercote and J. Seward. Valgrind: a framework for heavyweight dynamic binary instrumentation. In Proceedings of the 2007 ACM SIGPLAN conference on Programming language design and implementation, PLDI '07, pages 89-100, New York, N.Y., USA, 2007. ACM.
[19] Y. Oiwa. Implementation of the memory-safe fullansi-c compiler. In Proceedings of the 2009 ACMSIGPLAN conference on Programming languagedesign and implementation, PLDI '09, pages 259-269, New York, N.Y., USA, 2009. ACM.
[20] H. Ozdoganoglu, T. Vijaykumar, C. Brodley, B. Kuperman, and A. Jalote. Smashguard: A hardware solution to prevent security attacks on thefunction return address. Computers, IEEETransactions on, 55(10):1271-1285, oct. 2006.
[21] F. Qin, S. Lu, and Y. Zhou. Safemem: Exploiting ecc-memory for detecting memory leaks and memory corruption during production runs. High-PerformanceComputer Architecture, International Symposium on, 0:291-302, 2005.
[22] M. F. Ringenburg and D. Grossman. Preventing format-string attacks via automatic and efficient dynamic checking. In Proceedings of the 12th ACM conference on Computer and communications security, CCS '05, pages 354-363, New York, N.Y., USA, 2005. ACM.
[23] O. Ruwase and M. S. Lam. A practical dynamic buffer overflow detector. In Proceedings of the 11^{th} Annual Network and Distributed System Security(NDSS) Symposium, pages 159-169, February 2004.
[24] Z. Shao, C. Xue, Q. Zhuge, M. Qiu, B. Xiao, and E.-M. Sha. Security protection and checking for embedded system integration against buffer overflow attacks via hardware/software. Computers, IEEE Transactions on, 55(4):443-453, april 2006.
[25] Y. Shi, S. Dempsey, and G. Lee. Architectural support for run-time validation of control flow transfer. In Computer Design, 2006. ICCD 2006. International Conference on, pages 506-513, oct. 2006.
[26] P. Varma, R. K. Shyamasundar, and H. J. Shah. Backward-compatible constant-time exception-protected memory. In Proceedings of the 7th joint meeting of the European software engineeringconference and the ACM SIGSOFT symposium onThe foundations of software engineering, ESEC/FSE '09, pages 71-80, New York, N.Y., USA, 2009. ACM.
[27] W. Xu, D. C. DuVarney, and R. Sekar. An efficient and backwards-compatible transformation to ensure memory safety of c programs. In Proceedings of the 12th ACM SIGSOFT twelfth international symposium Foundations of software engineering, SIGSOFT '04/FSE-12, pages 117-126, New York, N.Y., USA, 2004. ACM.
[28] S. H. Yong and S. Horwitz. Protecting c programs from attacks via invalid pointer dereferences. In Proceedings of the 9th European software engineering conference held jointly with 11th ACM SIGSOFT international symposium on Foundations of software engineering, ESEC/FSE-11, pages 307-316, New York, N.Y., USA, 2003. ACM.

1. A memory and access management system for reducing both memory access errors and memory management errors for a language with features comprising synchronization-free, atomic pointers comprising atomic dereferencing of a pointer to scalar, the language furthermore featuring manual memory management, automatic memory management, or both, such that pointer metadata tracking by the system for reducing the errors is necessary, the language supporting dynamically allocating, moving or de-allocating memory to one or more objects of an application program, an object having a data part containing one or more values and a pointer part containing one or more pointers, the system comprising:
a heap memory pool containing a memory space to be assigned to an object of the application program;
a processor configured for reading the pointer part of the object and checking access to the object; and
an interface coupled with the processor for dynamically allocating, moving or de-allocating the data part of the object to defragment, manage or optimize the heap memory pool and, updating the address location of the data part contained in one or more pointers in the pointer part upon moving the data part, thereby eliminating all errors comprising inter-object spatial memory access violations, temporal memory access violations, pointers invulnerability violations, and memory management errors for the object.

2. The system of claim 1 wherein the pointer part comprises one or more live pointer, dangling pointer, inbound pointer, out-of-bounds pointer, uninitialized pointer, manufactured pointer or hidden pointer.

3. The system of claim 1 wherein the interface comprises a garbage collector for moving or de-allocating memory to the object.

4. The system of claim 1 wherein the interface comprises a manual management unit including support for allocating or de-allocating memory to the object.

5. The system of claim 3 wherein the garbage collector is a precise garbage collector for moving data part of the object in order to de-fragment the heap memory pool and improve cache or locality performance.

6. The system of claim 3 wherein the garbage collector is a complete conservative garbage collector configured without the object moving functionality and to effectively track the pointer part of the object.

7. The system of claim 3 wherein the garbage collector is a hybrid precise garbage collector with partial object moving functionality and configured to effectively track the pointer part of the object.

8. The system of claim 1 further comprising:
an invulnerability compliance unit for ensuring the pointers are invulnerable;
an access checking unit for ensuring safe memory access; and
a management checking unit for ensuring safe memory management.

9. The system of claim 3 wherein the garbage collector builds or uses a hash table comprising a plurality of buckets for containing lists of live or free objects.

10. The system of claim 1 wherein the pointer of the object is maintained in an encoded state.

11. The system of claim 4 wherein the manual management unit is a substitute to the memory management functions in stdlib.h, section 7.20.3 of the ANSI/ISO C99 manual such that spatially and temporally safe use and management of memory is obtained.

12. The system of claim 1 wherein the system is an automatically managed memory and access system supporting complete manually managed memory standards of C and C++ programming languages.

13. The system of claim 1 wherein the heap memory pool comprises a non-contiguous memory space to be increased or decreased at run-time, based on the needs of the application program.

14. The system of claim 1 wherein the system manages the heap memory pool via an arrangement of management structures, each for a specific allocation size used by the application program.

15. The system of claim 14 wherein the management structures comprises a dsizeof(0) structure where dsizeof(0) is doubleword sizeof(0) and a dsizeof(gh) structure where gh is a gap header and a dsizeof(m) structure where m is a management structure, such that one or more of the structures are created at system initialization time.

16. The system of claim 15 wherein the dsizeof(0) structure is configured for housing an eNULL object whose data size excluding meta-data is 0, the dsizeof(gh) structure contains gap headers on the internal allocated and internal free lists of the dsizeof(gh) structure and the dsizeof(m) structure contains management structures on the internal allocated list of the dsizeof(m) structure.

17. The system of claim 16 wherein outside of paired creation times the total number of free or live gap headers equals the total number of arranged management structures in the heap memory pool at any time.

18. The system of claim 14 wherein the management structures are arranged in a doubly linked sorted-by-size list such that each management structure tracks at least five allocated/free object lists and one gap header (gh) pertinent to allocations of the management structure's size.

19. The system of claim 3 wherein the garbage collector is further configured to quarantine the live or free objects having a dangling pointer.

20. The system of claim 18 wherein the gap header points to lists of gaps using fields gaps, fit_nxt, or fit_nxt_nxt wherein fit_nxt and fit_nxt_nxt point to consumable gaps and gaps points to non-consumable gaps.

21. The system of claim 20 wherein an allocation request with an existing management structure uses a free object or a consumable gap on the fit_nxt or fit_nxt_nxt lists unless none exist.

22. The system of claim 20 wherein management structure creation leads to a re-partitioning of the lists of gaps such that consumable-gaps stored on fit_nxt or fit_nxt_nxt lists are maximized.

23. The system of claim 20 wherein all objects and gaps in the heap memory pool are doubleword aligned.

24. The system of claim 20 wherein each gap created from a free object of doubleword size s by a garbage collector can serve allocation requests of doubleword size s among possibly others.

25. The system of claim 1 wherein the object data part comprises a meta-data part, the meta-data part includes one or more fields for storing next and previous links of objects for a doubly-linked object arrangement and, for storing an object layout key, version, size, markers or multi-purpose markers.

26. The system of claim 25 further comprises a hash table built by a garbage collector such that one or more lists of free or live objects stored in the hash table are built by re-using one of the links of the doubly-linked objects in the heap memory pool.

27. The system of claim 1 wherein the one or more pointers are invulnerable pointers, invulnerable encoded pointers, scalar invulnerable encoded pointers or atomic scalar invulnerable encoded pointers.

28. The system of claim 25 wherein the object layout key identifies a layout data structure or a constant to represent that the object does not yet have a layout or the object's layout is special, such as for an eNULL object.

29. An invulnerable pointer for identifying an object in a heap memory pool and supporting pointer-to-pointer cast or pointer arithmetic such that the pointer cannot be overwritten by a non-pointer value or read as a non-pointer value.

30. A deferred free operation over an object for manual memory management, the operation comprising the steps of:
saving the object in a cache of objects; and
freeing the cached objects later as a group using barrier synchronization.

31. The operation of claim 30, wherein the barrier synchronization is lock-free.

32. A read-only memory layout for a static type comprising bitwise representation of pointer-sized or pointer-aligned entities including pointer and non-pointer data, with one bit value representing a pointer datum and the other bit value representing non-pointer data.

33. The memory layout of claim 32 wherein the layout is generated by compacting a recognized repeat pattern in the layout into an un-repeated representation.

34. The memory layout of claim 32, wherein the memory layout is represented in a data structure comprising bitstrings of appended combinations of un-repeated bitstring pattern and one or more unrolls of repeat bitstring pattern.

35. Pointer invulnerability compliance checks based on a static type layout of claim 32.

36. The pointer invulnerability compliance checks of claim 35 are carried out dynamically for compliance operations comprising pointer casts, pointer arithmetic and stored pointer reads.

37. The pointer invulnerability compliance checks of claim 36, wherein a dynamic check for a pointer cast are performed in a forward direction, the forward direction includes type void * to type T * where T is not void, and no check is performed in the reverse direction.

38. The pointer invulnerability compliance checks of claim 35 wherein the shared checking occurs when compliance checks or memory access checks can be shifted to a dominating or effectively dominating position.

39. The pointer invulnerability compliance checks of claim 35 are static or dynamic and comprise layout or bitstring or layout key comparisons.

40. The pointer invulnerability compliance checks of claim 35 are optimized if an object's layout does not comprise an un-repeated bitstring or if the repeat bitstring is not manifested in the un-repeated bitstring.

41. The pointer invulnerability compliance checks of claim 35 wherein the checks are lock-free.

42. The pointer invulnerability compliance checks of claim 35 wherein the pointer invulnerability checks are shared with memory access checks.

43. The pointer invulnerability compliance checks of claim 35 wherein the shared checking occurs when a compliance check operation dominates a memory access operation or a memory access operation dominates a compliance check operation or a set of one or more compliance check operations effectively dominates a memory access operation or a set of one or more memory access operations effectively dominates a compliance check operation.

44. A method of shielding a vulnerable resource in the heap memory pool, the method comprises the steps of:
storing the vulnerable resource in an object in the heap memory pool; and
representing the vulnerable resource by an invulnerable pointer to the object.

45. The method of claim 44 further comprising storing the resource in a free object in the heap memory pool and referencing the free object by a dangling pointer allowing only special-purpose accesses to the resource through the dangling pointer and disallowing other accesses such as dereferences of the dangling pointer through normal access checking.

46. A method for encoding an un-encoded pointer comprising the steps of:
identifying an object for the un-encoded pointer by searching through a cache of previously decoded pointers' objects or using the object of a hinted encoded pointer or deferring the identification till a hash table of objects is dynamically constructed; and
using the address location or version of the object to build the encoded pointer.

47. An extended gap structure comprising at least four fields stored at one end of an unused memory block of a heap memory pool comprising:
a first field pointing to the other end of the memory block;
a second field pointing to a list of gaps;
a third and fourth field maintaining a doubly-linked list of gaps according to location-wise sorted order among gaps representing the entire set of unused memory blocks in the heap memory pool.

48. The extended gap structure of claim 47 wherein the extended gaps in a sorted state defragment the heap memory pool by maximizing matched memory allocations that consume an extended gap apiece, and enable linear time coalescing or addition of gaps within a constant-space garbage collector.

49. A probabilistically-applicable deterministic, precise garbage collector comprising:
a precise garbage collector with object moving functionality having a lightweight screening mechanism for determining applicability that decides whether collected putative pointers are also precise pointers.

50. The probabilistically-applicable deterministic, precise garbage collector of claim 49 wherein the lightweight screening mechanism comprises comparing a count of putative pointers that cover all actual pointers with a separately collected count of actual pointers, equality indicating that each putative pointer is an actual pointer.

51. A method for reducing both memory access errors and memory management errors for a language with features comprising synchronization-free, atomic pointers comprising atomic dereferencing of a pointer to scalar, the language furthermore featuring manual memory management, automatic memory management, or both, such that pointer metadata tracking by the system for reducing the errors is necessary, the language supporting dynamically allocating, moving or de-allocating memory to one or more objects of an application program, an object having a data part containing one or more values and a pointer part containing one or more pointers, the method comprising the steps of:
assigning a memory space contained in a heap memory pool to an object of the application program, reading the pointer part of the object and checking access to the object;
dynamically allocating, moving or de-allocating the data part of the object to defragment, manage or optimize the heap memory pool; and
updating the address location of the object's data part contained in one or more pointers in the object's pointer part upon moving the data part, thereby eliminating all errors comprising inter-object spatial memory access violations, temporal memory access violations, pointer invulnerability violations, and memory management errors for the object.

52. A mark method for a conservative garbage collector, such that the method identifies memory reachable from a root set of an application program, the root set comprising a stack, globals and static data section, and registers for the application program, the mark method comprising the steps of:
identifying putative encoded pointers in the root set;
recognizing a putative encoded pointer as a discovered encoded pointer only if a live or free object in the heap memory pool exists for the putative encoded pointer;
marking a live object pointed by a live putative encoded pointer as reachable memory;
adding marked live objects to the root set; and
repeating the above steps again till the root set stops changing.

53. The method of claim 52, wherein an object in the heap memory pool is marked or traversed only once to identify the reachable memory.

54. The method of claim 52, further comprises tracking a putative encoded pointer effectively by screening the pointer for proper size and alignment, the proper alignment and memory range of the pointer's pointed object, the presence of proper markers in the pointed object, the putative validity of the next or previous objects linked from the pointed object, or the equality or non-equality of the pointer and pointed object versions the former of which is indicative of a live pointer to a live object and the latter of which is indicative of a dangling pointer.

55. A recursive formulation of a mark method of a garbage collector, comprising the steps of:
marking an object with a deferred-marking tag for deferring the recursive marking of the object when the recursion depth has exceeded a user-specified bound; and
executing the mark method on the deferred-marking tagged objects.

56. The recursive formulation of claim 55, further comprising:
storing deferred-marking objects in a cache.

57. A method for re-cycling object version in a memory and access management system, the method comprises the steps of:
enumerating locally optimized last version candidates; and
choosing the best last version candidate among locally optimized last version candidates by selecting the candidate with maximum total version space for objects.

58. The method of claim 57 further comprises reusing one of the links of doubly linked objects and a multipurpose marker for computing the best last version candidate.

59. The method of claim 57 further comprising a gap creation method execution before the version-recycling method.

60. The method of claim 57 further comprising reusing one of the links of a doubly linked objects to build a list of sorted versions optionally reusing the hash table of the system.

61. A try block for backward compatibility, such that the try block runs in a scope where free variables comprising pointers consist only of decoded pointers.

62. A mark method for precise garbage collectors (GC), such that the method identifies memory reachable from a root set of an application program, the root set comprising a stack, global and static data section, and registers for the application program, the mark method comprising the steps of:
a. identifying invulnerable, encoded pointers in the root set;
b. marking a live object pointed by a live encoded pointer as reachable memory;
c. adding marked live objects to the root set; and
d. repeating the above steps again till the root set stops changing.

63. The mark method of claim 62 wherein marking an object in the heap memory pool or traversing only once to identify the reachable memory.

64. The mark method of claim 62 further comprising checking an encoded pointer for the pointer's version equality with the pointer's object version, equality indicating a live encoded pointer to a live object and inequality indicating a dangling pointer.

65. (canceled)

66. A manual memory management system operable in a computing environment comprising a means for deferred freeing of an object, comprising:
a means for saving the object in a cache of objects; and
a means for freeing the cached objects later as a group using barrier synchronization.

67. A conservative garbage collector operable in a computing environment comprising a mark means for identifying memory reachable from a root set of an application program, the root set comprising a stack, globals and static data section, and registers for an application program, the mark means comprising:
a means for identifying putative encoded pointers in the root set;
a means for recognizing a putative encoded pointer as a discovered encoded pointer only if a live or free object in a heap memory pool exists for the putative encoded pointer;
a means for marking a live object pointed by a live discovered encoded pointer as reachable memory;
a means for adding marked live objects to the root set; and
a means for repeatedly applying the above means till the root set stops changing.

68. A garbage collector operable in a computing environment with a recursive marking means comprising:
a means for marking an object with a deferred-marking tag for deferring the recursive marking of the object when the recursion depth exceeds a user-specified bound; and
a means for executing the recursive marking means on the deferred-marking tagged objects.

69. A precise garbage collector operable in a computing environment comprising a mark means for identifying memory reachable from a root set of an application program, the root set comprising a stack, global and static data section, and registers for the application program, the mark means comprising:
a means for identifying invulnerable, encoded pointers in the root set;
a means for marking a live object pointed by a live encoded pointer as reachable memory;
a means for adding marked live objects to the root set; and
a means for repeatedly applying the above means till the root set stops changing.

70. A memory and access management system, for reducing both memory access errors and memory management errors for a language with features comprising synchronization-free, atomic pointers comprising atomic dereferencing of a pointer to scalar, the language furthermore featuring manual memory management, automatic memory management, or both, the language allowing expression of one or more programs containing one or more reducible errors, the language supporting dynamically allocating, moving or de-allocating memory to one or more objects of an application program, an object having a data part containing one or more values and a pointer part containing one or more pointers, the system comprising:
a heap memory pool containing a memory space to be assigned to an object of the application program;
a processor configured for reading the pointer part of the object and checking access to the object; and
an interface coupled with the processor for dynamically allocating, moving or de-allocating the data part of the object to defragment, manage or optimize the heap memory pool and, updating the address location of the data part contained in one or more pointers in the pointer part upon moving the data part, thereby eliminating all errors comprising inter-object spatial memory access violations, temporal memory access violations, pointer invulnerability violations, and memory management errors for the object.
